(19) United States
(12) Patent Application Publication
(10) Pub. No.: US 2024/0418515 A1
(43) Pub. Date: Dec. 19, 2024

(54) USING A LANGUAGE MODEL TO LOCALIZE AND ROUTE PLAN FOR NAVIGATION SYSTEMS AND APPLICATIONS

(71) Applicant: Nvidia Corporation, Santa Clara, CA (US)

(72) Inventors: Shuang Wu, Fremont, CA (US); Denis Laprise, Palo Alto, CA (US); Mark Wheeler, Saratoga, CA (US)

(21) Appl. No.: 18/409,018

(22) Filed: Jan. 10, 2024

Related U.S. Application Data
(60) Provisional application No. 63/521,627, filed on Jun. 16, 2023.

(51) Int. Cl. G01C 21/34; G06F 40/284; G08G 1/0968

(52) U.S. Cl. CPC G01C 21/34; G06F 40/284; G08G 1/096811

(57) ABSTRACT

Approaches presented herein provide for the generation of a tokenized description of an environment for use in making decisions with respect to the environment. In particular, a large language model (LLM) can be used to generate a tokenized text string representation of an environment using sensor information captured at a specific location, as well as information about the semantics, topology, and geometry of the environment. A similarity-based search can be performed against tokenized descriptions for various locations until a single high-quality match is identified, and the geographic position of the match can be inferred to correspond to the current position of a vehicle that captured the sensor data. The current location and tokenized description can also be provided to a language model, along with a road-level route plan, in order to generate more detailed routing information that is optimized based on the additional information available in the tokenized description for a sequence of goals corresponding to the route plan.

### CROSS-REFERENCE TO RELATED APPLICATIONS

This application claims priority to and the benefit of U.S. Provisional Patent Application No. 63/521,627, filed Jun. 16, 2023, entitled “USING LANGUAGE MODELS FOR MAPPING IN AUTONOMOUS SYSTEMS AND APPLICATIONS,” the full disclosure of which is hereby incorporated in its entirety for all purposes.

### BACKGROUND

There are various operations—such as may relate to autonomous or semi-autonomous sensing, navigation, control and robotic simulation—where it can be desirable to determine a current location and, based at least in part on the current location, determine a route from that location, such as to a specified destination. As an example, maps—such as high definition (HD) maps, navigational maps, standard definition (SD) maps, etc.—are widely relied upon for semi-autonomous and autonomous navigation operations. Autonomous and semi-autonomous vehicles and machines may rely on these maps for navigation, localization, path or route planning, and/or other operations. Building, updating, and maintaining these maps (or other such representations) is a time-intensive and compute-heavy task that relies heavily on domain expertise and manually designed logic or rules. Further, existing solutions to complex search and routing using such maps depend on highly specialized systems that have a steep learning curve to new users and can be difficult to extend and customize to novel use cases. As an example, maps or other geospatial information often need to be stored in special data systems to support large data scale and fast querying. Further, information retrieval from such systems is normally performed using rigid and predefined interfaces that are unintuitive to human users. Furthermore, routing and other use cases of such systems are typically implemented as a list of functionalities that are not easy to inspect and adapt for various changes or use cases. Prior routing approaches are also limited in capability and accuracy when precise positioning information is not available, as may correspond to a lack of reliable signal or other such issues.

### BRIEF DESCRIPTION OF THE DRAWINGS

Various embodiments in accordance with the present disclosure will be described with reference to the drawings, in which:

FIG. 1 illustrates example data produced at stages of an environment reconstruction process, according to at least one embodiment;

FIG. 2A illustrates an example environment reconstruction pipeline, according to at least one embodiment;

FIG. 2B illustrates an example tokenized description generated using a pipeline such as that illustrated in FIG. 2A, according to at least one embodiment;

FIG. 2C illustrates an example localization and route determination pipeline, according to at least one embodiment;

FIGS. 3A, 3B, 3C, and 3D illustrate example map representations for different scenarios, along with points plotted in a latent space corresponding to tokenized descriptions of such different scenarios, according to at least one embodiment;

FIG. 4A illustrates an example localization process that can be performed according to at least one embodiment;

FIG. 4B illustrates an example route planning process that can be performed according to at least one embodiment;

FIG. 5A illustrates an example map graph, according to at least one embodiment;

FIG. 5B illustrates an example landmark analysis system, according to at least one embodiment;

FIG. 5C illustrates an example tokenized text string, according to at least one embodiment;

FIG. 5D illustrates an example lane graph, according to at least one embodiment;

FIG. 5E illustrates an example architecture for determining an output state, according to at least one embodiment;

FIG. 5F illustrates an example image of an intersection in an example map, according to at least one embodiment;

FIG. 6 illustrates components of a distributed system that can be used to generate and/or use a text-based representation of an environment, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment;

FIGS. 15A and 15B illustrate a data flow diagram for a process to train a machine learning model, as well as client-server architecture to enhance annotation tools with pre-trained annotation models, in accordance with at least one embodiment;

FIG. 16A illustrates an example of an autonomous vehicle, according to at least one embodiment;

FIG. 16B illustrates an example of camera locations and fields of view for the autonomous vehicle of FIG. 16A, according to at least one embodiment;

FIG. 16C is a block diagram illustrating an example system architecture for the autonomous vehicle of FIG. 16A, according to at least one embodiment;

FIG. 16D is a diagram illustrating a system for communication between cloud-based server(s) and the autonomous vehicle of FIG. 16A, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), one or more in-vehicle infotainment systems, one or more emergency vehicle detection systems), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, map building, updating and generation, synthetic data generation, generative AI, model training or updating, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), generative AI applications, collaborative content creation for 3D assets, cloud computing, and/or any other suitable applications.

Disclosed embodiments may be comprised in a variety of different systems such as automotive systems (e.g., an in-vehicle infotainment system for an autonomous or semi-autonomous machine, a mapping system associated with an autonomous or semi-autonomous system, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), systems for performing generative AI operations using one or more language models, systems for performing light transport simulation, systems for performing collaborative content creation for 3D assets, systems implemented at least partially using cloud computing resources, and/or other types of systems.

Approaches in accordance with various illustrative embodiments provide for the generation of a text- or language-based representation of a static or dynamic environment. In particular, various embodiments can use a large language model (LLM), or other generative artificial intelligence (AI)-based approach, to generate a tokenized text string representation of an environment, as may include stationary or mobile objects within that environment. A language model can be trained to represent an environment based on not only low-level primitives determinable from captured sensor data, for example, but also the kinematics, semantics, topology, and geometry related to those primitives, as well as the relationships among objects determinable using those primitives. Such learning allows a language model to generate environments that comply with real-world rules and constructs, and that can recognize and account for omissions or errors in the input data to be used to generate a representation of an environment. These learnings can also be used to correct or augment existing representations, such as previously generated maps. Objects in an environment can be represented using sequences of tokens, providing semantics and other information related to these objects. A text-based representation can be a one-dimensional sequence of these tokens, which can encapsulate the important spatial and other types of information of an environment. An advantage of such a text-based description is that it can be discrete and compact, allowing for quick processing, search, updating, and other such operations. A generated text-based representation of an environment can be used to generate several other types of representations useful for various operations or tasks, such as may include birds-eye view maps, high definition (HD) maps, or 3D virtual environments, among other such options.

In at least one embodiment, generative AI can be used to provide a semantic understanding of an environment based at least in part on sensor data captured for an environment. This sensor data can be processed and fed to a trained generative AI model (such as a large language model or “LLM”), for example, which can output a textual description of an environment in a structured textual format (or a domain specific language (DSL)), such as in a Road Topology Language (RTL). A text string in RTL can provide a tokenized language representation of a static or dynamic environment. The generative AI can be trained in such a way as to be able to fill in gaps or correct errors in the sensor data based on a semantic understanding of the objects or elements in the environment. The language model can receive input including kinematic, semantic, topological, and/or geometric information determined for an environment, such as by processing sensor data (e.g., image, RADAR, ultrasonic, IMU, GNSS, LIDAR, and/or other data types) captured for an environment, and can update the representation of a scene as the environment changes due to movement or other such occurrences. The language model may also take other inputs as well, such as prior maps or context information (indicating things like weather, time of day, season, road conditions, urban/rural region, geographic location, etc.). The input data can be represented by embeddings, feature vectors, or points in a latent space, which allows for relatively simple searching for similar environments. In this way, quick determinations of actions to be taken in an environment can be made by determining which actions were taken in similar environments, particularly when there may be insufficient data available for a current environment or situation to make a high confidence decision as to an action to be taken. The ability to determine what others have done in similar environments can help a system to function in a way similar to how a human uses “intuition” in a given situation even when there may be data missing, such as where snow may have obscured the lines along a road but the human can infer where to drive based on other information available in the environment. Such an approach can be used for a wide variety of geospatial information processing and autonomous driving tasks (such as map building, map editing, map-based navigation, planning and driving) by representing those tasks as document manipulation tasks. A generative AI, once trained, can also be used to generate realistic simulation environments that comply with real-world rules, such as may be useful for testing autonomous or semi-autonomous vehicles, machines, or robots. Such an approach can also be used to correct or update noisy or partial environment graphs or maps. The generative AI model might take the sensor data directly as input or might receive input that is generated from the sensor data in one or more stages of a pipeline, such as stages to extract features and generate embeddings of those features in a latent space that can be provided as input to the generative model.

In at least one embodiment, a tokenized description can be generated for a current location of a vehicle or machine, or other such device or object, based at least in part on sensor data captured by sensors associated with the vehicle or machine. The sensor data can be provided as input to a trained language model (such as a large language model (LLM)), along with potentially other relevant information, to generate a tokenized representation that is representative of the current location of the vehicle. A similarity-based search can then be performed against previously generated tokenized descriptions for various locations or domains, as may be stored in a vector database as vectors in a latent space, learned by a deep neural network (DNN), among other such options. A set of results can be returned where the tokenized descriptions are determined to satisfy at least one search criterion with respect to the tokenized description for the current location, at least with a minimum confidence or match score. For example, the similarity search results may correspond to intersections of similar configuration. As the vehicle moves and additional or updated sensor data is obtained, the tokenized description can be updated, and the search results filtered until a single similar result is obtained with at least a minimum match score or confidence. A geographic position associated with this single match can then be inferred to be the current location of the vehicle. Such information can be useful when a position signal or data is not available or reliable or can at least serve as a redundant source of location information for safety purposes.

The location information and tokenized description of a portion of an environment can also be used to perform tasks such as route planning. In at least one embodiment, a navigation system might have a road-level route plan determined. This road-level route plan can be provided in the form of a tokenized representation to a language model, along with the position and tokenized description of the environment, and the language model can generate more detailed or complete routing information. In at least one embodiment, a language model can determine a sequence of goals from the road-level route plan and can identify routing or path options that satisfy the sequence of goals. The language model can then use its learnings, as well as the semantic and other information provided in the tokenized description of the environment, to optimize over the routing options until a single “optimal” or “optimized” route plan is identified, at least from the identified options, which can then be provided to a control system of the vehicle. The detailed routing data can include more specific instructions related to lane changes or other maneuvers or operations that would not have been identified in the road-level route plan. Further, the compact nature of the tokenized description enables the routing data to be optimized over a much larger portion of an environment than would have been possible using prior map-based route planners.

Approaches in accordance with various illustrative embodiments can provide for the use of language models for various functionalities in autonomous or semi-autonomous systems and applications. Systems and methods are disclosed that use one or more language models (e.g., LLMs) to perform various mapping operations—such as map building, map editing, map-based navigation, routing, planning, and perception, error checking, data cleaning, and data validation, among others. For example, a deep learning model—such as an LLM—may encapsulate domain knowledge about how road networks and/or objects are structured. By training an LLM to predict structure and attributes of a graph described in a domain specific language (DSL)—such as RTL—the LLM learns to establish correct relationships among objects on the road. The RTL may express road, object, and/or other map-related information (e.g., by modeling relationships among lane elements and other map features) using language, such that the LLM learns to interpret the RTL—in addition to natural or conversational language—to generate outputs. An automated process may be implemented to convert existing map information to the RTL, and to convert outputs of the LLM from RTL to a suitable map format (e.g., a format for an HD map deployed in a production vehicle). Such an LLM may be used to solve various challenging problems related to mapping—such as identifying or correcting mistakes or gaps in maps, creating maps from a photo or video stream of road data, creating maps from aerial or satellite images, and/or creating maps from text descriptions. Once created, the maps can be used for various tasks, such as for autonomous vehicles (AV) or autonomous systems, semi-autonomous vehicles or systems (e.g., for advanced driver assistance systems (ADAS)), simulation systems (e.g., for developing or testing/validating AV/ADAS algorithms or for creating training data for AV/ADAS perception), and/or the like.

In contrast to conventional systems, the systems and methods of the present disclosure can adopt a language-model-based approach that allows for model training on large-scale maps—making data driven performance improvements easier and more scalable with respect to domain expertise. For example, the LLM may be trained to identify a next token in a graph using an underlying knowledge of how road objects and networks are connected in addition to road graph data that has already been presented to the LLM. This language model-based approach also naturally extends to support training with human input or feedback, and automatic or interactive application of trained models in geospatial information processing with or without human collaboration. For example, models can be trained or fine-tuned with question-answer pairs to gain the capability of responding to human query or guidance regarding some map, environment represented with RTL. Various tasks may be unified in geospatial information processing using a shared formulation such that the same algorithmic models can be reused without extra engineering effort. Processing efficiency can also be improved by replacing manual labor with machine learning model-based automation.

Variations of this and other such functionality can be used as well within the scope of the various embodiments as would be apparent to one of ordinary skill in the art considering the teachings and suggestions contained herein.

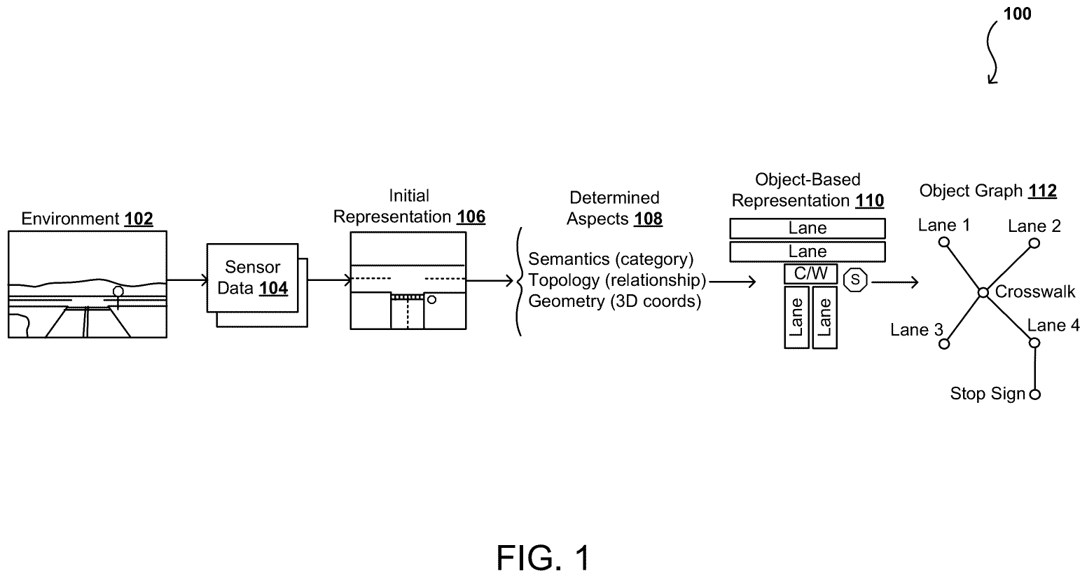

FIG. 1 illustrates an example data processing flow 100 that can be implemented in an environment representation and/or reconstruction system in accordance with at least one embodiment. In this example, sensor data 104 (or other raw data captured or representative of an environment) is obtained with respect to a specific environment 102. The environment can be any appropriate physical environment, such as an indoor or outdoor environment that may include any number of different types of objects or elements. The sensor data can include data captured or obtained using any of a number of different types of sensors, as may include cameras, LIDAR systems, RADAR systems, sonic sensors, distance sensors, and/or the like. Additional data may be obtained that relates to the environment 102 as well in various embodiments, as may relate to basic map data, contextual data, motion data, or other such data, which may also be obtained for virtual, augmented, or enhanced environments. In this example, the sensor data 104 (and any other available and useful data) can be used to generate an initial representation 106 of the environment 102. In at least one embodiment, this may include a point cloud representation of the environment 102 generated by analyzing and aggregating the sensor data 104 that may have been captured by multiple sensors to generate a single, n-dimensional (e.g., 2D, 3D, or 4D) representation of the environment. Other initial representations can be generated too, as may depend on the sensor data provided. If image data is provided, the image data may be analyzed to determine feature and depth information, which can be combined from multiple images from different viewpoints to generate a 3D representation of the environment 102, or at least objects and shapes within that environment.

This initial representation 106 of environment 102 can be analyzed to determined aspects 108 of the environment. For example, a point cloud can be analyzed to determine the categories (or types) of objects represented in the environment, as may relate to roadways, traffic signs, sidewalks, buildings, and the like. The representation can also be analyzed to determine the locations of these objects in the environment, as may be defined using a set of 3D coordinates relative to a chosen origin location. The initial representation 106 can also be analyzed to determine various relationships among these objects, such as where a crosswalk crosses specific lanes or where a stop sign is associated with a specific lane and indicates an expected behavior. Once these determined aspects 108 are obtained, these aspects can be used to generate an object-based representation 110 of environment 102. Various other types of representations can be generated as well within the scope of various embodiments. As illustrated, the object-based representation 110 will not be a comprehensive description of the environment 102 in this example but will instead focus on the types of objects or features of the environment that are potentially relevant to a particular task. For autonomous driving, for example, the object-based representation may include objects such as road lanes, crosswalks, intersections, and the like, but may not include objects that may not be directly relevant to driving, as may include buildings, billboards, mailboxes, and other such objects, except to the extent those objects may be relevant to a specific operation or task. In this example, the object-based representation 110 also does not include vehicles, pedestrians, or other movable objects that will only be in specific locations in the environment 102 at specific times, but any or all of these and other such objects could be included in the representation as well within the scope of various embodiments.

From this object-based representation, an object graph 112 can be generated that provides a different representation of the environment 102. An advantage of object graph 112 is that it is relatively lightweight and can be used to compactly describe aspects of the environment 102 that are important for a particular task or operation. For example, such an object graph 112 could be provided to a map generator to generate an HD map (or other such map or representation) that can be provided to an autonomous vehicle to make navigation decisions. Such an object graph 112 can also be provided as input to an environment generator that can generate a realistic 3D virtual environment that can be used for tasks such as robotic simulation or digital world recreation. Many object graphs can be stored to represent different environments, which can require significantly less memory or storage capacity than sensor data, such as many high-resolution images. Such object graphs can also be analyzed quickly to allow for real-time or near real-time operations, such as autonomous or semi-autonomous navigation or control.

A challenge with existing approaches to generate such representations is that there is a limited ability to perform automated geospatial information processing, particularly using an algorithm framework that is sufficiently generic to support a wide variety of use cases. Existing solutions typically have task-specific designs that cannot easily adapt to new task requirements, contain built-in assumptions that might not always hold in real-world situations, and do not make effective use of available data and human input. Existing approaches are also limited in their ability to learn from large amounts of diverse data that can be relevant to these different tasks or use cases. Many existing solutions depend heavily on domain expertise and manually designed logic or rules in various steps of the processing pipeline. These attempted solutions are difficult to accurately complete and improve, requiring manual effort to moderate the results and make them correct. Improvements to these systems are costly and generally offer smaller and smaller performance gains for the effort spent.

Approaches in accordance with at least one embodiment can provide a versatile approach to processing information about such an environment 102, as may include geospatial and semantic information. In at least one embodiment, a deep learning model can be used that encapsulates domain-specific (and/or agnostic) knowledge about how objects in an environment are structured and related. An example deep learning model is a large language model (LLM) that can be trained to generate a textual description of an environment that retains semantic understanding of an environment in addition to providing information about the categories and locations of objects in the environment. In at least one embodiment, an LLM can generate a tokenized text string as a representation of an environment, where objects in the environment are represented as tokens in the string, that provide semantic and/or relationship information with respect to the various tokens of the string. In addition to generating a compact yet thorough representation of an environment, for example, an advantage of using a model such as an LLM is that the LLM can fill in gaps in the sensor data or otherwise make corrections where needed to provide a more accurate representation of the environment. For example, training an LLM to predict the next token in the text string (corresponding to a next object in an object graph, for example) can help the LLM to learn to establish correct relationships between objects in the environment. This can include, for example, identifying or correcting mistakes or gaps in environment representations, creating environment representations (e.g., maps or object graphs) from a photo or video stream of environment data, creating environment representations from aerial or satellite images, and creating environment descriptions from textual descriptions, among other such tasks.

In at least one embodiment, a language model-based approach can be used that can allow model training on large-scale existing environment representations, such as maps, making data-driven performance improvements easier and more scalable with respect to domain expertise. A training approach can be used that can specifically teach the LLM to identify the next token in the graph. In at least one embodiment, an LLM can generate a deep underlying representation of how objects in the environment are connected or related, as well as a model of the graph data already presented as input to the LLM. In at least one embodiment, various tasks in geospatial information processing can be unified under a shared formulation, such that the same algorithmic models can be re-used without extra engineering effort. Processing efficiency can be further improved through replacing manual labor with machine learning model-based automation. A large language model can be trained on vast amounts of environment data so that it can automate various tasks such as missing element detection, inaccurate element correction, and inference of relationships among elements, among other such tasks. Each of these can be achieved without heavily depending on human expertise to explicitly design for and can be improved continuously with additional training data. Such a model can leverage existing environment (e.g., map) data without requiring additional data curation and labeling cost. The model can be trained in a task-agnostic way so that the model can be extended to other use cases without significant additional effort. These representations can include, or be used to generate, high quality maps useful for tasks such as those related to an advanced driver assistance system (ADAS), autonomous vehicle (AV), unmanned aerial vehicle (UAV) or simulation system, such as may be useful for developing or testing/validating AV/ADAS/UAV algorithms or creating training data for AV/ADAS/UAV perception.

Approaches in accordance with at least one embodiment attempt to improve, optimize, or at least control the way in which an environment is perceived. In various existing systems, perception of an environment is relatively primitive and based around rules for detected objects. For example, an existing system might analyze a captured image to identify the location of roadway lanes and lane markers, but do not have any concept of what the lines on the roadways mean, or how those lines relate to nearby road signs or traffic lights. An existing system might recognize the objects and use the locations of those objects to generate a map reflecting those objects. The system might attempt to determine relationships and apply rules to these objects to ensure the placement makes sense and determine any relationships, but this is typically done during post-processing when most other data has already been discarded. Applying rules based on detected objects means that it can be difficult to detect gaps, errors, or omissions that might otherwise be detected if the relationships and semantic meanings of various objects in a scene were known and used in the process of generating the representation of the environment. Further, a rules-based approach is harder to scale in many instances, and requires a human understanding of rules as they change from location to location, town to town, city to city, state to state, country to country, warehouse to warehouse, etc.

An approach in accordance with at least one embodiment can obtain and apply such knowledge earlier in the process. As mentioned, a large language model can take input relating to the semantics, location, and relationship between various objects in an environment, and can use this information to determine based on its learning how to generate a realistic environment representation from this input that can make up for the fact that the input data may be somewhat incomplete or erroneous. By representing the environment through a textual- or language-based representation, a language model can apply its learnings to determine how to structure the representation to ensure realism, completeness and fill in gaps in the input data based on what it has learned from similar situations. A language model has the advantage of taking text as input, rather than images or other large instances of sensor data, which can be processed relatively quickly during training. This allows a generative model to be trained using millions or even billions of such documents, with self-supervision, which provides for better understanding of behavior and relationships, as well as which behavior and/or relationships apply to a given environment or situation. By converting an object- or feature-based representation into a language representation, for example, this text-based representation can be used to train a language model to understand the various correlations between categories of objects and their relative locations, including ways that may be difficult to enumerate comprehensively. Attempting to capture all the relevant real-world correlations, relationships, and other semantic aspects would be extremely difficult to do using only explicit rules as would be required for various existing systems.

In the example of FIG. 1, a language model could take as input an object-based representation 110 and generate what is essentially a tokenized text string representation of the object graph 112. In other embodiments, the language model might be able to take other inputs that would allow for at least some steps in this generation pipeline to be eliminated as separate steps performed by separate processes or components. For example, an LLM could be trained to take in a set of determined aspects 108 (e.g., semantics, topology, or geometry information for an environment or objects in that environment) in text format and generate a tokenized text string representative of the object graph 112 without ever having to generate an object-based representation. Similarly, in some embodiments an LLM can take as input the initial representation 106, or even the sensor data 104, without the need for separate intermediate representations. For example, a model (as part of the LLM or a separate model) can analyze the sensor data 104 for the environment and encode features of the sensor data into a latent space (or other embedding). The LLM can then take a feature vector as input that is a function of these individual latent space encodings and can directly generate the tokenized text string representation of the environment. The features extracted can include kinematics, semantics, relationship, and geometry features, among other such options. Encoding such features in a latent space can prevent this information from being discarded early in the generation process and allow for more accurate representations or reconstructions to be generated.

In at least one embodiment, the tokenized text string can include a sequence of tokens, representing objects in the environment. The tokens can also be in a specific sequence, which not only can be useful in generating an object graph from the text string, but also allows semantic learning to be applied to the sequence of tokens as an LLM might typically do for the words of a sentence. Several languages can be used to represent such an environment, as long as the language is able to provide the representation as a sequential notation of discrete tokens. In at least one embodiment, a custom language might be used that includes specific tokens that can accurately and compactly represent a specific type of environment. For example, a road topology language (RTL) might be used that includes terminology and syntax useful for representing map data for environments including roadways. A unified, sequential, tokenized text representation can be used to model a graph, and a graph can be quickly generated from such a sequential tokenized text string in a way that is consistently repeatable. A language model can be trained to understand and “speak” in at least one specific language, such as RTL. As a trained LLM will know how to manipulate or fill in a sentence in natural language, so can an LLM learn to fill in a text string in a structured representation language. The LLM can also infer relationships between objects based on its understanding of the language. The LLM can then generate a unified text representation of an environment that can include information that was not present or determinable from the input alone but that allows the environment to be more realistic and to comply with real-world rules and/or constraints. These may include, for example, local traffic rules or ordinances, customs, and abilities of objects in the environment, among other such options. The language model can be trained to learn the semantics and syntax of the language, as well as the reasoning behind the semantics and syntax, including the physical concepts behind various object relationships. Instead of considering lane boundaries as lines in space, an LLM can consider the boundaries as associated with lanes of a roadway that come with various requirements, traffic rule or behaviors, and associated objects.

Although RTL, or other driving/navigation environment type language representations, are primarily described herein, this is not intended to be limiting. In some embodiments, one or more LLMs may be trained on languages for robotics environments (e.g., warehouses, factories, facilities, labs, buildings, etc.), languages for aerial vehicle environments, languages for circuit board, chip, semiconductor, and/or other hardware layout or design structures or environments (e.g., for evaluating a chip layout or structure, designing optimized chip layouts, etc.), and/or other use cases/environments.

A language model trained to generate a representation using such a language can be used in at least one embodiment to describe the physical layout of an environment, such as may be useful for generating high quality and/or HD maps. A model can generate text to describe other aspects of an environment as well, as may include characters, animals, dynamic actors, static objects, vehicles, and/or other objects and elements that might move or change position or pose over time, and that might only be in an environment for a limited period of time. For example, a text string might be generated that provides a representation including a map view that illustrates where a vehicle can navigate, and including representations of pedestrians, other vehicles, buildings, or other types of objects or entities that may be important for navigation or other such tasks. If a language model is able to generate a presentation that accurately describes aspects of the environment including nearby vehicles and pedestrians, for example, then navigation decisions may be able to be made using this representation without a separate need to identify such objects using perception (or in combination with perception) and provide that as additional input to a navigation or control system. An example perception map or representation can be generated that may include anything or everything in an environment that can be perceived using the available sensor data (or other such data) along with understanding of the physical rules or relationships for such an environment.

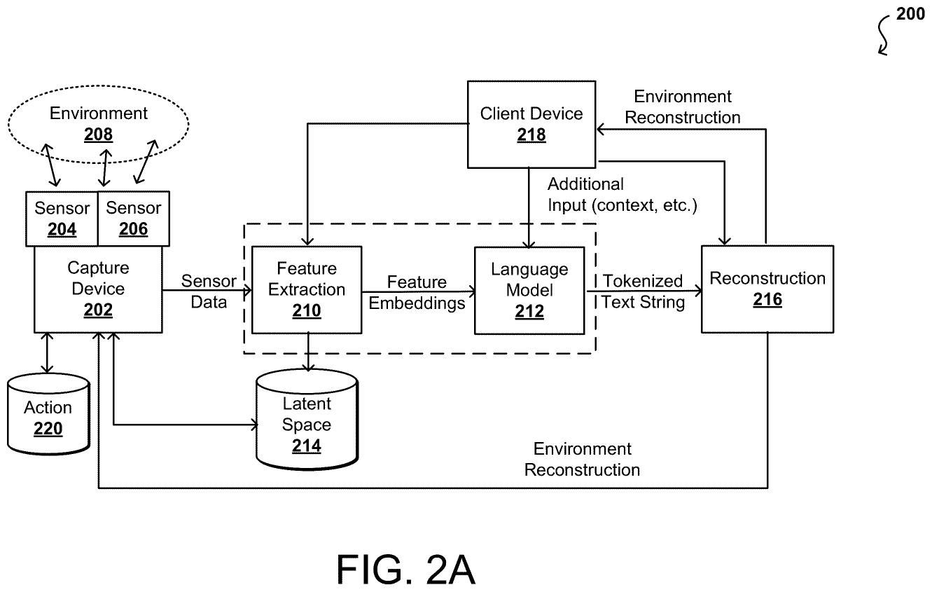

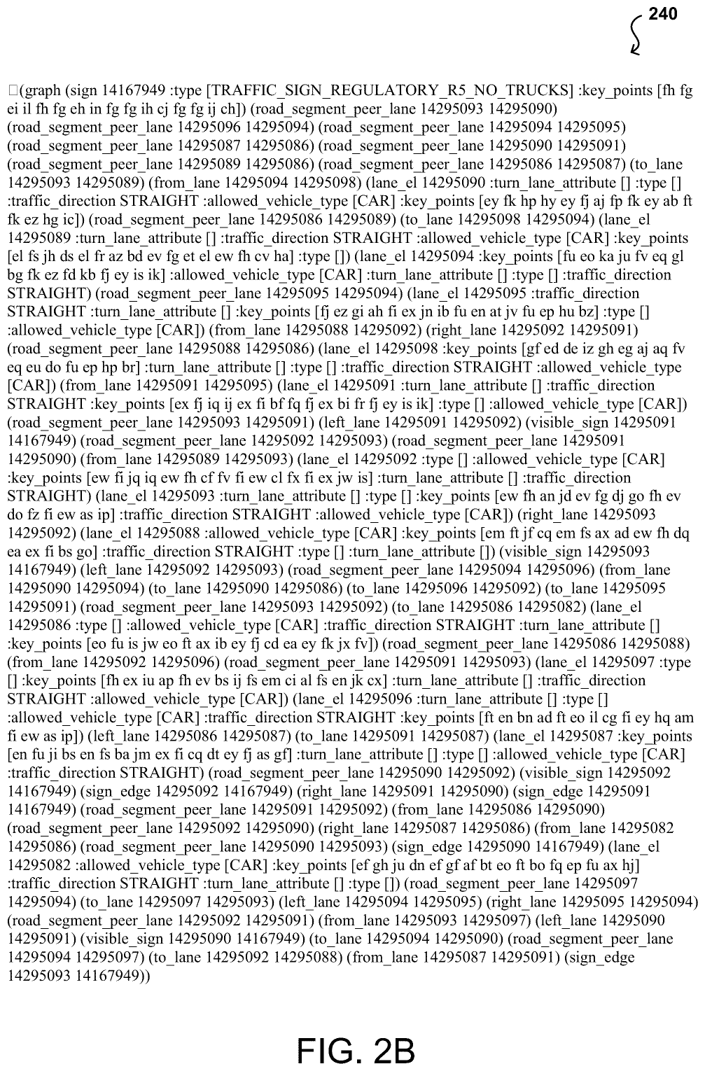

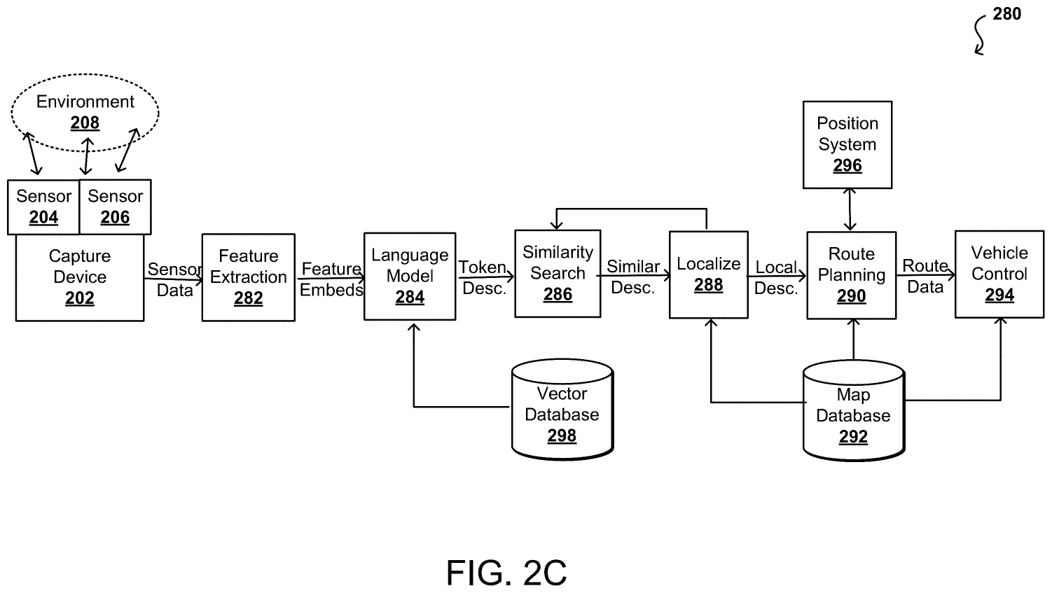

FIG. 2A illustrates an example pipeline 200 that can be used to generate a text-based representation of an environment in accordance with at least one embodiment. Rather than requiring at least some manual interaction, such an approach can automatically generate a representation from a variety of different types of input data. In this example, a capture device 202 can include, or be associated with, one or more sensors 204, 206 that can capture or generate information about an environment 208. The capture device can include any device, system, or component that is able to obtain sensor data from one or more sensors and either process that sensor data or transmit that sensor data for processing, as may include a desktop computer, a smart phone, a vehicle with data processing capability, or a robotic assembly, among other such options. The sensors can include any appropriate type of sensor that is able to capture or generate useful information about an environment, including sensors such as cameras, infrared (IR) sensors, ultrasonic sensors, depth sensors, LIDAR systems, radar systems, or other such sensors or data capture elements. Environment 208 can include an environment in which the capture device 202 is located, or that is within a capture distance of one or more sensors 204, 206.

In this example, the capture device 202 can provide the sensor data to be analyzed by a feature extraction module 210. As mentioned, the feature extraction can be performed as part of a large language model (LLM) 212 or by a separate model or algorithm, among other such options. In this example, the feature extraction module 210 can include an encoder that extracts features from the various instances of sensor data and encodes those features as embeddings or points in a latent space 214. The environment 208 in at least one embodiment can be represented by a set of embeddings or points in latent space, which may then be represented by one or more feature vectors corresponding to those individual embeddings. The latent space 214 may be an n-dimensional latent space, where each environment (or state of an environment) can correspond to a point (or vector) in the n-dimensional latent space.

In this example, at least one feature vector representing the point in the n-dimensional space can be provided as input to a large language model 212. Various other types of embeddings or representations can be used as well within the scope of various embodiments. In at least one embodiment, each object in the environment can be represented by a token in a text string to be generated, as well as an embedding, feature vector, or point in an n-dimensional latent space, as discussed previously. Such a feature vector or embedding can specify not only the type of object but can also represent various features of that object that can help to encode, for example, semantic, geographic, and/or topological information for that object.

The language model can use this input to generate a tokenized text string that is representative of the environment. In this example, the language model might receive other input as well that may help to generate a more accurate representation. For example, the language might receive a prior or partial map or environment representation, or prior tokenized text string (e.g., for a prior time point or nearby location) to which the language model can refer, and which can help with consistency of representations over time, such as where the environment is being reconstructed for a vehicle moving through an environment and comparing the inferences for each time point can help to improve accuracy by reducing noise or removing false positives (or at least flagging inferences that do not make sense based on a prior determination, such as where an object type has changed or suddenly appeared out of nowhere). Various other types of input can be provided as well. For example, a user might use a client device 218, such as a desktop computer or notebook computer, to provide input that can guide the generation of the tokenized text string. For example, the client device might provide contextual information that can help to guide the generation. Contextual information might include, for example, a type of environment, such as indication of an urban or rural setting, which can help the model to apply the appropriate set of rules. As an example, some of the relationships between road objects may be quite different in downtown Manhattan than they are in rural Montana, although various other relationships may be quite similar. The contextual information might indicate the state or country in which the sensor data was captured, as different states or countries often have different traffic or behavior rules, such as which lanes vehicles are allowed to turn into at an intersection. The contextual information might include information about the weather or time of day, as sensor data for a snowy, rainy, or nighttime environment might lack data for objects that might otherwise be observed during a sunny daytime capture period. Further, different behavior or rules might be appropriate at night or other situations where visibility may be limited. As discussed later herein, where a simulation environment is to be generated based upon embeddings in a latent space 214, for example, the additional input from a client device 218 can help to determine aspects of the simulation environment to be generated.

Tokenized text strings generated by large language model 212 can be provided to various components for various tasks. In some embodiments, a reconstruction of environment 208 might be performed by a reconstruction module 216 or system, such as to generate a high-definition map or 3D digital model of environment 208. In some embodiments, a text string and/or reconstruction might be provided to a control or navigation system for an autonomous vehicle or robot to allow decisions to be made about how to move or interact with respect to objects in the environment. In this example, the initial capture device 202 might be on or part of a vehicle or may in some embodiments be the vehicle (or robot, etc.) itself. The reconstruction of the environment can be provided back to the capture device for use in performing specific tasks. For example, if the capture device is an autonomous vehicle or driver assistance system, the reconstruction (or in some embodiments the tokenized text string) can be provided back to the capture device—which captured the initial sensor data using associated sensors 204, 206—to perform operations such as to make navigation or operation decisions based in part on the reconstruction.

In at least one embodiment, the reconstruction can be provided to a client device 218 for presentation or analysis, which may be the same client device that instructed the reconstruction. The client device 218 can analyze the reconstructed environment for accuracy and completeness in some embodiments or can perform various operations or simulations with respect to the environment. The client device 218 may also provide additional information, such as context, to the reconstruction module to use to generate the environment. For example, the client device might instruct the reconstruction module 216 to generate multiple reconstructions of the same environment 208 using the same tokenized text string, but under different conditions. This may include, for example, versions of the same environment in summer during the day, winter at night, in Europe versus Asia (which can impact the language and style used), and so forth. During model training, the tokenized text string and/or environment reconstruction can be compared against appropriate ground truth data in order to determine a loss value and update the parameters for the appropriate model.

In this example, the feature extraction and language generation operations may be part of the same or separate models. For example, a first model (e.g., an encoder) might take the sensor data as input and output a set of embeddings or latent feature vectors as output that can then be provided as input to a generative model (e.g., a large language model). In another embodiment, a generative model may include feature extraction or analysis capability and can generate a tokenized text string as output without any intermediate or other steps to process or analyze the input sensor data. Referring to the description of FIG. 1, a language model can be trained to take input from any of various stages of a representation generation pipeline. For example, a language model can take the raw sensor data as input or can take as input an initial representation (e.g., a point cloud) generated by analyzing that sensor data using a separate module, system, component, model, algorithm, or process. Similarly, the model might take in determined aspects or information as may relate to the kinematics, semantics, topology, or geometry of an environment, or might take as input an object-based representation generated for the environment, among other such options. In at least some embodiments, the type of input to be used may depend at least in part upon the system in which the language model is to be used, as different systems may already provide specific outputs to be used. In at least one embodiment, a language model might take the raw sensor data and such an intermediate representation as input, in order to attempt to provide more accurate or consistent representations. In some embodiments, multiple language models may be used. For example, a language model might be used to determine the semantics, topology, and geometry of an environment that are then to be fed as input to another language model.

In some instances, the tokenized text string and/or reconstruction generated for an environment may be incomplete for any of a number of reasons. For example, it might be snowing and some of the lane markers may not be visible or accurately represented in the sensor data. In other instances, a stop sign may have been damaged and not visible, or there may be an object obstructing part of the environment. In such situations, it may be difficult for an operation or task to be completed accurately or successfully based on the lack of complete information. Using a system such as that illustrated in FIG. 2, however, decisions can be made based on other decisions that were made in similar situations and environments. For example, during the feature extraction and encoding stage a point can have been determined in an n-dimensional latent space that represents the extracted features. While the set of features will not be complete due to the incomplete sensor data, a search can be performed in the latent space 214 for nearby points, which would represent very similar environments. This could include, for example, similar intersections in different locations, or even previously generated embeddings for the same general environment. Other types of feature-or embedding-based searches can be performed as well within the scope of various embodiments. Once similar environment(s) have been determined through such a search, a database 220 of actions taken in those environments can be analyzed to attempt to determine, with at least minimal probability or confidence, an action to be taken in the present environment 208. For example, a lane marker or traffic signal may not be visible but based upon what other vehicles (or even the same vehicle) in other environments have done in similar situations, a determination can be made as to the correct action to be taken in the current environment 208. Such an approach can allow a vehicle navigation system to function like human intuition, where a decision can be made as to the most appropriate action to be taken based on the information available and what has worked properly in similar situations in the past. For example, such an approach could allow an autonomous vehicle to operate in the snow even when lane markers are not visible based on the locations of objects such as road signs, traffic signals, other vehicles, and so on, where an appropriate location and action of the vehicle can be determined based upon what other vehicles have done in similar situations. In these similar situations the lane markers would likely often have been visible, so the data should be reliable. Such an approach can help to further fill in gaps or omissions in the input data.

A search process based at least in part on features, embeddings, or tokenized text strings can be relatively fast and lightweight, which can be important for tasks such as real time vehicle navigation or automation control. The search can also help to provide additional information for generating more accurate text strings or reconstructions. For example, when a set of feature embeddings is determined for an environment, a search can be performed to identify other environments that are very similar to the current environment or the same environment at a past point in time. Once determined, information about these similar environments can be analyzed to attempt to provide additional information, such as contextual information that may be able to help the text string or reconstruction to be more accurate. For example, the locations and relative spacings of various road signs may help to indicate the country or region in which the environment is located, the weather, a language in which signs are likely to be presented, and so forth. In some embodiments, embeddings or feature points from these similar environments can be provided as input to a language model to attempt to provide a more accurate tokenized text string, or better understand the relationships between objects detected from the sensor data.

The ability to compare a current situation to similar situations in similar environments can help with other tasks as well. For example, the prior observed behavior of people and vehicles in similar environments can be used to predict what similar objects are likely to do in the present environment, which can help make better decisions on the best course of action to take at the current time in the present environment. For example, where and when people are allowed to cross a street, as well as the likelihood of a person crossing the street, may vary in different locations, and understanding the likely actions in each location based on past observations for similar environments can help to avoid collisions or other undesired occurrences. Such an approach can help to provide a semantic “understanding” of an environment at a specific point in time and can help to generate various types of representations or determine various actions to take based at least in part on that understanding, as well as what is known about similar environments.

Referring again to the description of FIG. 1, a tokenized text string can effectively provide a different representation of an object graph. This can allow such an approach to be used with existing systems or processes that expect such a graph as input. Approaches presented herein can provide accurate object graph representations in the form of tokenized text strings, for example, which can be generated quickly, accurately, and automatically without human intervention in most cases. As mentioned, such a process can also help to fill in gaps or make corrections in the object graph that might not have been determinable from the sensor data or related input. In at least one embodiment, particularly where a language model undergoes continued learning, the model may learn new relationships or object types that may help to build more robust object graph representations and can infer additional semantics or relationships which can help these object graph representations to become more accurate over time. The syntax of the relevant description language can be updated over time to more accurately capture or reflect these additional learnings. In at least some embodiments, a tokenized text string can be equivalent to an object graph, just in different form. In other embodiments, a tokenized text string may include additional information that provides more context, understanding, or insight than might be available using a conventional object graph, and may include relationships that might not be indicated using such an object graph, including relationships that might not be easily explainable using natural human language.

As mentioned, a language model can apply learned rules to an environment like how a language model would have applied language rules to natural language text. Similar to how a model learns correct sentence structure, the model can learn correct environment structure, such as how lanes and roadways interrelate and are permitted to be designed. This can prevent the language model from generating a text string that indicates that lanes cross each other outside intersections, that certain intersections can be free of traffic signals or stop signs, that onramps can end short of the connecting highway lane, and so forth. The semantic understanding of these relationships can help to fill in this information even where the sensor data did not include sufficient data to otherwise provide this information or was otherwise unclear as to how it should be interpreted. The language model can use its learning and semantic understanding to properly interpret the data that is available and can refer to data for similar environments in at least some embodiments when it is appropriate or necessary. In some situations, there may be an object observed that cannot be identified with a sufficient level of confidence—such as where the object is partially obscured or damaged or is of a type or style that has not been previously encountered. The language model can rely upon its learnings to make a more accurate and/or confident determination of the type of object based on, for example, the other objects in that environment and the types of objects which typically have relationships to those objects. For example, an intersection will typically have a stop sign or traffic signal, while a highway will not and may be more likely to have an express lane or a mile marker. The ability to know what type of objects to expect for a given environment and/or context, as well as where those types of objects would typically be in that context, a language model can improve aspects such as object recognition even for objects that were not previously encountered or are at least partially obscured.

In some embodiments, such as where an environment is to be generated for simulation that complies with real-world rules, a user might augment sensor data to include additional (or alternative) objects in the reconstruction. For example, a user might use client device 218 to submit information about a pedestrian bridge that is to be added to an environment represented in captured sensor data. Appropriate embeddings for the bridge can be determined and encoded into the latent space for the environment. In some embodiments, the user might view the reconstruction on the client device 218 and make modifications, which can be provided as updated input to the large language model 212 to provide an updated tokenized text string and environment reconstruction. In some embodiments, a user can be allowed to generate a new environment reconstruction independent of sensor data. A user might provide input (e.g., speech or text) describing an environment, and this input (after any appropriate reformatting or analysis) can be used to select an appropriate point in latent space 214, which can then be provided as input to the language model to generate an appropriate tokenized text string. In some embodiments, the user input may be able to be provided directly to the language model as input, without the need for separate feature extraction or embedding generation. Such an approach can be useful for simulation environment generation, where a large amount of environment data can be generated synthetically without extensive cost or manual effort, which can be beneficial for training machine learning models or other artificial intelligence systems to operate in these various simulated environments. An environment generation process can then generate environments automatically, in response to human prompts, or through a combination of both. Modifications to the environment can be made relatively quickly and without significant processing through updating of the tokenized text string.

In at least one embodiment, an environment generation and/or reconstruction system can work with various data formats and can perform reformatting or restricting as appropriate. For example, data might be received in map, object, or graph format and can be converted to tokenized text string in a structured language. Similarly, such a text string can be used to generate any of these or other such representations of an environment. The text can also be regenerated to correspond to a different human language, as the same language (e.g., RTL) may have different terms or descriptors in different human languages (e.g., French or Spanish) for similar types of objects or relationships. When specifying the context such as the country or region, a language model can also learn to speak a language in which it may not have been initially trained and can learn to use the terminology that is appropriate for a given location or context. It may be the case that components of a system all speak in a structured token-based language internally but may accept input or generate output in any of a number of different formats. Using structured language to communicate internally can help to ensure that no data regarding semantics, relationships, or other such aspects are lost during processing and analysis due to the type of format being used.

As mentioned, a language-based representation can be very compact and discrete. Such aspects make language representations beneficial for use in real-(or near real-) time, real-world environments as the representations can be updated quickly and accurately and can be updated to include only that information that is relevant at the current time. For example, a language model might be used with a navigation system of an autonomous vehicle to make real-time navigation determinations. The ability to make these decisions is critical for many such applications. As the vehicle moves, the language representation can be updated to include portions of the environment that are now visible to the sensors ahead of the vehicle, for example, and can remove or delete portions that are no longer visible or are otherwise determined to not be important to navigation and the current location given the current direction and rate of motion, or other such aspects. Similarly, as another vehicle enters the roadway near the current (e.g., ego) vehicle, a representation of that other vehicle can be added to the language representation, while vehicles exiting the roadway or being more than a threshold distance away from the ego vehicle may be removed. Such an approach can allow the language representation to be easily right sized, such that it can contain all the information determined to be important and an exclude any information that is determined to be irrelevant, or at least no longer relevant based upon the current position, speed, direction, etc. Keeping a dynamic language representation current but compact can help to make better, faster decisions by only including the information needed to make decisions at a current (or near future) point or period in time.

As mentioned, a language model in at least one embodiment can be self-supervised. A language model can be trained to understand the structures, patterns, syntax, relationships, and other aspects of the language(s) on which it is trained. The trained model can then take in text (or other language input) for a new environment and generate or reconstruct that environment based on its learnings or can take in an incomplete or inaccurate representation of an environment and can generate a corrected or more complete representation. And this can be an end-to-end automated process with no need for human intervention, as opposed to prior systems that required human intervention at some if not all stages of map generation. When a model learns that it made a mistake and/or is able to correct a mistake or omission, the model can learn from that in order to make better future decisions. Such an approach can help to generate far more accurate representations that would be possible, or at least practical, with human-generated systems, as there can be many more rules or relationships for an environment such as an intersection or parking lot than may be practical for a human to attempt to accurately code, particularly when many of these rules or relationships might be implicit such that a human may not consciously even be aware they exist. A language model can learn these and other such rules and relationships without coding or supervision, which provides a significant advantage over prior mapping or reconstruction systems.

In one example, a language model can be used to generate or correct a representation such as a high definition (HD) map. An HD map generally is a type of map used for tasks such as autonomous driving, which may contain details or information that are not typically included in, or associated with, a conventional map. In an example HD map, individual sections of a roadway are encoded separately. These encodings can differentiate regions corrupting to different lanes in an intersection, for example, as well as potentially options for navigating on those lanes. Such information can be helpful in an intersection where there may not be painted or explicit lane markers for each available lane in each direction. This information helps a navigation system to function more like a human would, having the ability to understand implicit information based on context, but using previous systems these aspects needed to be hard coded and were thus limited in scope and difficult to scale. Each feature in the road can be represented by a node in a graph associated with the HD map. A language model can take this information and can make corrections or additions based on its understanding of the relationships and semantics of the environment, which can account for implicit inferences typically performed by human beings that can otherwise be difficult to design or instruct an automated process to perform. While aspects such as critical road boundaries may be relatively straightforward to code using a manual approach, for at least some environments, coding more implicit operations such as how to maneuver relative to a crosswalk in a complex urban environment (where the options can differ based upon the number and locations of people in that crosswalk at any given time, the state of crossing signals which may not all be visible, and decisions of people to not follow the rules and cross against the light or jaywalk, etc.) or to navigate through a detour or unique construction region can be much more difficult for a traditional system, and can benefit from the inferences and similarity determinations able to be performed using a language model as presented herein.

In at least one embodiment, a vector-based search can be used to find similar vectors (or other embeddings or encodings, etc.), such as may correspond to a very similar intersection, for use in inferring aspects of the environment or actions to take with respect to that environment, particularly where the raw sensor data may be inaccurate or incomplete. Such an approach is thus not a rule-based search, but a similarity-based search based upon what is determinable about an object or environment. Such a search can be performed quickly using incomplete or slightly inaccurate information, which can provide significant advantages over rules-based search and can allow for results that are not an exact match. An embedding can also represent various uncertainties with respect to an object. Such an embedding can also be a very lightweight representation that requires little storage capacity or bandwidth or streaming or transmission. As additional information is obtained for an object, the embedding for that object can be updated as well.

A language used with such a model will be somewhat lossy in many instances, so it can be important in at least one embodiment to attempt to encode features in that language in such a way as to retain as much important information as possible. For example, an image can contain many details about a person or vehicle, and many of these details will be lost in a compact language description. For many aspects this will be acceptable, as information about the general appearance or clothing of a person will typically not impact the decisions made by a vehicle with respect to this person, such as to avoid coming within more than three feet of that person at any time. A type of object may thus be used as a primary type of token, but there can be additional details or information stored on the token in a token-based text string. In at least one embodiment, geo-coordinates are stored as well so all nodes or tokens have well-defined places in space in addition to information about connectedness or relationships. The nodes thus store information about geometry in addition to information about semantics and topology. The information can also be general enough to support multiple domains or tasks that may involve similar types of objects.

In at least one embodiment, this additional information can be generated using conventional algorithms or machine learning, among other such options. For example, one or more machine learning models can be trained and used to provide information about the semantics, topology, and geometry (or other such aspects) of an object or environment. This can include the use of one or more language models that can take in various types of input and output a textual description of, or textual content for, any of these aspects. In some embodiments, the raw sensor data can be provided as input, while in other embodiments there may be at least some amount of pre-processing, such as to determine bounding boxes around objects and extract the relevant image data or perform basic object classification based on operations such as computer vision-based analysis, among other such options.

FIG. 2B illustrates an example tokenized text string 240 that can be generated for an environment in accordance with at least one embodiment. As illustrated, the string is a tokenized and sequential text string that represents individual objects as tokens, like nodes of a map graph. In this example, there are objects of types such as signs, lanes, and vehicles that are represented by tokens in the text string. Other information is encoded as well, as may relate to key points or geometry for the various tokens with respect to the environment. The key points—indicated by lettered pairs in the string used to encode geometric coordinates in the environment—may be used to indicate geometric coordinates or bounds of a lane, or section of a lane, for example. Although the example text string is rather long (as may include thousands of tokens for a single environment), the text string provides the necessary information to perform tasks such as navigation or driver assistance in a much more compact form than if the data were a set of high-resolution images or a high-density point cloud representation of the environment. Although a single text string is illustrated, it should be understood that in at least one embodiment there may be multiple text strings generated to represent different portions or features of an environment. Also, different types of information can be used with a text string as is appropriate for a given environment in a specific embodiment. In this example, the text string is generated using a specific language, such as RTL. The language is structured so that the text string will be both discreet and sequential in its tokenized (one-dimensional) representation. In at least one embodiment, a generated text string can be auto-regressive in that an individual token in the string will depend in part upon the previous token(s) in the string. As mentioned, a language model can be trained using an unsupervised (or self-supervised) approach in order to be able to cover the wide variety of concepts needed, without the need for a very large and varied corpus of annotated training data. In at least one embodiment, even though the text string is tokenized and sequential, there can be few other structural limitations placed on the generation of the string in order to prevent those limitations from becoming a bottleneck that can negatively impact performance due in part to the large amount of input data that may need to be processed. The structure may be flexible, similar to how there can be many valid ways to flatten a map graph or object graph that are all equally valid. There may also be many different valid object graphs to represent the same environment, and the generation of a tokenized text string can have similar flexibility. This flexibility also helps the text string generation to be able to better update over time, as well as to scale to include larger or smaller numbers of tokens based at least in part upon changes in the relevant environment.

In at least one embodiment, a variety of different types of information—such as existing map data or geospatial information—can be used to generate graphs as discussed herein, which can encode information such as semantic, topological, and geometric information using nodes and connecting edges of the graphs. As mentioned, such graphs can be represented in a language that is human readable, easy to extend, and informationally at least equivalent to original maps. Large scale language models can be trained with documents in this language, such as those generated from existing maps or perception data, for example, and tuned to be able to follow instructions in natural language. With a trained language model, every node or edge of a map graph can be mapped to an embedding vector, encoding information such as its semantic types or attributes, topological connections in a local graph neighborhood, and 3D spatial locations and geometric shapes, among other such information. Such an approach can allow for highly efficient and scalable search functionality with common techniques such as nearest neighbor search and hashing tricks. These similarity-based search approaches can be used for tasks such as localization and route planning.

Route planning and other use cases can be treated as problems of finding optimal sequential actions on graphs. Various approaches can be leveraged to then solve these problems. As one example, approaches may utilize classical graph algorithms such as Dijkstra's algorithm, Prim's algorithm, breadth-first search, or depth-first search algorithms to perform tasks such as find and sort vertices, determine shortest paths, etc. Various approaches can also leverage learning-based approaches such as may be based on reinforcement learning. For example, a shortest path problem has known solutions that can be readily adopted, while in many other cases learning-based methods such as reinforcement learning can be applied to make such determinations.

In at least one embodiment, a relatively simple data representation can be used that is at least equivalent to original maps and native to language models. Such an approach makes such a representation intuitive for human users to interact in natural language. A unified framework can be used to formulate various tasks using maps as optimal sequential actions. Such an approach allows for the leveraging of various powerful capabilities of large language models, including abstract reasoning, chain-of-thought, and common-sense planning, among other such options. Such an approach can also take advantage of a learning-based architecture that can be continuously improved through existing maps, data collected from usage of traditional systems, historical computation results, and the like.

FIG. 2C illustrates components of an example system 280 for performing operations such as localization and route planning in accordance with at least one embodiment. In this example, sensor data for an environment can be captured using a capture device 202 and one or more sensors 204, 206 such as was described previously with respect to FIG. 2A. It should be understood that similar reference numbers may be carried over between figures for simplicity of explanation and understanding, but that such usage should not be interpreted as a limitation on the scope of the various embodiments unless otherwise specifically stated. In this example, the sensor data can be passed as input to a feature extraction module 282, which can extract important, unique, or otherwise representative features from the captured sensor data, and may generate one or more feature embeddings representative of the extracted features for a current location within an environment. The extracted features, or feature embeddings, can be passed as input to a trained language model 284, which can generate one or more tokenized descriptions representative of the location in the environment based, at least in part, on the extracted features and potentially other relevant and available information. As mentioned, the tokenized description(s) can include a tokenized text string that can store information such as semantic, topology, and geometry data, among various other types of data discussed and suggested herein. At this point in the process, system 280 has generated a tokenized description of a current location in a physical environment based on the sensor data and/or resulting perception data.

In some instances, at least relatively precise location data may be available, such as from a global positioning system (GPS) device or other such location identification source or system. It might be the case, however, that precise location data may be unavailable, and in some instances, there may be no location data available from a system at all, such as where a GPS device is unable to receive a GPS signal or other such location-specific data. In such a situation, the generated tokenized description based on the determined sensor and/or perception data can be used to attempt to determine the current location. In at least one embodiment, there can be a database, such as a vector database 298, that stores feature vectors (or other embeddings or representations) previously determined for a large number of locations. Such a database or repository may take various other forms as well, such as a latent space or document containing tokenized descriptions, among other such options. In some embodiments, feature vectors stored in vector database 298 can be fed to the trained language model 284 to generate tokenized descriptions for various locations.

In this example, a similarity search component 286, module, service, or process can attempt to identify data for a number of similar locations using a similarity-based search (or similar search or comparison-based approach). Other approaches can be used as well as discussed in more detail elsewhere herein, as may include graph-based route planning. In one embodiment, the similarity search component 286 can take the perception-based tokenized description for the current location and perform a search of stored tokenized descriptions stored for various other locations to attempt to identify a set of similar locations. As an example, the perception-based tokenized description for the current location might be representative of a specific type of ODD, such as a complex intersection. Performing a similarity-based search can result in the identification of a number of similar intersections having tokenized descriptions that are determined, using one or more similarity criteria, to be sufficiently similar to warrant further analysis. While no two intersections will be exactly the same, due at least in part to small variations in relative locations or orientations of objects or features in the different intersection locations, it can be sufficient to identify a set of at least somewhat similar locations or domains, such as similar intersections. If only a single similar location can be identified, and the tokenized description for that single location is determined to correspond (with a high probability) to the perception-based tokenized description, then the location information for that single location can be determined to also correspond to the current location. In this way, the current location was determined from the sensor or perception data based on the result of a similarity search performed using the respective tokenized descriptions.

In many instances, however, there may be multiple similar locations identified, and in some cases potentially dozens or hundreds of similar locations. A localization process can then be performed, in at least one embodiment, to attempt to narrow down these identified similar locations until a single tokenized description is identified as similar, and the location associated with that similar tokenized description can then be used as the current location. In at least one embodiment, the localization process will be performed for a moveable object, such as a ground-based vehicle, aerial vehicle, robot, or nautical vehicle, among other such options. The vehicle can use the sensor data for a current location in a physical environment to determine how to navigate within that environment. As the vehicle begins to move, the available sensor data will change, reflecting new views of objects and newly visible objects, as well as portions of objects that may have been previously obscured or otherwise unable to have at least some data captured. A subsequent points in time, such as at regular intervals of distance or time, or in response to at least a minimum detected change in the captured sensor data, the sensor data can again be analyzed using a feature extraction module 282 of a perception system, and a new perception-based tokenized description can be generated for the new location in the physical environment. This new tokenized description for the new location can then be compared against the previously-identified similar tokenized descriptions for similar locations, and the set of similar tokenized descriptions can be filtered or otherwise reduced based on similarity to the new perception-based tokenized description for the new location. As the vehicle continues to move and updated tokenized descriptions generated for the corresponding new locations, the number of similar tokenized descriptions should decrease as additional information is represented for the route of travel, until only a single similar tokenized description is identified, and the location of that similar tokenized description can be used as the current location. If the single similar tokenized description does not satisfy at least one similarity criterion, however, the process may continue using updated similarity searches against the information in a vector database 298, for example, until a single result is located that sufficiently satisfied the similarity criteria. If no such match or result can be located, the vehicle can operate using the sensor data and any other available information, until the localization system identifies such a match, or until a location signal or data becomes available. If GPS or other data is available but not particularly reliable or accurate for a current location, or does not match any of the identified similar locations, for example, then the GPS data can also be monitored to attempt to reduce the set of similar matches by updating the range of possible locations in the environment over time due at least part to the movement of the vehicle and corresponding change in GPS-reported position.

In many instances, a mapping or routing system will have a general determination of a current location in an environment. For example, a positioning system in the downtown area may not be able to provide an accurate location, such as may be due in part to difficulty in receiving an accurate signal when surrounded by tall buildings, but may be able to provide a general location, such as being able to identify that the vehicle is in the downtown area of a given city. Such information can also be used as a filter or constraint on the similarity search, such that only tokenized descriptions for similar locations in the particular city may be returned, which may result in a much smaller initial set of potential matches for the current location. Various other constraints may be applied as well, such as those discussed or suggested elsewhere herein.

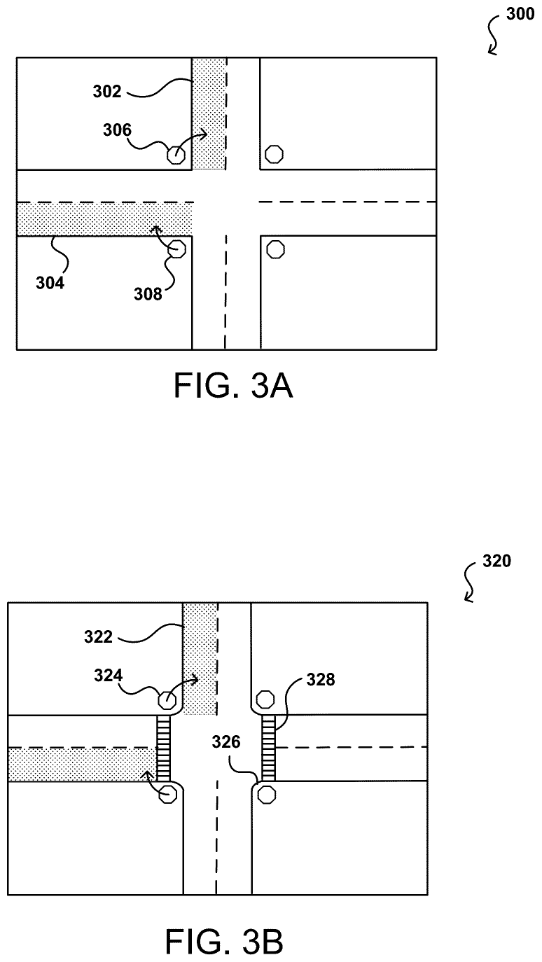

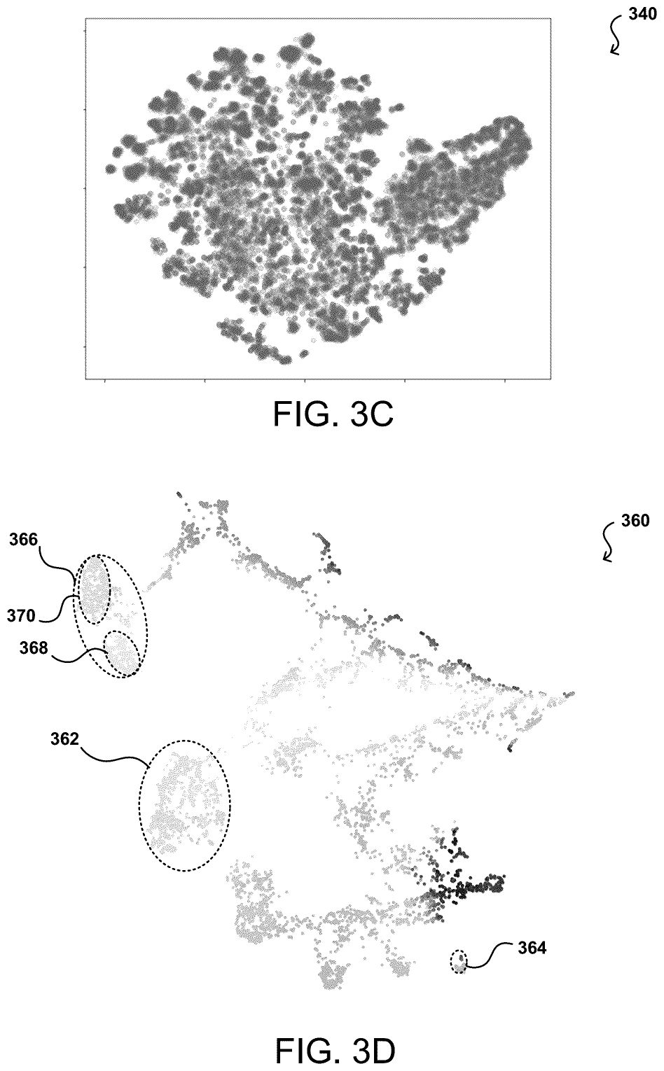

FIGS. 3A and 3B illustrate example intersections that may be identified as being similar using such a similarity search. In this example, a vehicle may be in (or near) an intersection such as that illustrated by the map view 300 of FIG. 3A. The sensor data may capture information about the location in the environment that is representative of the intersection, such as the number and arrangements of lanes, general configuration of the intersection, presence and locations of stop signs or traffic lights, and so on. A perception-based tokenized description can be generated that is representative of this intersection. As mentioned, the tokenized description can include semantic and relationship information, such as may indicate not only the presence of specific lanes 302, 304 and stop signs 306, 308, but indication of which lane is controlled by which stop sign.

A perception-based tokenized description generated for the intersection near the current location can be used to perform a similarity-based search, and may generate a set of search results for locations determined to be at least somewhat similar. As an example, FIG. 3B illustrates a map view 320 of a second intersection that can be identified through such a search. As illustrated, the general shape, configuration, and size of the intersections are similar, such that it can be reasonable to identify the intersections as being similar, such as with similar lanes 322 and stop signs 324. There are at least some differences, however, that show that the current location of the vehicle does not correspond to the location represented in FIG. 3B. For example, the lane boundaries 326 at the intersection are rounded instead of square, and there are crosswalks 328 present in the intersection of FIG. 3B. As additional data is captured, it can be determined that the intersections of FIGS. 3A and 3B are not the same, such that the intersection represented in FIG. 3B can be removed from the set of similar matches. The fact that the perception data for FIG. 3A did not initially include accurate depictions of the types of lane boundaries or presence of crosswalks did not cause the intersection of FIG. 3B to be excluded from the initial set of similar results for at least a couple of different reasons. As an example, a single set of sensor data may be noisy or have some amount of error, and may also be captured from such an angle that the shape of the lanes is not reliably determinable from that single set of sensor data. As the vehicle moves and more data is collected for the environment, and error in position information reduced, it can be determined that the intersections are not sufficiently similar to conclude that they are the same intersection, and on the contrary there can be differences detected that indicate that these are likely not the same intersection, although in some instances representations of locations may become out of date or not capture changes to those locations. Further, the fact that crosswalks were not detected in the first instance of sensor data for the current location should not necessarily rule out the second intersection being similar as the crosswalks may not have been visible for any of a number of potential reasons, such as other vehicles obstructing the view of the crosswalks, snow or water covering the crosswalks, a view angle of the sensors not being appropriate to capture data for the sidewalks, and other such situations. Thus, the intersection of FIG. 3B might initially be identified as being similar to the intersection of FIG. 3A based on the information in the respective tokenized descriptions, but as the vehicle moves and the representation of the first intersection becomes more accurate, it can be determined through the localization process that the two intersections are not the same, and the tokenized description for the intersection of FIG. 3B can be removed from the set of similar locations under consideration.

As mentioned, sensor data (or other data relating to one or more observations of a region or environment) can be captured that can be used to generate one or more representations of one or more regions or domains within a physical environment based upon the perceived data for the region(s) or domain(s). These representations may include, for example, a tokenized description comprising a sequence of (e.g., text) tokens, a 2D map, a 3D map, an HD map, or a virtual 3D environment, among other such options. Approaches in accordance with at least one embodiment can process sets of observations, such as may include sensor data for various locations in an environment, and can generate tokenized descriptions for those locations or portions of the environment. The tokenized descriptions can include token sequences for various objects or features in the environment, with each token sequence encoding semantic, topological, and/or geometric information corresponding to at least the respective feature or object. A given location or region, as may correspond to an intersection, may be described by one or more such tokenized descriptions, which may correspond to one or more feature vectors or embeddings. In at least one embodiment, an entire map (or map portion) for a relatively large region or environment can be represented as a set of embeddings or feature vectors, as may correspond to points in a latent space.

As an example, FIG. 3C illustrates an example plot 340 of points in a latent space that can be generated in accordance with various embodiments. Although illustrated in two dimensions for simplicity of explanation, it should be understood that the latent space can be an n-dimensional latent space, where n is the feature vector dimension, which can be in the thousands, tens of thousands, or more. The example plot illustrated in FIG. 3C does not include labels or units, as the labels or units can depend upon the dimension or feature being presented.

In this example, each point in the latent space can correspond to a feature vector or embedding. Each feature vector can, in turn, correspond to an object, portion, or sub-region of the map. The feature vectors (or embedding vectors) can have tunable granularities in at least one embodiment, as may be appropriate for different use cases. For example, there may be a maximum feature vector size based on capacity or length limits, as may relate to a maximum number of tokens in a string, but the feature vector can have any size up to, and including, such a limit. In other embodiments, there may be a discrete set of granularities from which a user or system can select. For example, there may be some use cases where a vector should represent an entire intersection, a portion of an intersection, or a block containing multiple intersections, and in some instances there may be vectors available for all these granularities. The granularities can be user or system configurable as well in at least some embodiments. In at least one embodiment, granularity should be set such that specific operational design domains (ODDs) are not split but are each represented by a single feature vector. In a mapping use case, there may be multiple levels of detail available between an HD map and an SD map, enabling a user or system to drill down to an appropriate level of detail.

In at least one embodiment, an attempt can be made to divide portions of a map (or other environmental representation) by region, feature, or domain type. For example, all of a given intersection, roundabout, parking lot, or other such domain may be identified as a region of interest. While there may be aspects of each of those regions that might separately be associated with a smaller region, or sub-region, a feature vector or embedding can be determined for each of those individual domains. Each of these feature vectors or embeddings can then be represented as a point in the latent space.

Taking such an approach, each point in the latent space 340 of FIG. 3C may correspond to a unique intersection, roadway, parking lot, roundabout, runway, driveway, or other such navigable (or non-navigable) feature, location, region, sub-region, or domain. An entire map can then be represented by the set of points in the plot 340, where each point corresponds to at least one location, region, or sub-region of the map. As the number of features (and thus dimensions of the latent space) increases and the number of region data samples increases, there may be patterns that begin to become apparent from the latent space. For example, many intersections may have similar features, and thus mapped to points in similar locations in a latent space, while highway offramps and parking lots may have very different features, and thus mapped to points that may be further away within the latent space. As an example, FIG. 3D illustrates another example latent space 360 where there are many sparse regions with little data, and other regions where there is a higher density of points in the latent space. Such a representation of data may be expected for maps of regions such as roadways, as there will be a number of regions that are very similar, and the differences in configurations of roadways, for example, may not be drastic due to the requirements of navigation, local, state, etc. driving rules or laws, etc. For example, there may be many instances of three- and four-way intersections. Due to the requirements for navigation, as well as the rules or laws that apply, many of these intersections will be at least somewhat similar in design and layout, having the lanes come together in a similar way, with similar traffic signals and signal placement, and applicable rules of navigation. Feature vectors generated for these intersections would then reasonably be expected to be relatively similar, corresponding to points or embeddings in a relatively similar location in the latent space, as the vectors would represent many relatively similar features (at least for dominant features). Similarly, highways with long, mostly straight stretches of roadway would likely have similar feature vectors or points in the latent space, which would likely be proximate each other due to their similarity. While the feature vectors will not be identical in most cases, due to relatively small variations in aspects such as road angle, sign placement, lane marking placement, and the like, at least some of the higher-level features will be relatively similar (which allows for easy understanding of how to drive in any given location). These similarities between regions or domains can then manifest themselves in nearby point locations in the latent space, which allows for a number of advantageous operations or tasks to be performed.

As a first example, the similarity in location of points in a latent space for similar domains or regions can allow for similarity-based search of points for similar types of domains or regions. Latent points corresponding to roundabouts may all be in a similar location as may correspond to a first similarity region 362, where tokenized descriptions represented by the points in the region will have many similar key features. Latent points corresponding to intersections of conventional roadways may all be in a similar location that may correspond to a second similarity region or group 366 that may be a reasonable distance away from the group 362 of roundabout points due in large part to the significant differences in key features between the types of regions or domains. There may be other types of regions that are significantly different, such as airport drop-off roadways, which may be somewhat similar in location and able to be determined as a similarity region 364, but that may have few representative points and may be far away from other points in the latent space. In at least some embodiments, there may be sub-regions within a given similarity region that may correspond to specific types of regions or domains. For example, within the larger region 366 of similar results for intersection latent points there are two dominant sub-regions 368, 370, such as may relate to the most common types of intersections, such as a first sub-region 370 that may correspond to four-way intersections that have two roadways crossing in a direction that is substantially orthogonal, as well as a similarity region 338 for three-way intersections, where roadways tend to meet at approximately 90 degrees (e.g., T-junctions) or 120 degree angles on average. There are various other points within the overall intersection set of latent points in a similarity group 366 that fall outside these sub-clusters, such as where these latent points correspond to intersections with more than four directions intersecting, or where the roads intersect at different angles or in uncommon ways, among other such options. For any new location or domain for which sensor data is obtained, the features can be extracted and encoded using the same encoder or encoding process, and the corresponding location in latent space should be proximate similar domains for which encoding was performed previously. As more data is obtained for a current location or region in an environment, the number of similar results (or size of a similarity group) can decrease, until only a single result is identified. In one embodiment, the set of similar results might first correspond to the larger similarity region 366 or set of points in the latent space, and then after more data is obtained the number of results might decrease, such as for example to a smaller similarity region 370 that corresponds to a specific type of intersection, rather than a general class of intersection.

An advantage to such a process is that similar domains can be determined in many instances using only representations generated from sensor data or other such observations. For example, sensor data may be obtained for a four-way intersection that was not scanned previously, and its encoding in latent space will likely be a short distance from latent points not only for intersections, but also for four-way intersections.

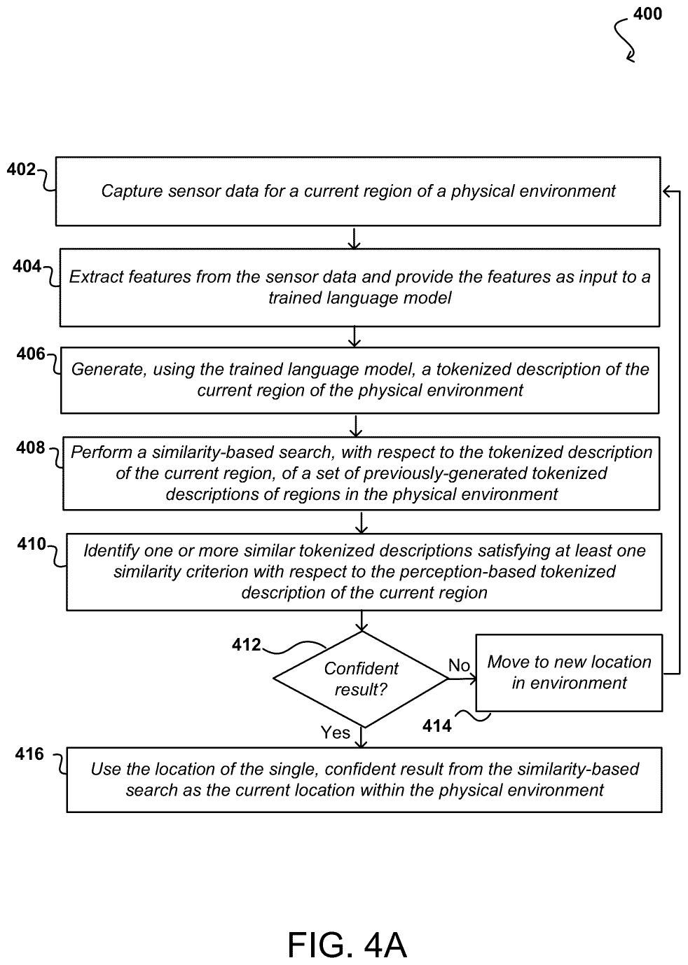

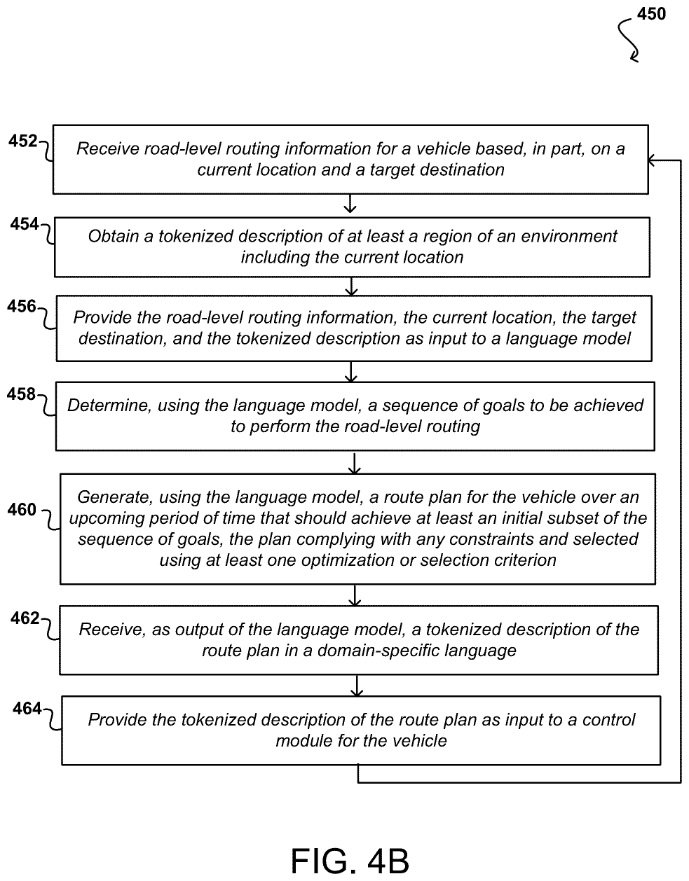

FIG. 4A illustrates an example process 400 for performing perception-based localization that can be performed in accordance with at least one embodiment. It should be understood that for this and other processes presented herein that there may be additional, fewer, or alternative operations or tasks performed or similar or alternative orders, or at least partially in parallel, within the scope of the various embodiments unless otherwise specifically stated. Further, although this and other examples herein will be discussed with respect to mapping and navigation environments, there can be other types of environments and representations used and/or generated as well within the scope of various embodiments. In this example process, sensor data is captured 402—or otherwise obtained—for a current region of a physical environment, as may correspond to a region surrounding a vehicle at a current location of the vehicle in the environment. A set of features can be extracted 404 from the sensor data, as well as any other relevant and identified data, and provided as input to a trained language model. A tokenized description can be generated 406, using the trained language model, that is representative of the current region of the physical environment based at least in part on the sensor data captured for the physical environment. This may be based on a single instance of sensor data or multiple instances captured at one or more locations within the environment. The tokenized description generated for the current region can be used to perform 408 a similarity-based search of a set of previously-generated tokenized descriptions for a variety of regions in the physical environment. This may include tokenized descriptions for various types of domains, such as intersections, roundabouts, parking lots, and the like. The previously-generated tokenized descriptions may be stored to a vector database, latent space, document, or set of embeddings, among other such options. As a result of the similarity search, one or more similar tokenized descriptions can be identified 410 with respect to the perception-based tokenized description for the current region. Any appropriate similarity criterion can be used, such as a minimum distance of separation of points in a latent space or similarity of feature vector shape, among other such options. A determination can be made 412 as to whether a single result has been identified that is similar to the tokenized description for the current location, as for a large number of results the number of similar results should decrease as additional data is obtained. Further it can be determined whether that single similar result is sufficiently similar to the tokenized description for the current location, or just the most similar location still having one or more determinable differences impacting the similarity. In at least one embodiment, a quality score can be returned for each identified similar result, and in some embodiments only results with at least a minimum quality score may be retained for consideration.

If there are multiple similar results, or if a single result does not satisfy at least one selection similarity criterion, then the vehicle (or other object, sensor assembly, etc.) can move 414 to a new location in the environment, such as by a vehicle driving down a road in the physical environment. While moving, or after moving in some instances, additional sensor data can be captured and an updated tokenized description generated, which can be used to update the similarity search. If a single result is located that has a sufficient confidence or probability of corresponding to the current location based at least on the tokenized descriptions, then the location associated with the single, confident result can be used 416 as the current location within the physical environment. The vehicle (or other translatable or moveable object) can then use map data for this location to improve tasks such as routing and navigation. In at least one embodiment, such a process effectively updates and narrows potential hypotheses for a region until a single, unique answer is found with sufficient matching confidence. The answer is found in at least one embodiment using tokenized representations, or other textual graph-type representations, that are generated using perceived features of the environment. These perceived features can correspond at least to topological information (as well as potentially other cues) extracted from sensor data captured of at least a portion of an environment. As mentioned, in at least some embodiments other data may be used as well, such as low-resolution maps, navigational maps, and/or SD maps, which can be used to generate feature embeddings, vectors, or points in latent space useful for similarity search. Such an approach allows for similarity searches to be performed with respect to representations for a large number of locations without the need to visit and capture sensor data for each of those locations. Even where location data is available, such a system can provide redundancy and further confidence in location determinations that can be important for vehicle safety.

In at least some embodiments, a path through an environment can also be used for localization purposes. A tokenized description of a path through an environment can be generated, using a domain-specific language such as RTL, and the tokenized description of the current path can be compared against representation for various paths stored to a vector database or other such location or repository. In some embodiments, a deep neural network might be trained with this information such that the map representations of the various domains are learned internal to the network and do not require an external database or repository to store that information. As the path length increases, the number of similar paths through various regions will decrease, until only a single region will have a sufficiently matching similar path through the environment. The location of the matching path can then be used to locate information for the current location of the vehicle.

In at least one embodiment, tokenized descriptions for new locations can be stored to the vector database, or other such repository, as they are generated and/or confirmed. If an updated or alternative tokenized description is generated and/or confirmed for a location, that description can be stored as the current tokenized description, representing the current state of the location or region (as may be due to construction or other such factors). In at least one embodiment, tokenized descriptions can be generated within various vehicles, or using data transmitted from various vehicles, and these descriptions can be stored to the token database. By accounting for descriptions generated using sensor data from various vehicles, a robust database can be quickly filled as vehicles pass through various regions or environments of interest. In at least one embodiment, representations may be stored only for newly-visited regions or where a significant and verifiable change is detected for a specific region, in order to reduce the number of redundant points, vectors, or embeddings, to be stored for the environment. In at least one embodiment, a differentiation can be performed between static and dynamic objects in an environment, and features may be extracted and/or considered only for specific types of static objects that are determined to be useful for domain representation and/or similarity searching in at least one embodiment.

When operating a vehicle, robot, or other controllable and moveable device using autonomous or semi-autonomous navigation, it can be beneficial—if not necessary—to perform at least some amount of route planning. Even for manually-controlled vehicles, it can be beneficial to perform such route planning in order to provide navigation instructions and/or recommendations to a driver or operator of that vehicle or device, etc. For vehicles that operate on roadways, route planning is generally performed at the road level, and is relatively straightforward once a navigational map and a route are obtained. Actually getting the vehicle to properly perform or follow that route can require additional information or determinations, however, as may relate to lane topology, lane descriptions, and other such information.

Approaches in accordance with various embodiments can provide or have access to this additional information which is captured or included in the tokenized representations for a physical environment. Road-level routing can indicate which roads a vehicle should follow to get to a target destination. The road-level routing does not include information as to the specific lanes to use, when to switch lanes, or how otherwise to operate when traveling along those roads. Routing approaches presented herein can determine more precise routing instructions that can be based on a longer time horizon than other existing routing solutions.

Referring back to the system 280 illustrated in FIG. 2C, the current location of a vehicle (or robot or other moveable device, for example) can be determined, whether from a positioning system such as GPS and/or using a localization module 288, among other such options. The current location can be used to determine a corresponding map region, where that map region can be represented using a tokenized description as discussed herein that includes semantic, topology, geometry, and various other types of data useful for making finer routing decisions that other road- or map-based routing systems. A route planning module 290 can use a tokenized description for a current region of a physical environment, determined based in part upon information obtained from a position system 296, as well as road-level routing information, to generate routing data that can be provided to a control system (or other navigation-related system) of a vehicle or other such device. The control system 294 can use the routing data along with mapping data from a map database 292 to make the necessary or appropriate fine-level control decisions for the vehicle.

In at least one embodiment, the routing data or route plan can also be provided in a domain-specific language, such as RTL, in a specific tokenized description. For example, a vehicle may come upon a complex intersection, where that intersection has a tokenized description useful to determine routing information. A route planning module can determine which lane to be in, a lane to turn into, when and where to make the turn, the path to be used to make the turn between lanes, and other such information. This routing information can be output from a language model to a tokenized representation, where this routing information is contained in the textual tokens of the token string in the representation, and the routing information retains semantic, topology, geometry, and other such data useful in ensuring proper operation of the vehicle based on the routing information. Where various current routing decisions are based on a relatively small scope of distance around a vehicle, routing decisions generated using tokenized descriptions as presented herein can be made on a much larger scale and can thus provide more accurate and useful routing determinations. For example, route planning using a tokenized representation of an entire region of a physical environment can indicate not only that a lane change should be made but can indicate a likely optimal location at which to make the lane change, based upon factors such as upcoming intersections, traffic patterns, and other such information. If a lane change is to be performed that involves moving across multiple lanes of a roadway, the routing can determine a likely optimal path for which to make those multiple lane changes.

In at least one embodiment, a route planning module can determine a routing path using a sequence of route planning goals. For example, a goal of turning left at the next intersection might involve a sequence of individual goals, such as getting from the right lane into the center lane, getting from the center lane into the left lane, and making a left turn from the left lane at the intersection. In at least one embodiment, an individual goal can be provided, along with a tokenized representation of a current region of the physical environment, as input to a route planning model, for example. The route planning model, which may be a language model in at least one embodiment, or another type of generative model in other embodiments, can determine a route or path to take from a current position that will achieve the goal within any constraints, and can return information for the route or path, which may be provided in the form of a tokenized representation in at least one embodiment. In some embodiments, a language model may receive location information (e.g., GNSS information), speed/acceleration information, wheel angle/turning rate information, weather information, traffic information, object detection information (e.g., related to dynamic objects in the environment), wait condition information (e.g., whether lights are red/green/yellow, etc.), and/or other information about the vehicle/machine and/or environment, in addition to information describing the environment (e.g., in RTL), in order to make determinations about path, road, route, and/or lane planning, and/or to aid in making control decisions for the vehicle or machine.

In at least one embodiment a tokenized representation of a region of an environment can be a token-based text string representative of a map graph or object graph for the region. In at least one embodiment, route planning can involve effectively performing an optimal path search through this object graph. Various models or heuristics can be used to perform such path optimization and/or determination. In at least one embodiment, a trained language model can output a selected path as a tokenized representation. Route planning can be performed at a longer timeline than for prior approaches using the graph-based approach and series of goal-determined routing paths. The route can also provide finer detail or granularity than prior map-based approaches.

A vehicle control system (or similar component) can then determine how to specifically cause the vehicle to follow this route plan. In at least one embodiment, a route planning pipeline can include both a decision making module and a route planning module. The decision making module can determine when to make lane changes according to a navigational signal. The planning module can perform tasks such as path generation, and can send the plan to a control module to execute. The decision making module can use a language-based representation—such as a tokenized description in a domain-specific language-to be able to generate route plans over much longer time horizons than would be possible with regional map-based approaches. Such a decision-making module can plan over multiple upcoming goals or interactions, in order to optimize a route over a longer distance than was previously practical.

As mentioned, tokenized descriptions as described herein can retain data—such as semantic data and relationship data—that would not otherwise have been available in prior map-based approaches, particularly those that used maps, such as SD maps, that may have included a limited amount of information about an environment. While there are certain types of maps, such as HD maps, that may contain at least a portion of this information, these maps are typically very large in size such that only a portion of the map may be stored and processed at any time, which then shortens the time horizon available for route planning. The ability to represent all this information in a compact tokenized description allows larger regions to be considered, and allows for faster and more accurate routing decisions than were possible using prior map-based routing approaches. The compactness of these representations also allows for the inclusion of information for dynamic objects, such as other vehicles on a roadway, which can further help to make optimal routing decisions, such as where it would be beneficial to make a lane change at a specific location based in part upon upcoming traffic or congestion. The compact nature of the representations also allows for integration with additional types of information, without a need to hardcode a significant amount of logic or instruction.

The ability to make route planning decisions over a longer time horizon using a language model also allows for decisions that more closely mimic human behavior. For example, humans typically think about individual goals concurrently with long-term goals, such as making multiple lane changes to prepare for an upcoming turn, where the human attempts to determine a path that achieves all those goals in a reasonable fashion based upon factors such as distance and traffic. A language model can be trained to make similar routing decisions by being trained on human behavior data, such as how humans typically drive in similar situations for similar locations. A language model can also help to fill in gaps in the goals by applying learned rules, behaviors, or actions. In some embodiments, a different decision may be made when considering the long-term goal, or a sequence of goals, than if only considering the next short-term goal. The compact representation enables a language model to consider routing options over a large region of the environment that may include many individual goals in a route plan to be determined, and can optimize over all of those goals. A similarity-based search can also be performed to determine how vehicles or drivers typically perform in similar locations or domains, and this knowledge can be leveraged to attempt to determine an appropriate path that is determined in part using human behavior data for similar locations or situations, as opposed to determining a path based on a simple cost function such as shortest distance or time to a goal. In some embodiments the language model may consider a next important goal, such as turning at an upcoming intersection, when determining routing options for any minor goal along the way. As goals change, the selected route plan may be updated. If situations change, such as where there is construction or an obstruction, the model can attempt to determine a new route plan based on that information. Route planning can be performed continually during operation or navigation of a vehicle, for example, to make adjustments to the route plan as appropriate for updated information about the current environment.

The ability to generate a larger number of route options based on a data for a larger area, as well as more detailed information such as semantic and other information, also allows such an approach to avoid issues with local minima in a decision process. For example, a navigation system that only plans for the next goal based upon currently available information can occasionally get stuck, where there is no reasonable solution determinable based on the current information. Being able to look concurrently at multiple goals and consider additional types of information allows for additional proposals to be generated, that improve the likelihood of a reasonable solution being determined. Not only can better routes be planned in advance, which can help to avoid such situations by planning over a larger portion of the environment, but additional route options can be generated that can help to get out of any such situation where rules-based constraints or other hard-coded criteria might have prevented an acceptable route from being determined. Such a process is also light-weight enough to be performed in real time on a vehicle itself, which can further help to avoid latency issues if a network connection were needed to transmit data for decision making our route planning purposes.

Route planning can also learn subtle human behavior that can be incorporated into the routes and updated based on current data. For example, human drivers will tend to move over within a lane if a motorcycle is approaching that may attempt to ride the lane line. While such behavior may not be hard-coded, once learned it can be incorporated into short term goal planning, and updated based on current data, such as where a motorcycle is detected to be approaching from behind along a given lane line. It can be difficult to try to hardcode all such human behavior, but a language model can learn such behavior simply by being trained using a sufficient amount of training data demonstrating that behavior.

In at least one embodiment, routing decisions can be made based upon other relevant information as well, such as the type of vehicle for which the route plan is being generated, or performance characteristics of that vehicle. For example, the time at which to make lane changes may differ for large semis or tractor trailers than for small, two-door coupes. The appropriate route to make turns can also vary significantly between those types of vehicles. Factors such as vehicle acceleration can impact an ability to pass a car in a passing lane, among other such performable actions. A tokenized description can contain such information, allowing for routing decisions to be made that are appropriate for the type of vehicle or device that is to operate according to those routing decisions.

FIG. 4B illustrates an example process 450 to use a language model to generate a route plan that can be performed in accordance with at least one embodiment. Although discussed with respect to a vehicle on a roadway, it should be understood that such a route or motion plan can be generated for other types of devices or components in similar or alternative types of environments, such as robots in a warehouse or equipment in a laboratory, among other such options. In this example, road-level routing information is received 452 for a vehicle, where that road-level routing information is based at least in part upon a current location of the vehicle and a target destination for the vehicle, whether as a final destination or an intermediate destination along a trip or journey. In at least one embodiment, the road-level routing information can be received from a route planning module that has access to mapping information for an environment that includes at least the current location of the vehicle, and may also include the current or intended final destination for the vehicle along the journey. The road-level routing information will typically indicate the roads to take along a route plan, including turns to make and intersections to pass through, and other such information. The road-level routing will typically not include information relating to the lanes to use, when to change lanes, which lane to take in an intersection, and other more detailed routing information. Further, the road-level routing information will typically be optimized at the road level, and does not provide for any finer-grained optimization based upon navigation options within, or near to, the provided road-level route plan.

In addition to the road-level routing information, a language model-based route planning module can also receive map information for a region of the environment including the current location of the vehicle. In at least one embodiment, this may include obtaining 454 a tokenized description of at least a portion of the environment as discussed herein, which may be in the form of a string of text-based tokens written in a domain-specific language. Such a tokenized description has advantages of being lightweight and compact, such that data can be stored for a large portion of the environment (or even the entire environment) while that data can retain semantic, topology, geometry, and other relevant data that can help to make better routing decisions. The language model-based route planning module may receive other types of data as input as well, as may relate to traffic or weather data, vehicle performance data, and the like.

At least the road-level routing information and the tokenized description of a relevant portion of the environment can be provided 456 as input to a trained language model of the route planning module. In one embodiment, the planning module will determine 458 a set or sequence of goals, and provide those goals individually to the language model to determine a route path or segment that will satisfy that individual goal. In this example, the language model has been trained to approach the routing information as a sequence of goals to be achieved, and can attempt to determine an optimal path (at least from an available set of options that satisfies any relevant navigation or path constraints) that achieves all of these goals. While such an approach may not select an optimal path for an individual goal, the path or route plan can be selected to provide optimal or improved performance over the sequence of goals. Using a language model to determine optimal sequence actions also has the advantage of being able to leverage powerful capabilities of large language models, including abstract reasoning, chain-of-thought, common sense planning, and the like.

As an example, a vehicle may be in the right-hand lane of a current roadway but may need to make a left-hand turn at an upcoming complex intersection. This may be defined as a sequence of goals including moving into the center lane, moving into the left-hand lane, approaching the intersection in accordance with an available navigation state—such as whether there is a red light or a green left turn arrow, for example—and making a left turn through the intersection into a specific lane of the next roadway. There may be additional goals as well, as may relate to navigation prior to, during, or after navigation through the complex intersection. If the vehicle were only considering moving into the center lane, then the time determined to be optimal might be a given distance from the intersection. If the left lane tends to back up with traffic, or is experiencing such backup, then the goal of getting into the left turn lane might require moving into the center lane sooner. Or, if there is a store on the left upcoming into which a significant amount of traffic is likely to turn, then it may instead be beneficial to wait until after the turn for that store to change lanes. By setting a sequence goals and optimizing across those goals, a more detailed route plan can be generated that can provide improved planning over prior approaches. Further, the semantic and relationship information stored in the tokenized description for large regions of the environment allows for better decision making based in part upon the availability of this additional information.

The language model can then generate a more detailed route plan 460 for the vehicle, at least over an upcoming time period, distance of navigation, or number of goals, or other such option. The generated route plan can comply with any constraints on the route or navigation options. The generated route plan can also be optimized, or at least attempted to be optimized, using at least one optimization or selection criterion. Such criteria may include shortest time, shortest distance, or lowest susceptibility to variations in traffic flow or volume, and the like. In at least one embodiment, the model may generate a set of potential paths or navigation vectors, for example, and can attempt to narrow down the set of vectors using an optimization or selection process until a single route option is determined to be optimal based on the currently available information. A tokenized description of the route plan, in a domain-specific language, can be received 462 as output of the language model. The output may be in other forms in other embodiments, as may be appropriate for a control module or other such intended recipient. The tokenized description of the route plan can then be provided 464 as input to a control module—or other such component, system, or process—for the vehicle in order to make real-time navigation and/or operation adjustments, such as to cause the vehicle to move into the center lane per the route plan.

In at least one embodiment, operations such as route planning (and other such use cases) can be treated as problems of finding optimal sequential actions on graphs or graph-based representations. Both classical graph algorithms and learning-based approaches can be applied to such problems. For example, the shortest path problem has known solutions that can be readily adopted, while in many other cases learning-based methods such as reinforcement learning are applicable. Use of a learning-based architecture also has an advantage in that it can be continuously improved through existing maps, data collected from usage of traditional systems, historical computation results, and other such information. Graph-based approaches can be used with learning-based approaches, for example, to perform tasks such as to identify and sort graph nodes, group related nodes, determines shortest path lengths or distances between nodes, and the like.

In at least one embodiment, a tokenized text string for a current environment can be updated (or new text string generated) at any appropriate interval, balancing a need for current information with the latency and resource requirements for each individual string generation. In an embodiment that generated such text strings based at least in part on raw sensor data, the text string can be generated in accordance with the data capture or refresh rate of the sensors, such as at 30 Hz or 60 Hz. For less time critical applications, the strings may be generated less often—such as once per second or every few seconds—or may be generated based upon detected changes in the environment, among other such options. In some embodiments, such as for robotic performance, the text strings may be generated at the time for performance of a task and periodically or at specific times throughout that performance as needed or appropriate. For each generation, a determination can be made as to additional nodes or tokens to be added, such as for a vehicle that just turned into a current ego lane, or nodes that can be removed, such as cars that are no longer on the road or within a given distance of an ego vehicle for a navigation task. For navigation tasks, there may be a sliding window around a vehicle of a determined size, which may vary based upon factors such as speed of travel or type of environment, and any relevant object within that sliding window may be represented by a token in the string, with nodes outside that window being excluded from the string, except where there may be a rule or reason to keep a given token in the string even though the corresponding object is outside the sliding window of distance around a vehicle in motion.

In practice, a task such as navigation will take as input both prior map and/or environment data, as well as sensor data. The prior map and/or environment data can help to improve the accuracy and confidence of various environmental determinations, and the sensor data can help to identify objects—such as vehicles or pedestrians—that may only be in the environment temporarily and may not have been represented in the prior data, as well as changes in the environment, as may be due to construction, lane closures, or other such factors. If no map information is available, then the language model may rely on sensor input and potential information for similar locations obtained from a latent space or set of encodings. In some embodiments, the input may not include prior map data but may include a prior tokenized text string generated for that particular environment. The language model can also infer additional information—as be based on semantics or learned relationships—that may not have been indicated by a prior map, as discussed in more detail elsewhere herein.

In at least one embodiment, a generated route plan might be presented to a human driver rather than a control system. In such a situation, the plan is already in textual format, so a simple language translation can be performed to provide human-understandable instructions in natural language. In at least one embodiment, a generative AI-based solution can be used to generate instructions in natural human language based on the information stored in the domain-specific language in the tokenized descriptions. In a situation where a human may need to go back to understand the instructions or guidance that were provided to a vehicle, such as in response to an accident, the instructions in text can also help a human to better understand the instructions that were given.

Approaches in accordance with at least one embodiment can formulate a wide range of geospatial information processing and autonomous and semi-autonomous driving tasks—such as map building, map editing, map-based navigation, planning, and driving—as document manipulation tasks that leverage one or more LLMs to solve them in a unified and joint fashion. In at least one embodiment, an LLM is built using one or more deep neural networks (DNNs) that are trained using textual information-such as in a domain specific language (DSL) like RTL—using textual representations of geospatial information (such as maps). The DSL described herein may be referred to as, without limitation, the RTL. The RTL may rely on both the existence of a rich feature database and a graph describing relationships of these or other such features within a map or other such representation. Using one or more automated processes or operations, a set of map features/landmarks (e.g., those encoded in an HD map using a data format suitable for HD maps) may be deterministically converted to the RTL, and vice versa. In some embodiments, the graph can be represented as a knowledge graph that expresses road objects, road object relationships, and road network topology, rather than generic knowledge.

In some embodiments, an LLM (or other language model type(s)) may retrieve and/or access map data or other information determined to be necessary to generate an output using one or more application programming interfaces (APIs) and/or plug-ins (e.g., third-party plug-ins). For example, in order to retrieve additional contextual information, additional map information, additional feature information, and/or other information not directly included in a prompt to the model, the system—using the LLM, in some embodiments—may generate one or more prompts or queries for one or more data sources (e.g., open street maps (OSM), wolfram alpha, a local map database, etc.), via one or more APIs or plug-ins, in order to obtain the additional information required (or deemed necessary) for responding to the initial query or prompt. Such an approach to querying additional resources may be recursive, in at least some embodiments, in that the system may continue to access one or more data sources via the API(s) and/or plug-ins until it is determined the necessary information has been obtained, or until no additional information is available. In some embodiments, an initial prompt for the model may be generated using one or more APIs or plug-ins, such as an API for retrieving an RTL description of a selected section of a map. For example, a user may, via an API, select a portion of a map to be processed or analyzed using the LLM, and the API may return a textual or tokenized description of the portion of the map in the DSL (such as RTL).

The RTL may use an S-expression syntax as one way to represent map information. In S-expressions, information can be grouped—such as in sets of parentheses—where each set includes one or more items that can be either simple pieces of information like numbers or text, or another set of S-expressions. This allows for representing maps in a hierarchical and compositional way that can be relatively simple to parse. Other graph representations may also be adopted and used in some stages of the system to facilitate specific data manipulation when appropriate.

One of the use cases of the RTL is to interface with an LLM (or other language model type), where the grammatical validity of the output of the LLM can be ensured. Formally expressing data using a grammar can make it easier to assert its validity compared to managing an arbitrary bag of strings or relying on generic formats like JavaScript Object Notation (JSON) or Yet Another Markup Language (YAML)—which can result in loss of semantic information. As such, using formal grammar to represent the input/output of a language model can improve the robustness and reliability of the system, and can help to ensure that the processed data has proper semantic meaning and is well-formed.

In at least one embodiment, one main entity in an RTL document is a directed heterogenous graph describing a portion of a road network—such as an intersection. There are multiple possible approaches to encode map coordinates and—in order to accommodate a small, fixed-size vocabulary—a grid-based tokenization as the decimal notation may be implemented. However, alternative approaches may be used, such as using a geo-hashing representation, which provides another technique to encode geospatial locations. However, geo-hashing often relies on a global reference system and supports precision at various levels, which results in the need for a very large vocabulary.

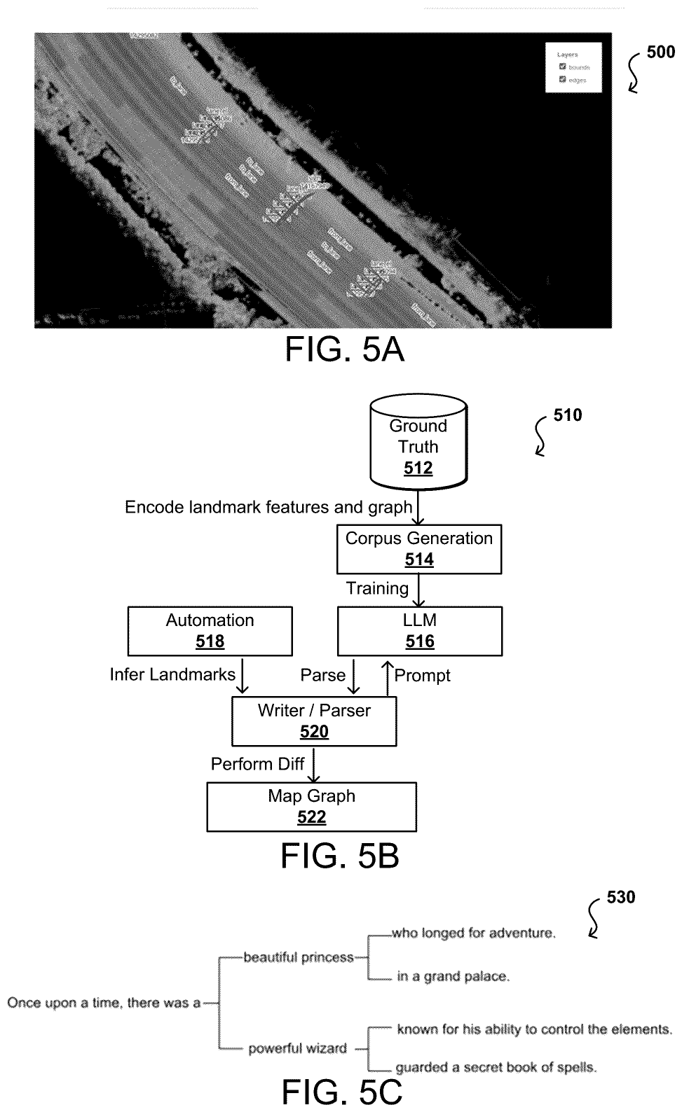

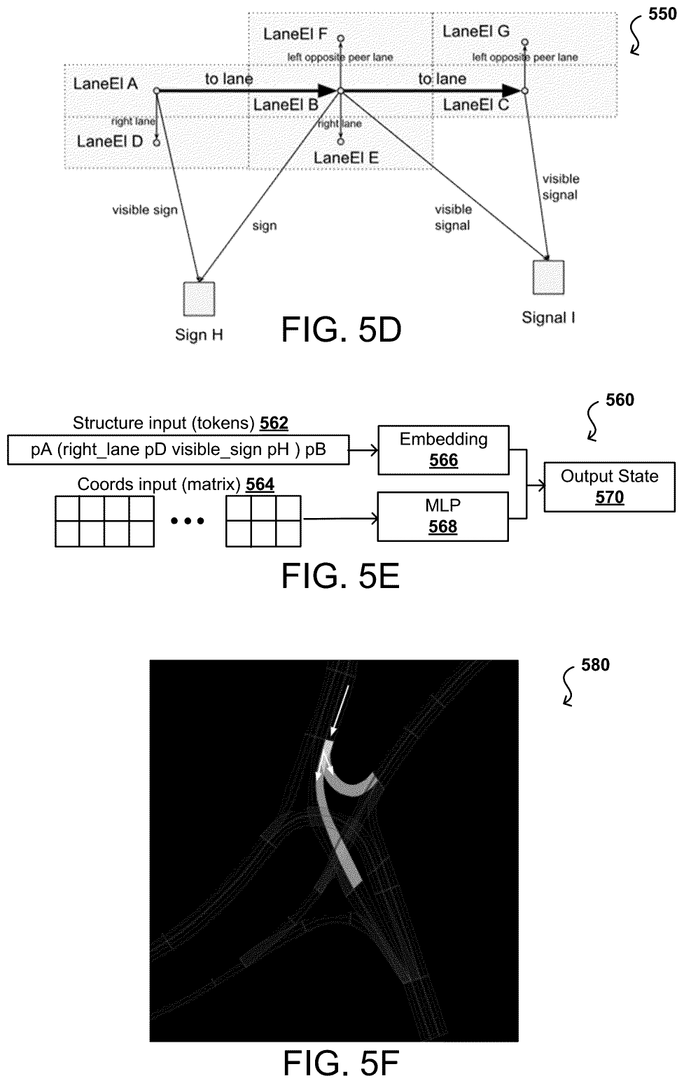

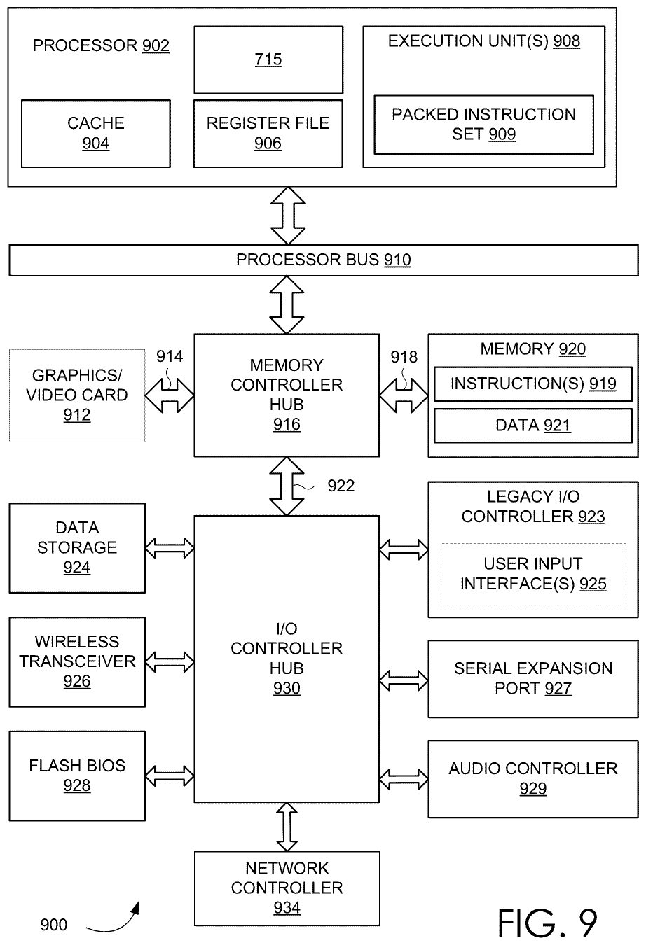

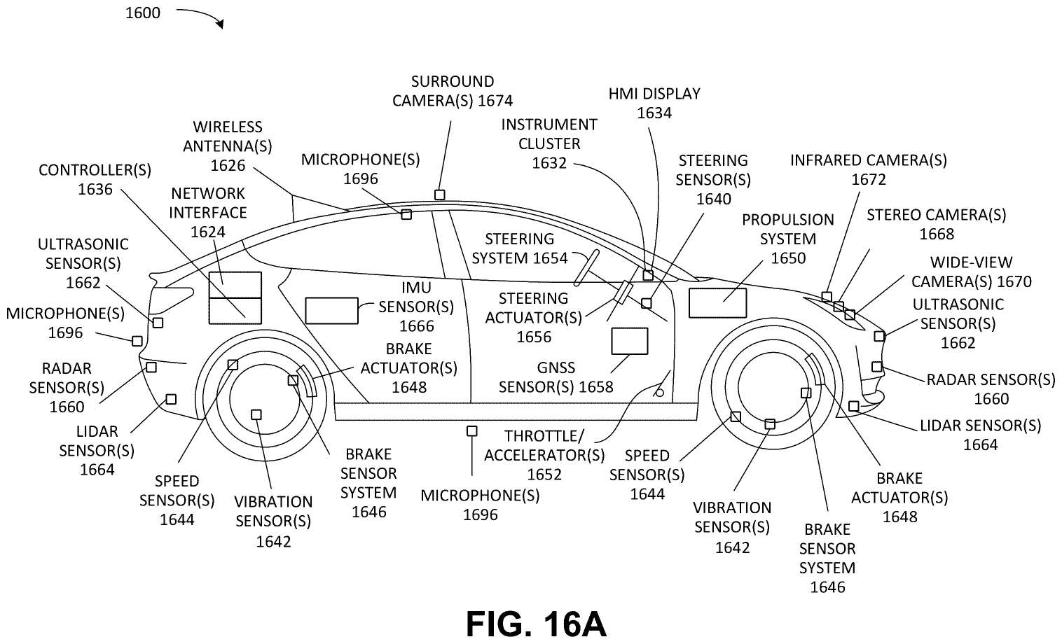

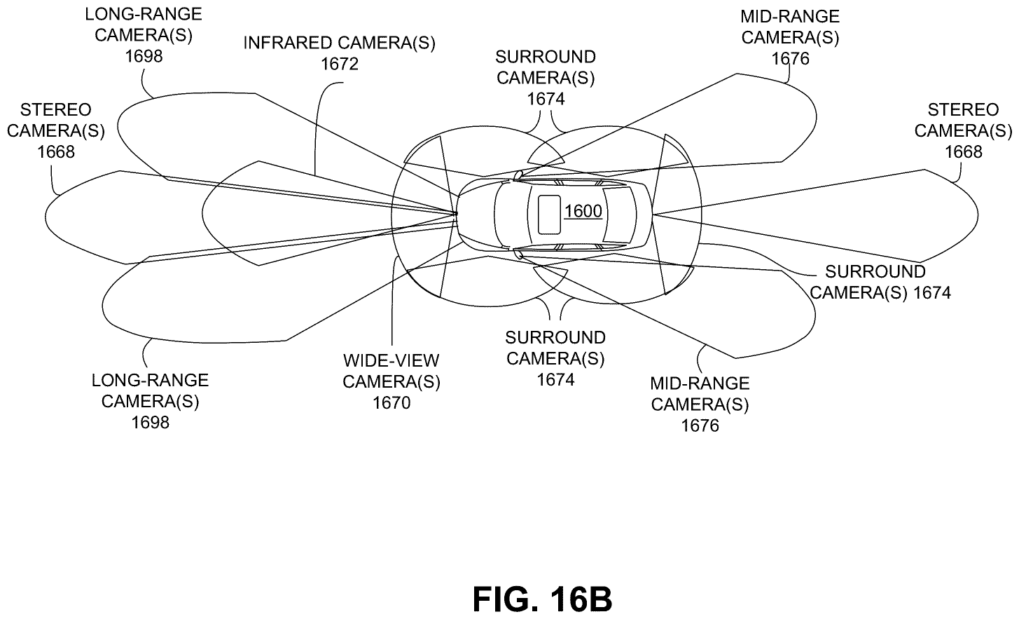

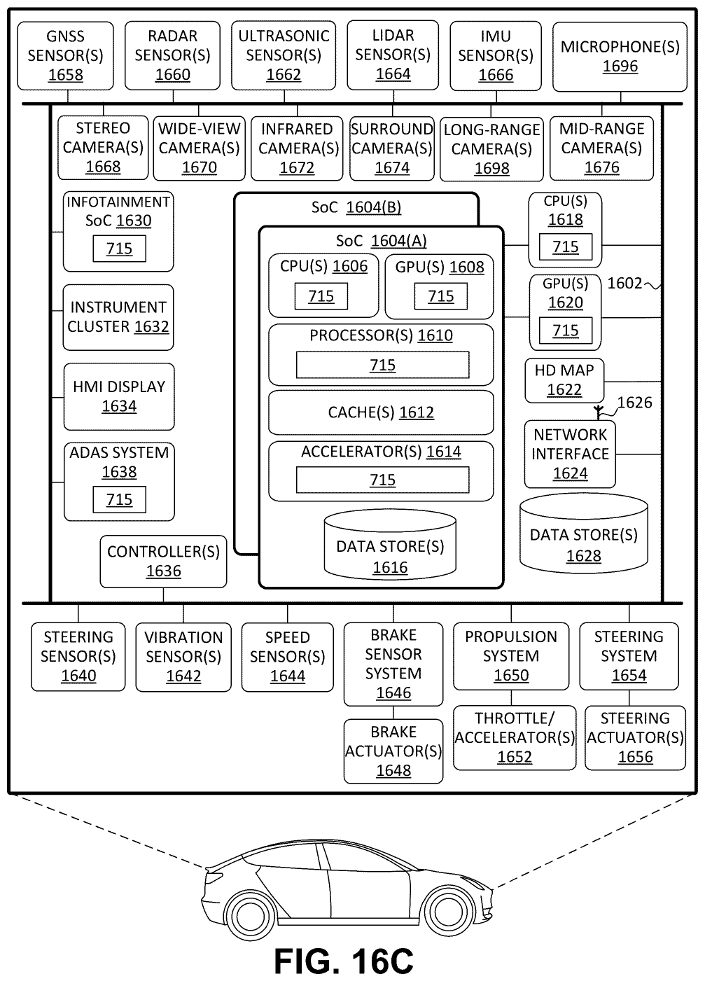

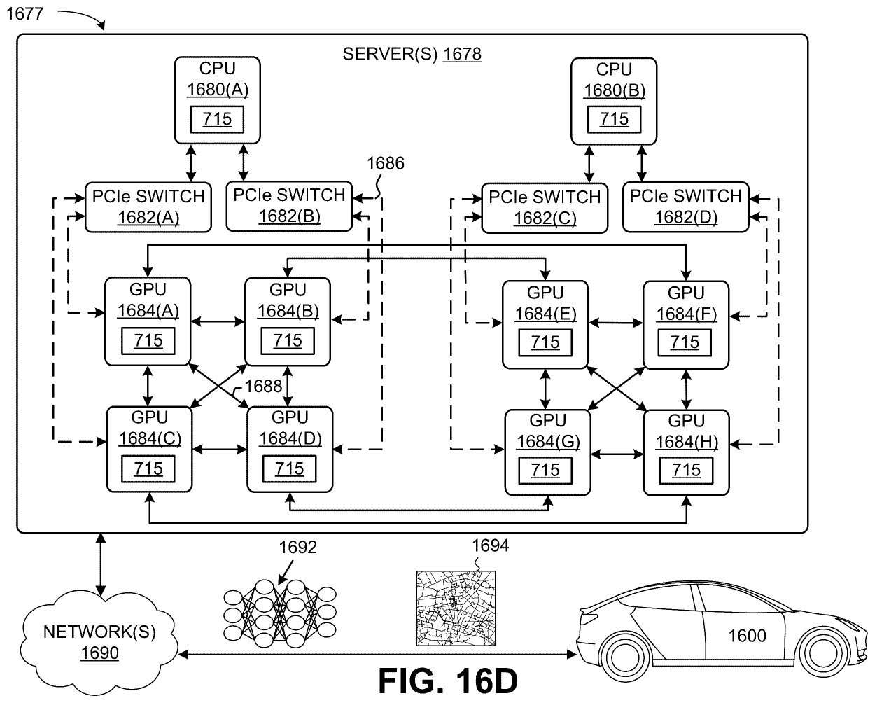

FIG. 5A illustrates an example graph view 500 of an environment corresponding to a portion of a multiple-lane roadways in accordance with at least one embodiment. To express a map for such an environment using a language such as RTL, semantic data about the map may be used. FIG. 5B illustrates an example architecture 510 for the training and deployment of an LLM, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1600 of FIGS. 16A-16D, example computing device 900 of FIG. 9, and/or data center.

As illustrated in the example architecture 510 of FIG. 5B, semantic information may be available—e.g., encoded in one or more maps from a database 512 or repository of ground truth data—and may be used to describe the map in the relevant language. In some embodiments, existing map data may be used to perform tasks such as to encode landmark features and other aspects of a map or graph. For example, an HD map (which may be represented using an occupancy map generated from any type of sensor data, such as image data, LiDAR data, RADAR data, etc., in embodiments) may have various layers—such as planning layers, semantic data layers, sensor-specific layers (e.g., RADAR layers, LiDAR layers, camera layers, etc.), and/or other layer types. To convert the map representation to a language-based representation, such as a sequential, tokenized text string, one or more of these layers may be used. An automated conversion tool can be used to read the map data in a map format and convert the data to the RTL, or otherwise generate a language-based representation of the map data, such that an LLM can understand and process the data. In at least one embodiment, this can include using a corpus generation component 514 that can generate a text-based representation based on the encodings or embeddings from the map data, and perform training before providing the text representation to an LLM 516. As such, the RTL may include or comprise a language that can express a topology of a road network (and/or other network, such as those associated with warehouses, buildings, outdoor spaces, waterways, etc.) that is derived from, for example, an HD map. The RTL may then serve as an interface between an LLM 516 and the HD map such that the LLM(s) can learn the underlying structure of the road network (and/or other network(s)).

In some embodiments, the RTL may be encoded into an HD map—e.g., into one or more layers, such as a semantic layer, of an HD map. The LLM 516 may then be trained using this encoded information as a training corpus. In some embodiments, the features that are included or represented in the RTL can include, without limitation, traffic signs, traffic signals, poles, lane dividers, road boundaries, road markings, stop lines, wait elements, lane elements, and/or the like. For each landmark or feature, various types of data may be represented—such as a landmark ID (e.g., global unique IDs), a landmark number (e.g., total number of current landmark types), spatial information (e.g., 3D latitude and longitude, size, orientation, pose, etc.), and/or semantic information. The spatial information in some embodiments may include 2D coordinates (which may be derived from 3D coordinates), 3D coordinates (which may be determined from 2D coordinates), 4D coordinates (that may change over time or have a temporal component), bounding shape locations, and/or curve locations. Bounding shapes may be represented using float [3] for location, float [3] for sizes, and float [3] or [4] for orientation or pose. Landmarks that are curves may be represented using a list of key points and their 2D or 3D locations, or may be represented using parameters of curves based on a parametric form. Semantic information may include, for example and without limitation, a landmark type, a landmark association (e.g., a traffic light's associated lane IDs, lane boundary segment locations), and/or textual information (e.g., text displayed on signs).

An LLM 516 trained with an RTL (or other DSL) corpus built from a database 512 of map ground truth data can be queried to correct features output from a machine learning (ML) automation pipeline. The output of an LLM 516—such as by using a writer and/or parser component or module 520—can be mapped back to the extracted features. A difference (e.g., diff) operation can then be performed with respect to inferred landmarks from an automation component 518, for example, to perform any appropriate corrections to generate a map graph 522. An example use case is to infer the road topology (e.g., edges) from an incomplete set of nodes (e.g., landmarks) with potential applications in, for example and without limitation, tooling, quality assurance (QA), and automation. In some embodiments, document embeddings may be indexed in a vector database, or n-dimensional latent space (where n can represent a number of extracted features or feature types), and the index can then be used to cluster similar intersections—thus allowing the unsupervised labeling and retrieval of operation design domains (ODDs) (e.g., features or landmarks).

In at least one embodiment, a structured language such as RTL can rely on both the existence of a rich feature database and a graph describing the relationships of these features within the map. Approaches described herein allow for deterministically converting from a set of landmark features to an RTL representation, and vice-versa. A graph in this example can be thought of as a knowledge graph, but instead of generic knowledge, the graph expresses the road network topology or other aspects of the relevant environment. In one or more embodiments, there may be strong constraints around how to encode coordinates so that they can be understood by language models (LMs). Location-related aspects such as coordinates, latitude, longitude, and altitude coordinate tuples can be represented using coded values or representations, such as sets of two characters from the permutations of the alphabet: “ab ac ad . . . ” up to size 256, for a non-limiting example.

To tokenize or encode a coordinate, for example, one, some, or all landmark features in a document can be considered, and a values such as their centroid may be used as the origin in an east, north, up (ENU) coordinate system (or another coordinate system), with altitude set to the average altitude of coordinates in the document. A radius R can be considered, such as, for example, 350 meters around that origin that is split into a grid (e.g., a 65536×65536 grid). The tokenization precision can be a function of this width, as a cell in the grid can be the smallest addressable (or indexable) unit which equals, for example, 0.0107m with the proposed range. Such a fixed-size grid can allow for the coordinates to be represented at the same scale across documents (versus being normalized against the bounding shape of each document, for example).

In at least one embodiment, an important entity in a language-based representation—such as an RTL document—may be implemented as a directed graph describing a portion of an environment such as a road network. Such a graph can be used to express the connectivity between road features (topology) and may be similar to a knowledge graph. The graph nodes can then correspond to landmark features and may be typed or classified with their landmark type. The edges of the graph can correspond to the relationships between road features. In some embodiments, all source nodes may include lane elements. An individual lane element (laneEl) can be converted into a small graph, and a document can contain all nodes related to a given laneEl. A road graph can be represented by listing the entirety of its nodes and edges. The ordering of the nodes and edges may be arbitrary; however, edges can reference nodes by their index in the document.

In a graph traversal representation, an edge sequence can be used to express the path on the underlying graph of the map. Such a path can include the list of the laneEl nodes visited and their attributes. The attributes of a laneEl node may include its intrinsic properties (such as the laneEl's drivable direction), as well as the attributes of the nodes it can reach (such as signals this laneEl can see, and its neighboring laneEl). In this way, the RTL document may not capture the full graph of the map, but rather possible paths on the map. A sentence of a natural language can also be thought of as a path on the underlying graph of the natural language. At each word, there can be many different possibilities of what the next would be, and those possibilities can form a graph, with a particular sentence consisting of a sequence of choices of different edges at the nodes of the graph. FIG. 5C illustrates an example simple graph 530, similar to a sentence diagram, that can break out objects or tokens, and can associate additional information with the appropriate tokens or objects.

In at least one embodiment, a language model can analyze a number of sentences, and determine the next word such that it is consistent with the words that came before. Essentially, the LLM has learned the underlying graph structure such that it can walk on the graph to produce reasonable sentences. By providing a sufficient number of potential paths, the map LLM can learn the graph of the map and can generate plausible paths on a map. For example, when seeing a turn signal light in the input sequence, the LLM may predict a turn lane for the next token in the sequence.

Using a form of edge sequences can allow for a more compact representation of the RTL documents. Moreover, integer IDs used to refer to the features can be eliminated completely. Since there can be a linear path in the structure, the nodes and properties around that path can be expressed in an appropriate fashion. FIG. 5D illustrates an example of a sub-graph 550 around such a sequence in accordance with at least one embodiment. Here, the sub-graph corresponds to sequence laneEl A--->laneEl B-->laneEl C. In such an example, the traversal may use a number (e.g., 19) tokens in total to specify the structure of the path, which is a fairly compact representation. In one example, a path can be expressed in the following tasks:
Task 1: Specify a node by its type and attribute/property. For example, node laneEl A is specified as LaneEl pA, where pA are the properties of A (e.g., traffic_direction straight, allowed_vehicle_type car, etc.)
Task 2: Specify the main path by listing the nodes it goes through: LaneEl pA LaneEl pB LaneEl Pc.
Task 3: For each node on the main path, specify the non-navigable nodes it can connect to in the format (edge_type node). For example, for laneEl A, the non-navigable nodes are (right_lane laneEl pD visible_sign Sign pH).
Task 4: When referring to a node that is identified before, use its index directly. For instance, if sign H is listed as a non-navigable node for A, when it is observed again for B, it would be (sign 0) since it is the first sign in the sequence.

Various approaches may be used to encode map coordinates. For example, decimal notation, grid-based tokenization, geo-hashing, and/or other approaches may be used in various embodiments. In order to ensure a small fixed-sized vocabulary, some embodiments use a grid-based tokenization method—as decimal notation and geo-hashing may require larger vocabularies. As an LLM can work well with sequences, a delta-based encoding can be used to express coordinates. As an alternative, a global coordinate system may be implemented; however, a global coordinate system—while easier to parse and encode—may result in sparse tokens and make the topology learning less effective. As a note, cumulative absolute error is not considered problematic at this point as the length of the traversals is short and approximate relative positions may be suitable.

With each node having at least four key points, the first key point can be used as the anchor point for the subsequent points in the node. As a non-limiting example, a 263×263 grid may then be laid out, and centered at the anchor point, which may allow for an indexable area of 878m×878m at 5 cm precision. FIG. 5E illustrates an example architecture 560 that can be used to determine an output state 570. To tokenize a coordinate, such as coordinates received as input in a matrix 564, all landmark features in a document may be considered, such as may be received as a set of tokens or other structure input 562. A value such as a centroid may be used as the origin in an ENU coordinate system, for example, with the altitude set to the average altitude of coordinates in the document. The tokens can be processed to determine appropriate embeddings using an embedding module 566, and the coordinate input processed using an MLP 568, for example in order to generate the appropriate output state 570. In at least one embodiment, graph traversals can be generated using random-walking on the laneEl graph. The connections of the laneEls (e.g., from_laneEl and to_laneEl fields) may define all possible ways of navigating on the map. To generate a traversal, one approach is to start from a laneEl and recursively follow the successor laneEls to generate a path. When a branch point is encountered where multiple successors exist, the approach can be to randomly take one of the successors and follow the path until, for example, a max token limit is reached.

FIG. 5F illustrates an example image 580 of an intersection in an example map. As depicted, white arrows indicate the possible directions of traffic and the two highlighted lanes are the two successor laneEls of the laneEl above them. When generating the traversal, one approach is to start from the top laneEls, and one of the successor laneEls may be picked to add to the path and follow one of its successors, and so on. To generate graph traversal, a random walk on the laneEl graph can be performed. In practice, graph traversals can be generated with tasks such as the following:
Task 1: Extract all laneEls in the map and put their ids into a vector.
Task 2: Randomly choose a start laneEl from the vector, where the to laneEl fields are the possible successor laneEls that this laneEl can go to. Randomly choose one successor laneEl and follow its successor, and so on.
Task 3: While at a laneEl in the path, extract the landmark features that are reachable by this laneEl and add them to the traversal results. Stop the path once the traversal reaches the max token limit.
   In this example, nodes correspond to landmarks. A common node type in this example is the lane_el, but also includes road_boundary, lane_divider, signal, sign, stop_line, etc. Edges can represent relationships between landmarks, with each edge having a type, such as from_lane, to_lane, visible_sign, sign_edge, etc.

According to one or more embodiments, the grammar may include a simple directed graph data structure with an arbitrary number of edges. Node attributes can be specified in the node entity and depend on the node type, which is the same as the landmark feature type. An RTL document can be produced by using logic such as the following: the features are within a predefined area (e.g., 700m×700m) as defined with respect to coordinates encoding herein; a document is written for every laneEl that includes the related features as nodes and their relationships encoded as edges; and the edges of the node are included as well. The language can be compiled using a command line tool. Such a tool can validate (lint), for example, check that all nodes referred to are present in the document, and compile to other targets such as keyhole markup language (KML) or an image, which can be useful for debugging. An RTL API can provide a public interface that lets developers generate structured language documents, and also allows users to query a trained model. As described herein, a schema can be provided to tokenize the edge sequence path, where attributes of the node are represented by a single token for illustration purposes. While in reality all the node attributes may not fit into a single token, there is still room to compress them into as few tokens as possible.

In some embodiments, high level contextual information may be added to prefix an RTL document. The generative part of a language model can learn to manufacture RTL graphs from contextual information. Using such an approach can allow for converting from natural language descriptions, other simpler map representations, or images (camera or BEV) to a language such as RTL. For example, the LLM may be prefixed with natural language descriptions such as “a 2 lane road,” “a 4 way intersection with 2 lanes in each direction,” or “a large intersection with traffic lights,” or using a more structured language that captures the same information, such as “DESCRIPTION 2 lanes 4 way intersection GEN (graph (lane_el . . . ” Such high-level contextual descriptions may be derived from HD and/or SD map information. In some embodiments, an image may be processed using a model (e.g., a DNN) and a description of the image—or road topology or contextual information represented in the image—may be output by the model. This contextual information or semantic information may also be used to generate RTL, which may allow for fitting the RTL to an image (using an overlay capability). Such a process can be performed with top-down or bird's eye view (BEV) images. Such a process can also provide the ability for processing an image (in camera or BEV) into RTL (or another DSL).

As such, contextual information—in a format different than the DSL or RTL—may be provided or prepended to a query or prompt for the LLM in order to direct the generation of the output from the LLM. For example, an LLM configured for maps and an LLM for natural language—or a combined LLM trained to process both types of language—may be used in order to understand both natural language and the DSL. The context, as described herein, may include a higher-level description of the scene “a two lane road,” “a 4 way intersection with two lanes in each direction,” or “a large intersection with traffic lights.” In some embodiments, an encoded representation of a standard or lower definition map (relative to an HD map)—such as a navigational map—may be generated and used as a prefix or a prepended portion of a prompt of the LLM. For example, this map information may be encoded in natural language, or may be encoded in another format that is digestible by the LLM. This type of information, with more or less detail, in embodiments, may be processed by the one or more LLMs to generate a representation of the described scenario or scene in the RTL, for example. In some embodiments, observed geometry or image features may also be included or prepended to the prompt. Some of this information may be retrieved or generated using a map. For example, a map may include information encoded therein such as “type: intersection asymmetrical t junction {incomplete} (NE=>SW),” and this information may be used as part of the prompt. In some embodiments, information or descriptions such as (num lanes, num lanes in/out of intersection, num turn lanes, etc.) may be retrieved or obtained from reading the map. To capture this information, in embodiments, the RTL vocabulary may be extended to include these types of descriptions as prompt tokens. For example, as described above, the training data may include “DESCRIPTION 2 lanes 4 way intersection GEN (graph (lane_el . . . ), and the LLM(s) may be queried with or without the RTL graph information. This information may also be generated from open street maps (OSM) or another map source or database, and/or from processing images or other sensor data types.

As mentioned, such a representation of an environment can be used to perform specific tasks, as may relate to simulation or testing. In at least one embodiment, representations generated using approaches presented herein can be sufficiently realistic to allow a planning control system for an autonomous vehicle to operate within the environment. Maintaining semantic information and building from understood relationships can provide for a much more accurate and thorough representation of an environment that could otherwise be built using low-level primitive representations alone—such as points, lines, segments curves, or polygons representative of the shapes and locations of objects in an environment—with additional information (e.g., semantic data) being cast aside early in the reconstruction process as in prior approaches. As mentioned, topology information obtained from such low-level primitives can also be fragmented due to occlusions and other such factors. An example representation as generated in accordance with at least one embodiment can retain this additional information and complete a fragmented representation using one or more language models. Further, a representation might be able to be further improved by using multiple perception and/or localization modules that can analyze distinct types of input and fuse those inputs to generate more accurate features and relationships. A prior map or representation information can be used as well, where available. A language model can further be used to fuse these types of information to generate a single, consistent representation.

Aspects of various approaches presented herein can be lightweight enough to execute in various locations, such as on a device, such as a client device that includes a personal computer or gaming console, in real time. Such processing can be performed on, or for, content that is generated on, or received by, that client device or received from an external source, such as streaming data or other content received over at least one network from a cloud server 620 or third party service 660, among other such options. In some instances, at least a portion of the processing, generation, compositing, and/or determination of this content may be performed by one of these other devices, systems, or entities, then provided to the client device (or another such recipient) for presentation or another such use.

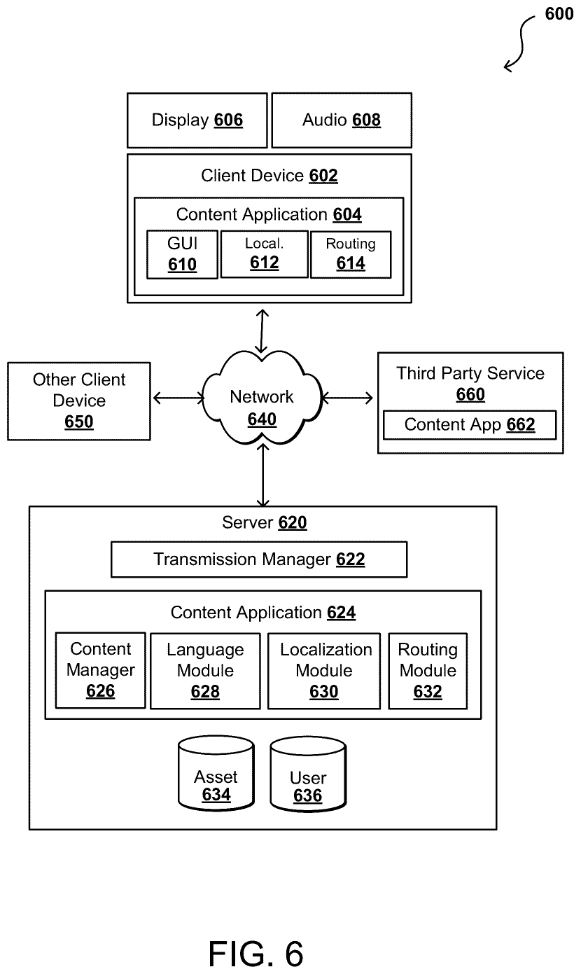

As an example, FIG. 6 illustrates an example network configuration 600 that can be used to provide, generate, modify, encode, process, and/or transmit generated data or other such content. In at least one embodiment, a client device 602 can generate or receive data for a session using components of a content application 604 on client device 602 and data stored locally on that client device. In at least one embodiment, a content application 624 executing on a cloud server 620 (e.g., a cloud server or edge server) may initiate a session associated with at least one client device 602, as may use a session manager and user data stored in a user database 636, and can cause content such as one or more digital assets (e.g., implicit and/or explicit object representations or maps) from an asset repository 634 to be determined by a content manager 626. A content manager 626 may work with a trained language module 628 to generate text-based representations of an environment based upon several types of input data. In at least one embodiment, these text-based representations can be provided to a localization module 630 in order to attempt to determine a current location associated with captured sensor or determined perception data, and/or a routing module 632 to use the tokenized descriptions and location information to determine routing data. At least a portion of the generated text-based representations, location information, and/or routing data can be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding content application 604, which may also or alternatively include a graphical user interface 610 allowing for user interaction, as well as a localization module 612 and routing module 614 for performing determinations on the client device itself, such as on a computerized vehicle. The content application 604 can also include a language module that can perform various generating tasks, such as to update or augment a text-based representation. A decoder may also be used to decode data received over the network 640 for presentation via client device 602, such as image or video content through a display device 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from cloud server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs (Graphics Processing Unit).

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by allowing the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device or may incorporate one or more Virtual Machines (VMs). In at least one embodiment, such a system can be implemented at least partially in a data center or at least partially using cloud computing resources.

### Inference and Training Logic

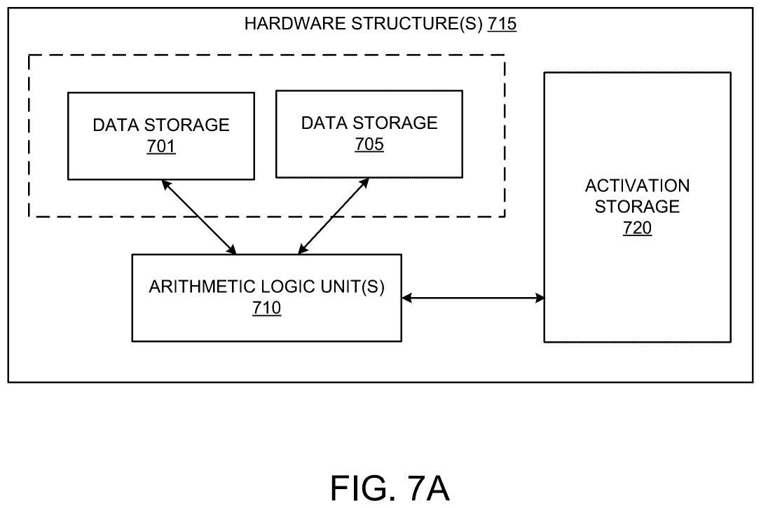

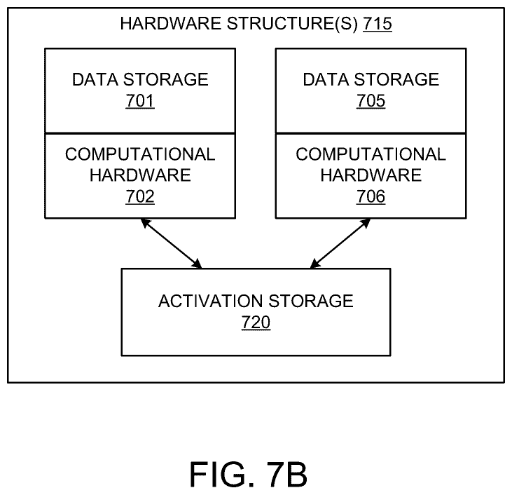

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 701 and/or code and/or data storage 705 are used as operands along with other values, such as bias values, gradient information, momentum values, or other parameters or hyperparameters, any or all of which may be stored in code and/or data storage 701 or code and/or data storage 705 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

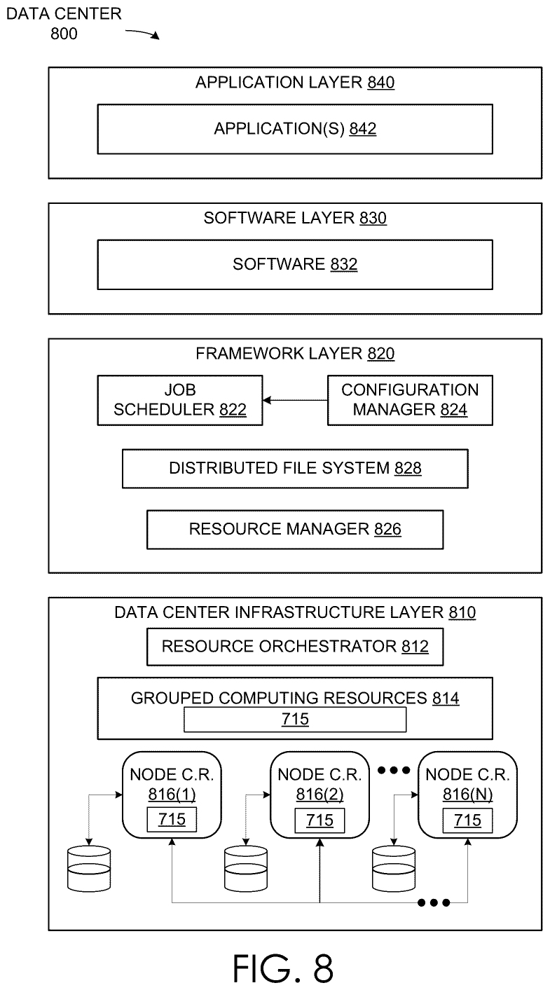

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to perform localization and/or route planning based in part upon one or more tokenized representations of at least a portion of an environment.

### Computer Systems

FIG. 9 is a block diagram illustrating an exemplary computer system 900, which may be a system with interconnected devices and components, a system-on-a-chip (SOC) or some combination thereof formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium® XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution unit(s) 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word computing (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache 904 may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit(s) 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit(s) 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor data bus 910 for performing operations on packed data, which may eliminate need to transfer smaller units of data across processor data bus 910 to perform one or more operations one data element at a time.

In at least one embodiment, execution unit(s) 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interface(s) 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to perform localization and/or route planning based in part upon one or more tokenized representations of at least a portion of an environment.

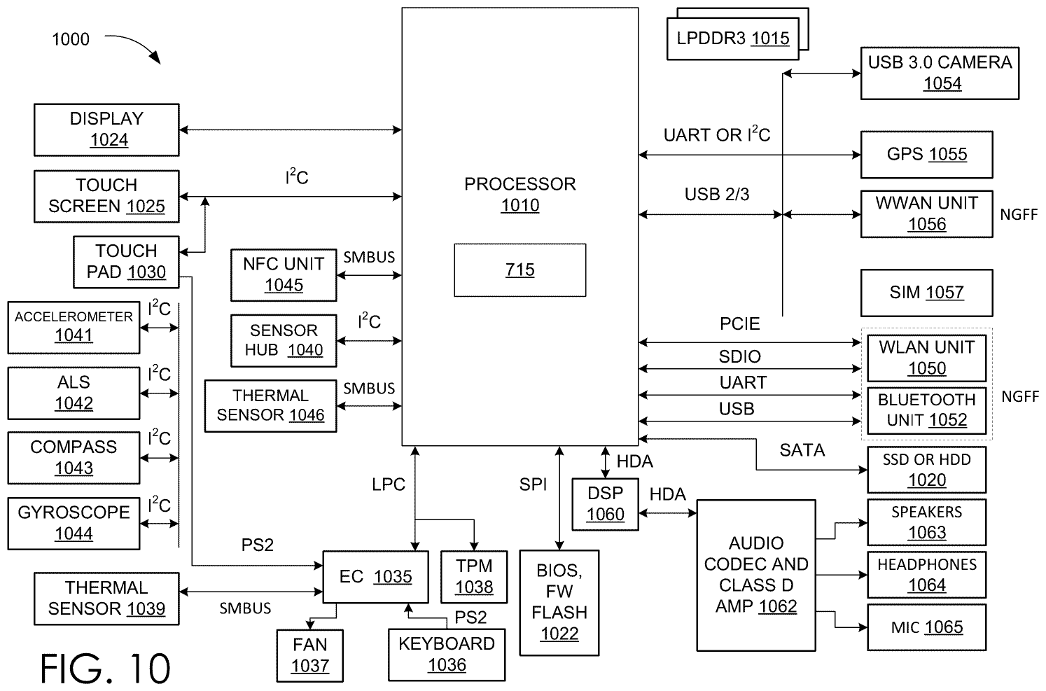

FIG. 10 is a block diagram illustrating an electronic device 1000 for using a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates an electronic device 1000, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to perform localization and/or route planning based in part upon one or more tokenized representations of at least a portion of an environment.

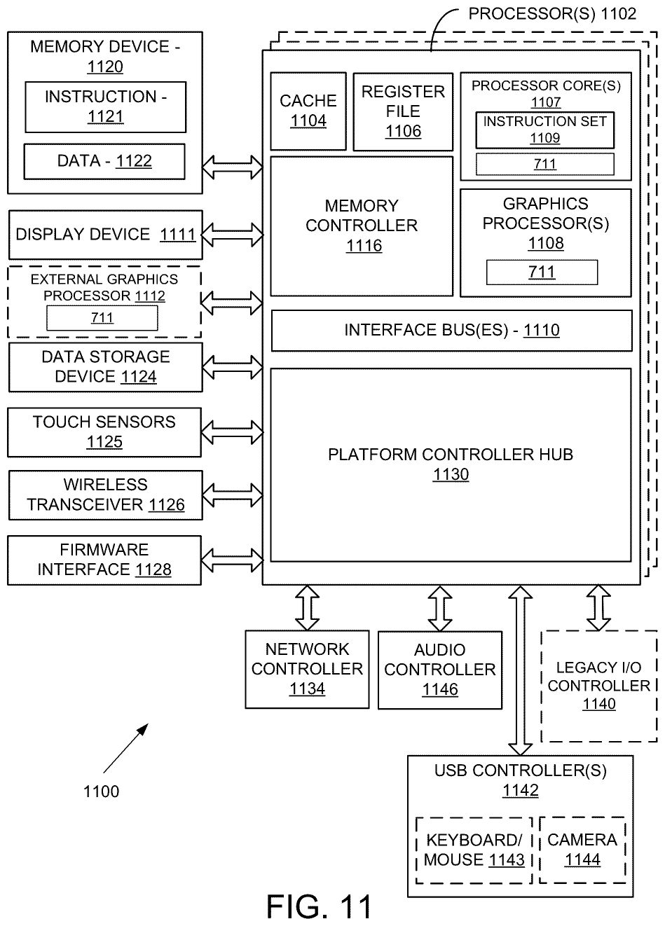

FIG. 11 is a block diagram of a processing system, according to at least one embodiment. In at least one embodiment, processing system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, processing system 1100 is a processing platform incorporated within a system-on-a-chip (SoC) integrated circuit for use in mobile, handheld, or embedded devices.

In at least one embodiment, processing system 1100 can include, or be incorporated within a server-based gaming platform, a game console, including a game and media console, a mobile gaming console, a handheld game console, or an online game console. In at least one embodiment, processing system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory (“cache”) 1104. In at least one embodiment, processor(s) 1102 can have a single internal cache or multiple levels of internal cache. In at least one embodiment, cache 1104 is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in processing system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory buses, or other types of interface buses. In at least one embodiment processor(s) 1102 include an integrated memory controller 1116 and a platform controller hub 1130. In at least one embodiment, memory controller 1116 facilitates communication between a memory device 1120 and other components of processing system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for processing system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 allows peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 allows communication with system firmware, and can be, for example, a unified extensible firmware interface (UEFI). In at least one embodiment, network controller 1134 can allow a network connection to a wired network. In at least one embodiment, a high-performance network controller (not shown) couples with interface bus(es) 1110. In at least one embodiment, audio controller 1146 is a multi-channel high definition audio controller. In at least one embodiment, processing system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, processing system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processing system 1100. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to perform localization and/or route planning based in part upon one or more tokenized representations of at least a portion of an environment.

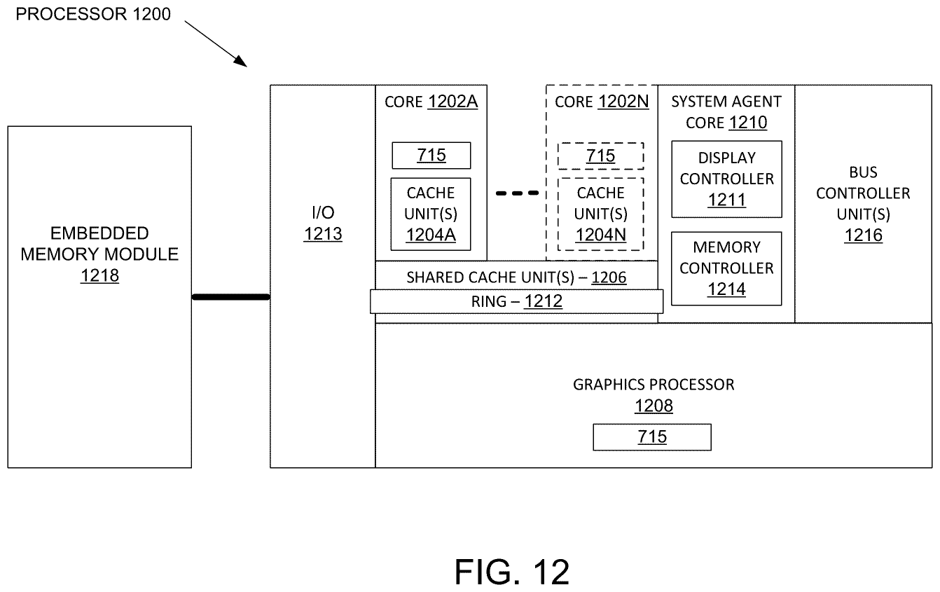

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache memory unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express buses. In at least one embodiment, system agent core 1210 provides management functionality for various processor components. In at least one embodiment, system agent core 1210 includes one or more integrated memory controller(s) 1214 to manage access to various external memory devices (not shown).

In at least one embodiment, one or more of processor core(s) 1202A-1202N include support for simultaneous multi-threading. In at least one embodiment, system agent core 1210 includes components for coordinating and operating processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controller(s) 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory module 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used to perform localization and/or route planning based in part upon one or more tokenized representations of at least a portion of an environment.

### Virtualized Computing Platform

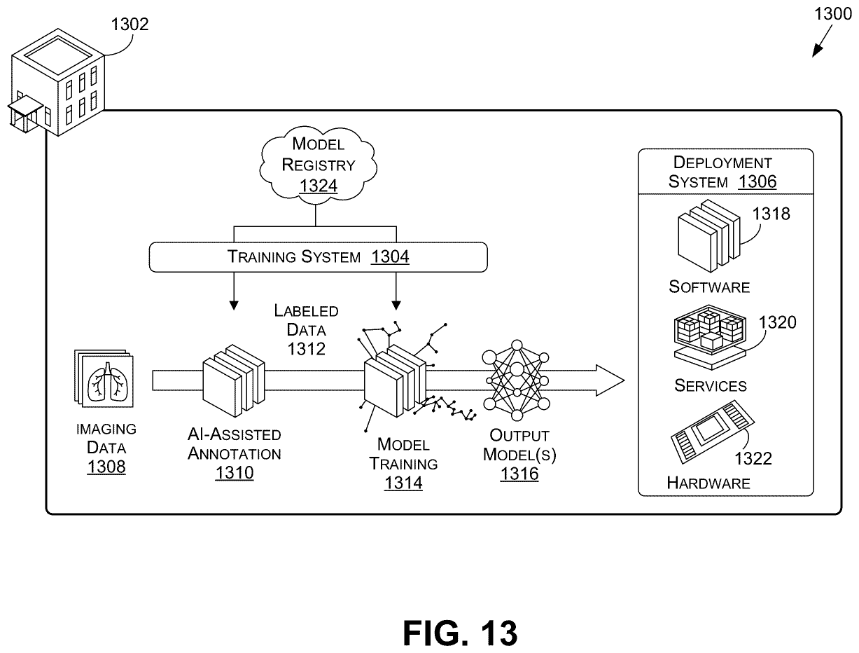

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facility (ies) 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility (ies) 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility (ies) 1302 using data 1308 (such as imaging data) generated at facility (ies) 1302 (and stored on one or more picture archiving and communication system (PACS) servers at facility (ies) 1302), may be trained using imaging or sequencing data 1308 from another facility (ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1304 (FIG. 13) may include a scenario where facility (ies) 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility (ies) 1302 needs a machine learning model for use in performing one or more processing tasks for one or more applications in deployment system 1306, but facility (ies) 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility (ies) 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility (ies) 1302 requiring a machine learning model for use in performing one or more processing tasks for one or more applications in deployment system 1306, but facility (ies) 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility (ies) 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility (ies) 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., processor 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by process 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., process 1300 of FIG. 13). In at least one embodiment, completed and validated applications or containers may be stored in a container registry and associated machine learning models may be stored in model registry 1324. In at least one embodiment, a requesting entity-who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306(e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform). In at least one embodiment, rather than each application that shares a same functionality offered by services 1320 being required to have a respective instance of services 1320, services 1320 may be shared between and among various applications. In at least one embodiment, services 1320 may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects-such as ray-tracing, rasterization, denoising, sharpening, etc.-to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an Al/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility (ies) 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an Al/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to allow seamless scaling and load balancing.

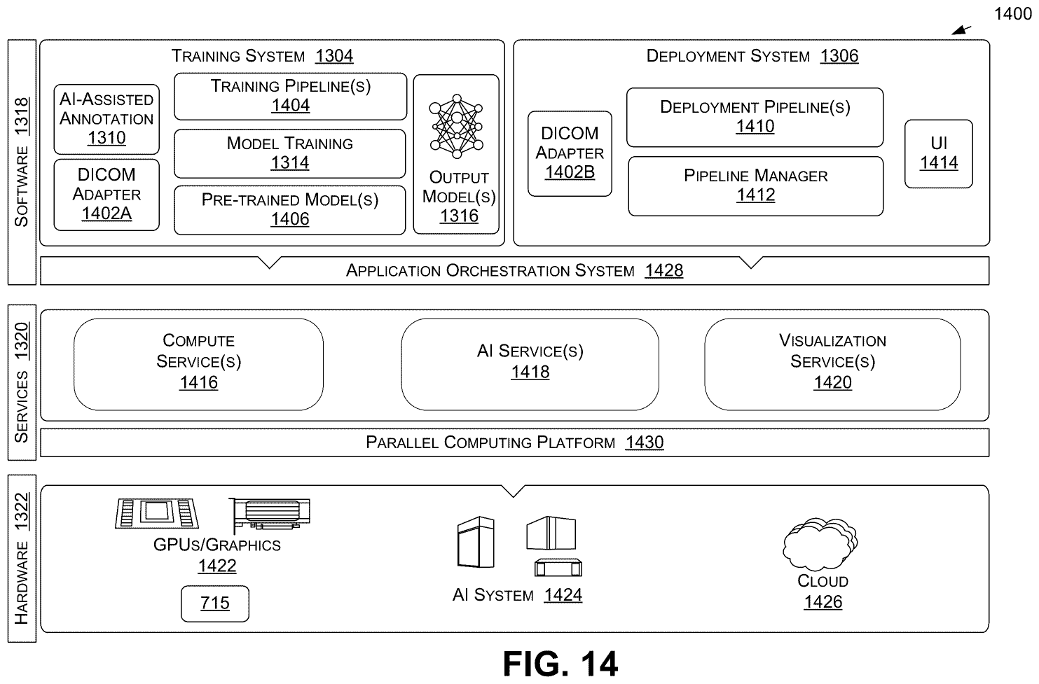

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus (ses), wireless data protocols (Wi-Fi), wired data protocols (e.g., Ethernet), etc.

In at least one embodiment, training system 1304 may execute training pipeline(s) 1404, similar to those described herein with respect to FIG. 13. In at least one embodiment, where one or more machine learning models are to be used in deployment pipeline(s) 1410 by deployment system 1306, training pipeline(s) 1404 may be used to train or retrain one or more (e.g. pre-trained) models, and/or implement one or more of pre-trained model(s) 1406(e.g., without a need for retraining or updating). In at least one embodiment, as a result of training pipeline(s) 1404, output model(s) 1316 may be generated. In at least one embodiment, training pipeline(s) 1404 may include any number of processing steps, such as but not limited to imaging data (or other input data) conversion or adaption In at least one embodiment, for different machine learning models used by deployment system 1306, different training pipeline(s) 1404 may be used. In at least one embodiment, training pipeline(s) 1404 similar to a first example described with respect to FIG. 13 may be used for a first machine learning model, training pipeline(s) 1404 similar to a second example described with respect to FIG. 13 may be used for a second machine learning model, and training pipeline(s) 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipeline(s) 1404 may include AI-assisted annotation, as described in more detail herein with respect to at least FIG. 14. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation 1310 may be performed as part of deployment pipelines 1410; either in addition to, or in lieu of AI-assisted annotation 1310 included in training pipeline(s) 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility (ies) 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.-including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QOS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may allow general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426- or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426(e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to allow seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

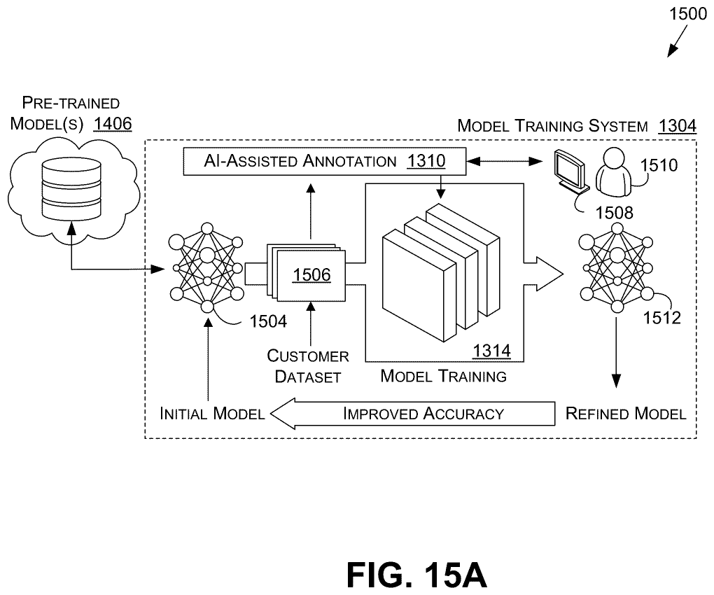

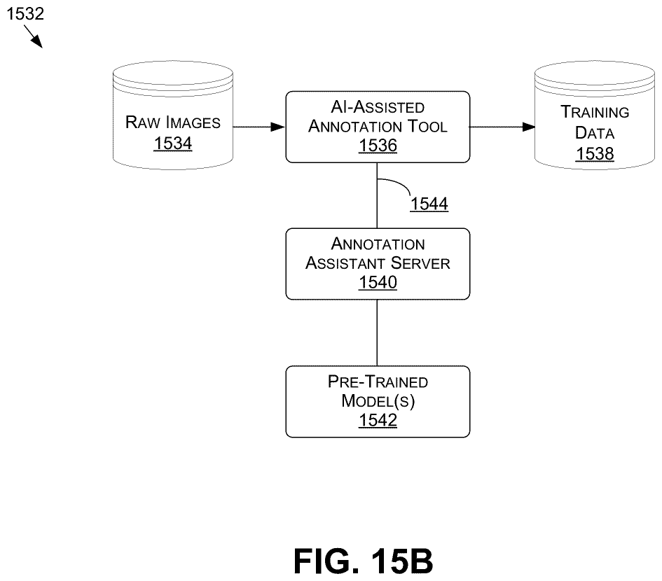

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined model 1512 generated by process 1500 may be executed by a deployment system for one or more containerized applications in deployment pipelines 1510.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained model(s) 1506 may be stored in a data store, or registry. In at least one embodiment, pre-trained model(s) 1506 may have been trained, at least in part, at one or more facilities other than a facility executing process 1500. In at least one embodiment, to protect privacy and rights of patients, subjects, or clients of different facilities, pre-trained model(s) 1506 may have been trained, on-premise, using customer or patient data generated on-premise. In at least one embodiment, pre-trained model(s) 1506 may be trained using a cloud and/or other hardware, but confidential, privacy protected patient data may not be transferred to, used by, or accessible to any components of a cloud (or other off premise hardware). In at least one embodiment, where pre-trained model(s) 1506 is trained at using patient data from more than one facility, pre-trained model(s) 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model(s) 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select pre-trained model(s) 1506 to use with an application. In at least one embodiment, pre-trained model(s) 1506 may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model(s) 1506 may be updated, retrained, and/or fine-tuned for use at a respective facility.

In at least one embodiment, a user may select pre-trained model(s) 1506 that is to be updated, retrained, and/or fine-tuned, and this pre-trained model may be referred to as initial model 1504 for a training system within process 1500. In at least one embodiment, a customer dataset 1506(e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by model training system 1304. In at least one embodiment, ground truth data may be generated, at least in part, by clinicians, scientists, doctors, practitioners, at a facility.

In at least one embodiment, AI-assisted annotation 1310 may be used in some examples to generate ground truth data. In at least one embodiment, AI-assisted annotation 1310 (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto) annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation model(s) 1542, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an annotation assistant server 1540 that may include a set of pre-trained model(s) 1542 stored in an annotation model registry, for example. In at least one embodiment, an annotation model registry may store pre-trained model(s) 1542 (e.g., machine learning models, such as deep learning models) that are pre-trained to perform AI-assisted annotation 1310 on a particular organ or abnormality. These models may be further updated by using training pipelines. In at least one embodiment, pre-installed annotation tools may be improved over time as new labeled data is added.

### Autonomous Vehicle

FIG. 16A illustrates an example of an autonomous vehicle 1600, according to at least one embodiment. In at least one embodiment, autonomous vehicle 1600 (alternatively referred to herein as “vehicle 1600”) may be, without limitation, a passenger vehicle, such as a car, a truck, a bus, and/or another type of vehicle that accommodates one or more passengers. In at least one embodiment, vehicle 1600 may be a semi-tractor-trailer truck used for hauling cargo. In at least one embodiment, vehicle 1600 may be an airplane, robotic vehicle, or other kind of vehicle.

Autonomous vehicles may be described in terms of automation levels, defined by National Highway Traffic Safety Administration (“NHTSA”), a division of US Department of Transportation, and Society of Automotive Engineers (“SAE”) “Taxonomy and Definitions for Terms Related to Driving Automation Systems for On-Road Motor Vehicles” (e.g., Standard No. J3016-201806, published on Jun. 15, 2018, Standard No. J3016-201609, published on Sep. 30, 2016, and previous and future versions of this standard). In at least one embodiment, vehicle 1600 may be capable of functionality in accordance with one or more of Level 1 through Level 5 of autonomous driving levels. For example, in at least one embodiment, vehicle 1600 may be capable of conditional automation (Level 3), high automation (Level 4), and/or full automation (Level 5), depending on embodiment.

In at least one embodiment, vehicle 1600 may include, without limitation, components such as a chassis, a vehicle body, wheels (e.g., 2, 4, 6, 8, 18, etc.), tires, axles, and other components of a vehicle. In at least one embodiment, vehicle 1600 may include, without limitation, a propulsion system 1650, such as an internal combustion engine, hybrid electric power plant, an all-electric engine, and/or another propulsion system type. In at least one embodiment, propulsion system 1650 may be connected to a drive train of vehicle 1600, which may include, without limitation, a transmission, to enable propulsion of vehicle 1600. In at least one embodiment, propulsion system 1650 may be controlled in response to receiving signals from a throttle/accelerator(s) 1652.

In at least one embodiment, a steering system 1654, which may include, without limitation, a steering wheel, is used to steer vehicle 1600 (e.g., along a desired path or route) when propulsion system 1650 is operating (e.g., when vehicle 1600 is in motion). In at least one embodiment, steering system 1654 may receive signals from steering actuator(s) 1656. In at least one embodiment, a steering wheel may be optional for full automation (Level 5) functionality. In at least one embodiment, a brake sensor system 1646 may be used to operate vehicle brakes in response to receiving signals from brake actuator(s) 1648 and/or brake sensors.

In at least one embodiment, controller(s) 1636, which may include, without limitation, one or more system on chips (“SoCs”) (not shown in FIG. 16A) and/or graphics processing unit(s) (“GPU(s)”), provide signals (e.g., representative of commands) to one or more components and/or systems of vehicle 1600. For instance, in at least one embodiment, controller(s) 1636 may send signals to operate vehicle brakes via brake actuator(s) 1648, to operate steering system 1654 via steering actuator(s) 1656, to operate propulsion system 1650 via throttle/accelerator(s) 1652. In at least one embodiment, controller(s) 1636 may include one or more onboard (e.g., integrated) computing devices that process sensor signals, and output operation commands (e.g., signals representing commands) to enable autonomous driving and/or to assist a human driver in driving vehicle 1600. In at least one embodiment, controller(s) 1636 may include a first controller for autonomous driving functions, a second controller for functional safety functions, a third controller for artificial intelligence functionality (e.g., computer vision), a fourth controller for infotainment functionality, a fifth controller for redundancy in emergency conditions, and/or other controllers. In at least one embodiment, a single controller may handle two or more of above functionalities, two or more controllers may handle a single functionality, and/or any combination thereof.

In at least one embodiment, controller(s) 1636 provide signals for controlling one or more components and/or systems of vehicle 1600 in response to sensor data received from one or more sensors (e.g., sensor inputs). In at least one embodiment, sensor data may be received from, for example and without limitation, global navigation satellite systems (“GNSS”) sensor(s) 1658 (e.g., Global Positioning System sensor(s)), RADAR sensor(s) 1660, ultrasonic sensor(s) 1662, LIDAR sensor(s) 1664, inertial measurement unit (“IMU”) sensor(s) 1666(e.g., accelerometer(s), gyroscope(s), a magnetic compass or magnetic compasses, magnetometer(s), etc.), microphone(s) 1696, stereo camera(s) 1668, wide-view camera(s) 1670 (e.g., fisheye cameras), infrared camera(s) 1672, surround camera(s) 1674 (e.g., 360 degree cameras), long-range cameras (not shown in FIG. 16A), mid-range camera(s) (not shown in FIG. 16A), speed sensor(s) 1644 (e.g., for measuring speed of vehicle 1600), vibration sensor(s) 1642, steering sensor(s) 1640, brake sensor(s) (e.g., as part of brake sensor system 1646), and/or other sensor types.

In at least one embodiment, one or more of controller(s) 1636 may receive inputs (e.g., represented by input data) from an instrument cluster 1632 of vehicle 1600 and provide outputs (e.g., represented by output data, display data, etc.) via a human-machine interface (“HMI”) display 1634, an audible annunciator, a loudspeaker, and/or via other components of vehicle 1600. In at least one embodiment, outputs may include information such as vehicle velocity, speed, time, map data (e.g., a High Definition map (not shown in FIG. 16A)), location data (e.g., vehicle's 1600 location, such as on a map), direction, location of other vehicles (e.g., an occupancy grid), information about objects and status of objects as perceived by controller(s) 1636, etc. For example, in at least one embodiment, HMI display 1634 may display information about presence of one or more objects (e.g., a street sign, caution sign, traffic light changing, etc.), and/or information about driving maneuvers vehicle has made, is making, or will make (e.g., changing lanes now, taking exit 34B in two miles, etc.).

In at least one embodiment, vehicle 1600 further includes a network interface 1624 which may use wireless antenna(s) 1626 and/or modem(s) to communicate over one or more networks. For example, in at least one embodiment, network interface 1624 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”) networks, etc. In at least one embodiment, wireless antenna(s) 1626 may also enable communication between objects in environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc. protocols.

Inference and/or training logic 715 are used to perform inferencing and/or training operations associated with one or more embodiments. Details regarding inference and/or training logic 715 are provided herein in conjunction with FIGS. 7A and/or 7B. In at least one embodiment, inference and/or training logic 715 may be used in system FIG. 16A for inferencing or predicting operations based, at least in part, on weight parameters calculated using neural network training operations, neural network functions and/or architectures, or neural network use cases described herein.

Such components can be used to perform localization and/or route planning based in part upon one or more tokenized representations of at least a portion of an environment.

FIG. 16B illustrates an example of camera locations and fields of view for autonomous vehicle 1600 of FIG. 16A, according to at least one embodiment. In at least one embodiment, cameras and respective fields of view are one example embodiment and are not intended to be limiting. For instance, in at least one embodiment, additional and/or alternative cameras may be included and/or cameras may be located at different locations on vehicle 1600.

In at least one embodiment, camera types for cameras may include, but are not limited to, digital cameras that may be adapted for use with components and/or systems of vehicle 1600. In at least one embodiment, camera(s) may operate at automotive safety integrity level (“ASIL”) B and/or at another ASIL. In at least one embodiment, camera types may be capable of any image capture rate, such as 60 frames per second (fps), 1220 fps, 240 fps, etc., depending on embodiment. In at least one embodiment, cameras may be capable of using rolling shutters, global shutters, another type of shutter, or a combination thereof. In at least one embodiment, color filter array may include a red clear clear clear (“RCCC”) color filter array, a red clear clear blue (“RCCB”) color filter array, a red blue green clear (“RBGC”) color filter array, a Foveon X3 color filter array, a Bayer sensors (“RGGB”) color filter array, a monochrome sensor color filter array, and/or another type of color filter array. In at least one embodiment, clear pixel cameras, such as cameras with an RCCC, an RCCB, and/or an RBGC color filter array, may be used in an effort to increase light sensitivity.

In at least one embodiment, one or more of camera(s) may be used to perform advanced driver assistance systems (“ADAS”) functions (e.g., as part of a redundant or fail-safe design). For example, in at least one embodiment, a Multi-Function Mono Camera may be installed to provide functions including lane departure warning, traffic sign assist and intelligent headlamp control. In at least one embodiment, one or more of camera(s) (e.g., all cameras) may record and provide image data (e.g., video) simultaneously.

In at least one embodiment, one or more camera may be mounted in a mounting assembly, such as a custom designed (three-dimensional (“3D”) printed) assembly, in order to cut out stray light and reflections from within vehicle 1600 (e.g., reflections from dashboard reflected in windshield mirrors) which may interfere with camera image data capture abilities. With reference to wing-mirror mounting assemblies, in at least one embodiment, wing-mirror assemblies may be custom 3D printed so that a camera mounting plate matches a shape of a wing-mirror. In at least one embodiment, camera(s) may be integrated into wing-mirrors. In at least one embodiment, for side-view cameras, camera(s) may also be integrated within four pillars at each corner of a cabin.

In at least one embodiment, cameras with a field of view that include portions of an environment in front of vehicle 1600 (e.g., front-facing cameras) may be used for surround view, to help identify forward facing paths and obstacles, as well as aid in, with help of one or more of controller(s) 1636 and/or control SoCs, providing information critical to generating an occupancy grid and/or determining preferred vehicle paths. In at least one embodiment, front-facing cameras may be used to perform many similar ADAS functions as LIDAR, including, without limitation, emergency braking, pedestrian detection, and collision avoidance. In at least one embodiment, front-facing cameras may also be used for ADAS functions and systems including, without limitation, Lane Departure Warnings (“LDW”), Autonomous Cruise Control (“ACC”), and/or other functions such as traffic sign recognition.

In at least one embodiment, a variety of cameras may be used in a front-facing configuration, including, for example, a monocular camera platform that includes a CMOS (“complementary metal oxide semiconductor”) color imager. In at least one embodiment, a wide-view camera 1670 may be used to perceive objects coming into view from a periphery (e.g., pedestrians, crossing traffic or bicycles). Although only one wide-view camera 1670 is illustrated in FIG. 16B, in other embodiments, there may be any number (including zero) wide-view cameras on vehicle 1600. In at least one embodiment, any number of long-range camera(s) 1698 (e.g., a long-view stereo camera pair) may be used for depth-based object detection, especially for objects for which a neural network has not yet been trained. In at least one embodiment, long-range camera(s) 1698 may also be used for object detection and classification, as well as basic object tracking.

In at least one embodiment, any number of stereo camera(s) 1668 may also be included in a front-facing configuration. In at least one embodiment, one or more of stereo camera(s) 1668 may include an integrated control unit comprising a scalable processing unit, which may provide a programmable logic (“FPGA”) and a multi-core micro-processor with an integrated Controller Area Network (“CAN”) or Ethernet interface on a single chip. In at least one embodiment, such a unit may be used to generate a 3D map of an environment of vehicle 1600, including a distance estimate for all points in an image. In at least one embodiment, one or more of stereo camera(s) 1668 may include, without limitation, compact stereo vision sensor(s) that may include, without limitation, two camera lenses (one each on left and right) and an image processing chip that may measure distance from vehicle 1600 to target object and use generated information (e.g., metadata) to activate autonomous emergency braking and lane departure warning functions. In at least one embodiment, other types of stereo camera(s) 1668 may be used in addition to, or alternatively from, those described herein.

In at least one embodiment, cameras with a field of view that include portions of environment to sides of vehicle 1600 (e.g., side-view cameras) may be used for surround view, providing information used to create and update an occupancy grid, as well as to generate side impact collision warnings. For example, in at least one embodiment, surround camera(s) 1674 (e.g., four surround cameras as illustrated in FIG. 16B) could be positioned on vehicle 1600. In at least one embodiment, surround camera(s) 1674 may include, without limitation, any number and combination of wide-view cameras, fisheye camera(s), 360 degree camera(s), and/or similar cameras. For instance, in at least one embodiment, four fisheye cameras may be positioned on a front, a rear, and sides of vehicle 1600. In at least one embodiment, vehicle 1600 may use three surround camera(s) 1674 (e.g., left, right, and rear), and may leverage one or more other camera(s) (e.g., a forward-facing camera) as a fourth surround-view camera.

In at least one embodiment, cameras with a field of view that include portions of an environment behind vehicle 1600 (e.g., rear-view cameras) may be used for parking assistance, surround view, rear collision warnings, and creating and updating an occupancy grid. In at least one embodiment, a wide variety of cameras may be used including, but not limited to, cameras that are also suitable as a front-facing camera(s) (e.g., long-range camera(s) 1698 and/or mid-range camera(s) 1676, stereo camera(s) 1668, infrared camera(s) 1672, etc.,) as described herein.

Inference and/or training logic 715 are used to perform inferencing and/or training operations associated with one or more embodiments. Details regarding inference and/or training logic 715 are provided herein in conjunction with FIGS. 7A and/or 7B. In at least one embodiment, inference and/or training logic 715 may be used in system FIG. 16B for inferencing or predicting operations based, at least in part, on weight parameters calculated using neural network training operations, neural network functions and/or architectures, or neural network use cases described herein.

Such components can be used to perform localization and/or route planning based in part upon one or more tokenized representations of at least a portion of an environment.

FIG. 16C is a block diagram illustrating an example system architecture for autonomous vehicle 1600 of FIG. 16A, according to at least one embodiment. In at least one embodiment, each of components, features, and systems of vehicle 1600 in FIG. 16C is illustrated as being connected via a bus 1602. In at least one embodiment, bus 1602 may include, without limitation, a CAN data interface (alternatively referred to herein as a “CAN bus”). In at least one embodiment, a CAN may be a network inside vehicle 1600 used to aid in control of various features and functionality of vehicle 1600, such as actuation of brakes, acceleration, braking, steering, windshield wipers, etc. In at least one embodiment, bus 1602 may be configured to have dozens or even hundreds of nodes, each with its own unique identifier (e.g., a CAN ID). In at least one embodiment, bus 1602 may be read to find steering wheel angle, ground speed, engine revolutions per minute (“RPMs”), button positions, and/or other vehicle status indicators. In at least one embodiment, bus 1602 may be a CAN bus that is ASIL B compliant.

In at least one embodiment, in addition to, or alternatively from CAN, FlexRay and/or Ethernet protocols may be used. In at least one embodiment, there may be any number of busses forming bus 1602, which may include, without limitation, zero or more CAN busses, zero or more FlexRay busses, zero or more Ethernet busses, and/or zero or more other types of busses using different protocols. In at least one embodiment, two or more busses may be used to perform different functions, and/or may be used for redundancy. For example, a first bus may be used for collision avoidance functionality and a second bus may be used for actuation control. In at least one embodiment, each bus of bus 1602 may communicate with any of components of vehicle 1600, and two or more busses of bus 1602 may communicate with corresponding components. In at least one embodiment, each of any number of system(s) on chip(s) (“SoC(s)”) 1604 (such as SoC 1604 (A) and SoC 1604 (B)), each of controller(s) 1636, and/or each computer within vehicle may have access to same input data (e.g., inputs from sensors of vehicle 1600), and may be connected to a common bus, such CAN bus.

In at least one embodiment, vehicle 1600 may include one or more controller(s) 1636, such as those described herein with respect to FIG. 16A. In at least one embodiment, controller(s) 1636 may be used for a variety of functions. In at least one embodiment, controller(s) 1636 may be coupled to any of various other components and systems of vehicle 1600, and may be used for control of vehicle 1600, artificial intelligence of vehicle 1600, infotainment for vehicle 1600, and/or other functions.

In at least one embodiment, vehicle 1600 may include any number of SoCs 1604. In at least one embodiment, each of SoCs 1604 may include, without limitation, central processing units (“CPU(s)”) 1606, graphics processing units (“GPU(s)”) 1608, processor(s) 1610, cache(s) 1612, accelerator(s) 1614, data store(s) 1616, and/or other components and features not illustrated. In at least one embodiment, SoC(s) 1604 may be used to control vehicle 1600 in a variety of platforms and systems. For example, in at least one embodiment, SoC(s) 1604 may be combined in a system (e.g., system of vehicle 1600) with a High Definition (“HD”) map 1622 which may obtain map refreshes and/or updates via network interface 1624 from one or more servers (not shown in FIG. 16C).

In at least one embodiment, CPU(s) 1606 may include a CPU cluster or CPU complex (alternatively referred to herein as a “CCPLEX”). In at least one embodiment, CPU(s) 1606 may include multiple cores and/or level two (“L2”) caches. For instance, in at least one embodiment, CPU(s) 1606 may include eight cores in a coherent multi-processor configuration. In at least one embodiment, CPU(s) 1606 may include four dual-core clusters where each cluster has a dedicated L2 cache (e.g., a 2 megabyte (MB) L2 cache). In at least one embodiment, CPU(s) 1606(e.g., CCPLEX) may be configured to support simultaneous cluster operations enabling any combination of clusters of CPU(s) 1606 to be active at any given time.

In at least one embodiment, one or more of CPU(s) 1606 may implement power management capabilities that include, without limitation, one or more of following features: individual hardware blocks may be clock-gated automatically when idle to save dynamic power; each core clock may be gated when such core is not actively executing instructions due to execution of Wait for Interrupt (“WFI”)/Wait for Event (“WFE”) instructions; each core may be independently power-gated; each core cluster may be independently clock-gated when all cores are clock-gated or power-gated; and/or each core cluster may be independently power-gated when all cores are power-gated. In at least one embodiment, CPU(s) 1606 may further implement an enhanced algorithm for managing power states, where allowed power states and expected wakeup times are specified, and hardware/microcode determines which best power state to enter for core, cluster, and CCPLEX. In at least one embodiment, processing cores may support simplified power state entry sequences in software with work offloaded to microcode.

In at least one embodiment, GPU(s) 1608 may include an integrated GPU (alternatively referred to herein as an “iGPU”). In at least one embodiment, GPU(s) 1608 may be programmable and may be efficient for parallel workloads. In at least one embodiment, GPU(s) 1608 may use an enhanced tensor instruction set. In at least one embodiment, GPU(s) 1608 may include one or more streaming microprocessors, where each streaming microprocessor may include a level one (“L1”) cache (e.g., an L1 cache with at least 96 KB storage capacity), and two or more streaming microprocessors may share an L2 cache (e.g., an L2 cache with a 512 KB storage capacity). In at least one embodiment, GPU(s) 1608 may include at least eight streaming microprocessors. In at least one embodiment, GPU(s) 1608 may use compute application programming interface(s) (API(s)). In at least one embodiment, GPU(s) 1608 may use one or more parallel computing platforms and/or programming models (e.g., NVIDIA's CUDA model).

In at least one embodiment, one or more of GPU(s) 1608 may be power-optimized for best performance in automotive and embedded use cases. For example, in at least one embodiment, GPU(s) 1608 could be fabricated on Fin field-effect transistor (“FinFET”) circuitry. In at least one embodiment, each streaming microprocessor may incorporate a number of mixed-precision processing cores partitioned into multiple blocks. For example, and without limitation, 64 PF32 cores and 32 PF64 cores could be partitioned into four processing blocks. In at least one embodiment, each processing block could be allocated 16 FP32 cores, 8 FP64 cores, 16 INT32 cores, two mixed-precision NVIDIA Tensor cores for deep learning matrix arithmetic, a level zero (“L0”) instruction cache, a scheduler (e.g., warp scheduler) or sequencer, a dispatch unit, and/or a 64 KB register file. In at least one embodiment, streaming microprocessors may include independent parallel integer and floating-point data paths to provide for efficient execution of workloads with a mix of computation and addressing calculations. In at least one embodiment, streaming microprocessors may include independent thread scheduling capability to enable finer-grain synchronization and cooperation between parallel threads. In at least one embodiment, streaming microprocessors may include a combined L1 data cache and shared memory unit in order to improve performance while simplifying programming.

In at least one embodiment, one or more of GPU(s) 1608 may include a high bandwidth memory (“HBM”) and/or a 16 GB HBM2 memory subsystem to provide, in some examples, about 900 GB/second peak memory bandwidth. In at least one embodiment, in addition to, or alternatively from, HBM memory, a synchronous graphics random-access memory (“SGRAM”) may be used, such as a graphics double data rate type five synchronous random-access memory (“GDDR5”).

In at least one embodiment, GPU(s) 1608 may include unified memory technology. In at least one embodiment, address translation services (“ATS”) support may be used to allow GPU(s) 1608 to access CPU(s) 1606 page tables directly. In at least one embodiment, embodiment, when a GPU of GPU(s) 1608 memory management unit (“MMU”) experiences a miss, an address translation request may be transmitted to CPU(s) 1606. In response, 2 CPU of CPU(s) 1606 may look in its page tables for a virtual-to-physical mapping for an address and transmit translation back to GPU(s) 1608, in at least one embodiment. In at least one embodiment, unified memory technology may allow a single unified virtual address space for memory of both CPU(s) 1606 and GPU(s) 1608, thereby simplifying GPU(s) 1608 programming and porting of applications to GPU(s) 1608.

In at least one embodiment, GPU(s) 1608 may include any number of access counters that may keep track of frequency of access of GPU(s) 1608 to memory of other processors. In at least one embodiment, access counter(s) may help ensure that memory pages are moved to physical memory of a processor that is accessing pages most frequently, thereby improving efficiency for memory ranges shared between processors.

In at least one embodiment, one or more of SoC(s) 1604 may include any number of cache(s) 1612, including those described herein. For example, in at least one embodiment, cache(s) 1612 could include a level three (“L3”) cache that is available to both CPU(s) 1606 and GPU(s) 1608 (e.g., that is connected to CPU(s) 1606 and GPU(s) 1608). In at least one embodiment, cache(s) 1612 may include a write-back cache that may keep track of states of lines, such as by using a cache coherence protocol (e.g., MEI, MESI, MSI, etc.). In at least one embodiment, a L3 cache may include 4 MB of memory or more, depending on embodiment, although smaller cache sizes may be used.

In at least one embodiment, one or more of SoC(s) 1604 may include one or more accelerator(s) 1614 (e.g., hardware accelerators, software accelerators, or a combination thereof). In at least one embodiment, SoC(s) 1604 may include a hardware acceleration cluster that may include optimized hardware accelerators and/or large on-chip memory. In at least one embodiment, large on-chip memory (e.g., 4 MB of SRAM), may enable a hardware acceleration cluster to accelerate neural networks and other calculations. In at least one embodiment, a hardware acceleration cluster may be used to complement GPU(s) 1608 and to off-load some of tasks of GPU(s) 1608 (e.g., to free up more cycles of GPU(s) 1608 for performing other tasks). In at least one embodiment, accelerator(s) 1614 could be used for targeted workloads (e.g., perception, convolutional neural networks (“CNNs”), recurrent neural networks (“RNNs”), etc.) that are stable enough to be amenable to acceleration. In at least one embodiment, a CNN may include a region-based or regional convolutional neural networks (“RCNNs”) and Fast RCNNs (e.g., as used for object detection) or other type of CNN.

In at least one embodiment, accelerator(s) 1614 (e.g., hardware acceleration cluster) may include one or more deep learning accelerator (“DLA”). In at least one embodiment, DLA(s) may include, without limitation, one or more Tensor processing units (“TPUs”) that may be configured to provide an additional ten trillion operations per second for deep learning applications and inferencing. In at least one embodiment, TPUs may be accelerators configured to, and optimized for, performing image processing functions (e.g., for CNNs, RCNNs, etc.). In at least one embodiment, DLA(s) may further be optimized for a specific set of neural network types and floating point operations, as well as inferencing. In at least one embodiment, design of DLA(s) may provide more performance per millimeter than a typical general-purpose GPU, and typically vastly exceeds performance of a CPU. In at least one embodiment, TPU(s) may perform several functions, including a single-instance convolution function, supporting, for example, INT8, INT16, and FP16 data types for both features and weights, as well as post-processor functions. In at least one embodiment, DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

In at least one embodiment, DLA(s) may perform any function of GPU(s) 1608, and by using an inference accelerator, for example, a designer may target either DLA(s) or GPU(s) 1608 for any function. For example, in at least one embodiment, a designer may focus processing of CNNs and floating point operations on DLA(s) and leave other functions to GPU(s) 1608 and/or accelerator(s) 1614.

In at least one embodiment, accelerator(s) 1614 may include programmable vision accelerator (“PVA”), which may alternatively be referred to herein as a computer vision accelerator. In at least one embodiment, PVA may be designed and configured to accelerate computer vision algorithms for advanced driver assistance system (“ADAS”) 1638, autonomous driving, augmented reality (“AR”) applications, and/or virtual reality (“VR”) applications. In at least one embodiment, PVA may provide a balance between performance and flexibility. For example, in at least one embodiment, each PVA may include, for example and without limitation, any number of reduced instruction set computer (“RISC”) cores, direct memory access (“DMA”), and/or any number of vector processors.

In at least one embodiment, RISC cores may interact with image sensors (e.g., image sensors of any cameras described herein), image signal processor(s), etc. In at least one embodiment, each RISC core may include any amount of memory. In at least one embodiment, RISC cores may use any of a number of protocols, depending on embodiment. In at least one embodiment, RISC cores may execute a real-time operating system (“RTOS”). In at least one embodiment, RISC cores may be implemented using one or more integrated circuit devices, application specific integrated circuits (“ASICs”), and/or memory devices. For example, in at least one embodiment, RISC cores could include an instruction cache and/or a tightly coupled RAM.

In at least one embodiment, DMA may enable components of PVA to access system memory independently of CPU(s) 1606. In at least one embodiment, DMA may support any number of features used to provide optimization to a PVA including, but not limited to, supporting multi-dimensional addressing and/or circular addressing. In at least one embodiment, DMA may support up to six or more dimensions of addressing, which may include, without limitation, block width, block height, block depth, horizontal block stepping, vertical block stepping, and/or depth stepping.

In at least one embodiment, vector processors may be programmable processors that may be designed to efficiently and flexibly execute programming for computer vision algorithms and provide signal processing capabilities. In at least one embodiment, a PVA may include a PVA core and two vector processing subsystem partitions. In at least one embodiment, a PVA core may include a processor subsystem, DMA engine(s) (e.g., two DMA engines), and/or other peripherals. In at least one embodiment, a vector processing subsystem may operate as a primary processing engine of a PVA, and may include a vector processing unit (“VPU”), an instruction cache, and/or vector memory (e.g., “VMEM”). In at least one embodiment, VPU core may include a digital signal processor such as, for example, a single instruction, multiple data (“SIMD”), very long instruction word (“VLIW”) digital signal processor. In at least one embodiment, a combination of SIMD and VLIW may enhance throughput and speed.

In at least one embodiment, each of vector processors may include an instruction cache and may be coupled to dedicated memory. As a result, in at least one embodiment, each of vector processors may be configured to execute independently of other vector processors. In at least one embodiment, vector processors that are included in a particular PVA may be configured to employ data parallelism. For instance, in at least one embodiment, plurality of vector processors included in a single PVA may execute a common computer vision algorithm, but on different regions of an image. In at least one embodiment, vector processors included in a particular PVA may simultaneously execute different computer vision algorithms, on one image, or even execute different algorithms on sequential images or portions of an image. In at least one embodiment, among other things, any number of PVAs may be included in hardware acceleration cluster and any number of vector processors may be included in each PVA. In at least one embodiment, PVA may include additional error correcting code (“ECC”) memory, to enhance overall system safety.

In at least one embodiment, accelerator(s) 1614 may include a computer vision network on-chip and static random-access memory (“SRAM”), for providing a high-bandwidth, low latency SRAM for accelerator(s) 1614. In at least one embodiment, on-chip memory may include at least 4 MB SRAM, comprising, for example and without limitation, eight field-configurable memory blocks, that may be accessible by both a PVA and a DLA. In at least one embodiment, each pair of memory blocks may include an advanced peripheral bus (“APB”) interface, configuration circuitry, a controller, and a multiplexer. In at least one embodiment, any type of memory may be used. In at least one embodiment, a PVA and a DLA may access memory via a backbone that provides a PVA and a DLA with high-speed access to memory. In at least one embodiment, a backbone may include a computer vision network on-chip that interconnects a PVA and a DLA to memory (e.g., using APB).

In at least one embodiment, a computer vision network on-chip may include an interface that determines, before transmission of any control signal/address/data, that both a PVA and a DLA provide ready and valid signals. In at least one embodiment, an interface may provide for separate phases and separate channels for transmitting control signals/addresses/data, as well as burst-type communications for continuous data transfer. In at least one embodiment, an interface may comply with International Organization for Standardization (“ISO”) 26262 or International Electrotechnical Commission (“IEC”) 61508 standards, although other standards and protocols may be used.

In at least one embodiment, one or more of SoC(s) 1604 may include a real-time ray-tracing hardware accelerator. In at least one embodiment, real-time ray-tracing hardware accelerator may be used to quickly and efficiently determine positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses.

In at least one embodiment, accelerator(s) 1614 can have a wide array of uses for autonomous driving. In at least one embodiment, a PVA may be used for key processing stages in ADAS and autonomous vehicles. In at least one embodiment, a PVA's capabilities are a good match for algorithmic domains needing predictable processing, at low power and low latency. In other words, a PVA performs well on semi-dense or dense regular computation, even on small data sets, which might require predictable run-times with low latency and low power. In at least one embodiment, such as in vehicle 1600, PVAs might be designed to run classic computer vision algorithms, as they can be efficient at object detection and operating on integer math.

For example, according to at least one embodiment of technology, a PVA is used to perform computer stereo vision. In at least one embodiment, a semi-global matching-based algorithm may be used in some examples, although this is not intended to be limiting. In at least one embodiment, applications for Level 3-5 autonomous driving use motion estimation/stereo matching on-the-fly (e.g., structure from motion, pedestrian recognition, lane detection, etc.). In at least one embodiment, a PVA may perform computer stereo vision functions on inputs from two monocular cameras.

In at least one embodiment, a PVA may be used to perform dense optical flow. For example, in at least one embodiment, a PVA could process raw RADAR data (e.g., using a 4D Fast Fourier Transform) to provide processed RADAR data. In at least one embodiment, a PVA is used for time of flight depth processing, by processing raw time of flight data to provide processed time of flight data, for example.

In at least one embodiment, a DLA may be used to run any type of network to enhance control and driving safety, including for example and without limitation, a neural network that outputs a measure of confidence for each object detection. In at least one embodiment, confidence may be represented or interpreted as a probability, or as providing a relative “weight” of each detection compared to other detections. In at least one embodiment, a confidence measure enables a system to make further decisions regarding which detections should be considered as true positive detections rather than false positive detections. In at least one embodiment, a system may set a threshold value for confidence and consider only detections exceeding threshold value as true positive detections. In an embodiment in which an automatic emergency braking (“AEB”) system is used, false positive detections would cause vehicle to automatically perform emergency braking, which is obviously undesirable. In at least one embodiment, highly confident detections may be considered as triggers for AEB. In at least one embodiment, a DLA may run a neural network for regressing confidence value. In at least one embodiment, neural network may take as its input at least some subset of parameters, such as bounding box dimensions, ground plane estimate obtained (e.g., from another subsystem), output from IMU sensor(s) 1666 that correlates with vehicle 1600 orientation, distance, 3D location estimates of object obtained from neural network and/or other sensors (e.g., LIDAR sensor(s) 1664 or RADAR sensor(s) 1660), among others.

In at least one embodiment, one or more of SoC(s) 1604 may include data store(s) 1616 (e.g., memory). In at least one embodiment, data store(s) 1616 may be on-chip memory of SoC(s) 1604, which may store neural networks to be executed on GPU(s) 1608 and/or a DLA. In at least one embodiment, data store(s) 1616 may be large enough in capacity to store multiple instances of neural networks for redundancy and safety. In at least one embodiment, data store(s) 1616 may comprise L2 or L3 cache(s).

In at least one embodiment, one or more of SoC(s) 1604 may include any number of processor(s) 1610 (e.g., embedded processors). In at least one embodiment, processor(s) 1610 may include a boot and power management processor that may be a dedicated processor and subsystem to handle boot power and management functions and related security enforcement. In at least one embodiment, a boot and power management processor may be a part of a boot sequence of SoC(s) 1604 and may provide runtime power management services. In at least one embodiment, a boot power and management processor may provide clock and voltage programming, assistance in system low power state transitions, management of SoC(s) 1604 thermals and temperature sensors, and/or management of SoC(s) 1604 power states. In at least one embodiment, each temperature sensor may be implemented as a ring-oscillator whose output frequency is proportional to temperature, and SoC(s) 1604 may use ring-oscillators to detect temperatures of CPU(s) 1606, GPU(s) 1608, and/or accelerator(s) 1614. In at least one embodiment, if temperatures are determined to exceed a threshold, then a boot and power management processor may enter a temperature fault routine and put SoC(s) 1604 into a lower power state and/or put vehicle 1600 into a chauffeur to safe stop mode (e.g., bring vehicle 1600 to a safe stop).

In at least one embodiment, processor(s) 1610 may further include a set of embedded processors that may serve as an audio processing engine which may be an audio subsystem that enables full hardware support for multi-channel audio over multiple interfaces, and a broad and flexible range of audio I/O interfaces. In at least one embodiment, an audio processing engine is a dedicated processor core with a digital signal processor with dedicated RAM.

In at least one embodiment, processor(s) 1610 may further include an alwayson processor engine that may provide necessary hardware features to support low power sensor management and wake use cases. In at least one embodiment, an alwayson processor engine may include, without limitation, a processor core, a tightly coupled RAM, supporting peripherals (e.g., timers and interrupt controllers), various I/O controller peripherals, and routing logic.

In at least one embodiment, processor(s) 1610 may further include a safety cluster engine that includes, without limitation, a dedicated processor subsystem to handle safety management for automotive applications. In at least one embodiment, a safety cluster engine may include, without limitation, two or more processor cores, a tightly coupled RAM, support peripherals (e.g., timers, an interrupt controller, etc.), and/or routing logic. In a safety mode, two or more cores may operate, in at least one embodiment, in a lockstep mode and function as a single core with comparison logic to detect any differences between their operations. In at least one embodiment, processor(s) 1610 may further include a real-time camera engine that may include, without limitation, a dedicated processor subsystem for handling real-time camera management. In at least one embodiment, processor(s) 1610 may further include a high-dynamic range signal processor that may include, without limitation, an image signal processor that is a hardware engine that is part of a camera processing pipeline.

In at least one embodiment, processor(s) 1610 may include a video image compositor that may be a processing block (e.g., implemented on a microprocessor) that implements video post-processing functions needed by a video playback application to produce a final image for a player window. In at least one embodiment, a video image compositor may perform lens distortion correction on wide-view camera(s) 1670, surround camera(s) 1674, and/or on in-cabin monitoring camera sensor(s). In at least one embodiment, in-cabin monitoring camera sensor(s) are preferably monitored by a neural network running on another instance of SoC 1604, configured to identify in cabin events and respond accordingly. In at least one embodiment, an in-cabin system may perform, without limitation, lip reading to activate cellular service and place a phone call, dictate emails, change a vehicle's destination, activate or change a vehicle's infotainment system and settings, or provide voice-activated web surfing. In at least one embodiment, certain functions are available to a driver when a vehicle is operating in an autonomous mode and are disabled otherwise.

In at least one embodiment, a video image compositor may include enhanced temporal noise reduction for both spatial and temporal noise reduction. For example, in at least one embodiment, where motion occurs in a video, noise reduction weights spatial information appropriately, decreasing weights of information provided by adjacent frames. In at least one embodiment, where an image or portion of an image does not include motion, temporal noise reduction performed by video image compositor may use information from a previous image to reduce noise in a current image.

In at least one embodiment, a video image compositor may also be configured to perform stereo rectification on input stereo lens frames. In at least one embodiment, a video image compositor may further be used for user interface composition when an operating system desktop is in use, and GPU(s) 1608 are not required to continuously render new surfaces. In at least one embodiment, when GPU(s) 1608 are powered on and active doing 3D rendering, a video image compositor may be used to offload GPU(s) 1608 to improve performance and responsiveness.

In at least one embodiment, one or more SoC of SoC(s) 1604 may further include a mobile industry processor interface (“MIPI”) camera serial interface for receiving video and input from cameras, a high-speed interface, and/or a video input block that may be used for a camera and related pixel input functions. In at least one embodiment, one or more of SoC(s) 1604 may further include an input/output controller(s) that may be controlled by software and may be used for receiving I/O signals that are uncommitted to a specific role.

In at least one embodiment, one or more Soc of SoC(s) 1604 may further include a broad range of peripheral interfaces to enable communication with peripherals, audio encoders/decoders (“codecs”), power management, and/or other devices. In at least one embodiment, SoC(s) 1604 may be used to process data from cameras (e.g., connected over Gigabit Multimedia Serial Link and Ethernet channels), sensors (e.g., LIDAR sensor(s) 1664, RADAR sensor(s) 1660, etc. that may be connected over Ethernet channels), data from bus 1602 (e.g., speed of vehicle 1600, steering wheel position, etc.), data from GNSS sensor(s) 1658 (e.g., connected over a Ethernet bus or a CAN bus), etc. In at least one embodiment, one or more SoC of SoC(s) 1604 may further include dedicated high-performance mass storage controllers that may include their own DMA engines, and that may be used to free CPU(s) 1606 from routine data management tasks.

In at least one embodiment, SoC(s) 1604 may be an end-to-end platform with a flexible architecture that spans automation Levels 3-5, thereby providing a comprehensive functional safety architecture that leverages and makes efficient use of computer vision and ADAS techniques for diversity and redundancy, and provides a platform for a flexible, reliable driving software stack, along with deep learning tools. In at least one embodiment, SoC(s) 1604 may be faster, more reliable, and even more energy-efficient and space-efficient than conventional systems. For example, in at least one embodiment, accelerator(s) 1614, when combined with CPU(s) 1606, GPU(s) 1608, and data store(s) 1616, may provide for a fast, efficient platform for Level 3-5 autonomous vehicles.

In at least one embodiment, computer vision algorithms may be executed on CPUs, which may be configured using a high-level programming language, such as C, to execute a wide variety of processing algorithms across a wide variety of visual data. However, in at least one embodiment, CPUs are oftentimes unable to meet performance requirements of many computer vision applications, such as those related to execution time and power consumption, for example. In at least one embodiment, many CPUs are unable to execute complex object detection algorithms in real-time, which is used in in-vehicle ADAS applications and in practical Level 3-5 autonomous vehicles.

Embodiments described herein allow for multiple neural networks to be performed simultaneously and/or sequentially, and for results to be combined together to enable Level 3-5 autonomous driving functionality. For example, in at least one embodiment, a CNN executing on a DLA or a discrete GPU (e.g., GPU(s) 1620) may include text and word recognition, allowing reading and understanding of traffic signs, including signs for which a neural network has not been specifically trained. In at least one embodiment, a DLA may further include a neural network that is able to identify, interpret, and provide semantic understanding of a sign, and to pass that semantic understanding to path planning modules running on a CPU Complex.

In at least one embodiment, multiple neural networks may be run simultaneously, as for Level 3, 4, or 5 driving. For example, in at least one embodiment, a warning sign stating “Caution: flashing lights indicate icy conditions,” along with an electric light, may be independently or collectively interpreted by several neural networks. In at least one embodiment, such warning sign itself may be identified as a traffic sign by a first deployed neural network (e.g., a neural network that has been trained), text “flashing lights indicate icy conditions” may be interpreted by a second deployed neural network, which informs a vehicle's path planning software (preferably executing on a CPU Complex) that when flashing lights are detected, icy conditions exist. In at least one embodiment, a flashing light may be identified by operating a third deployed neural network over multiple frames, informing a vehicle's path-planning software of a presence (or an absence) of flashing lights. In at least one embodiment, all three neural networks may run simultaneously, such as within a DLA and/or on GPU(s) 1608.

In at least one embodiment, a CNN for facial recognition and vehicle owner identification may use data from camera sensors to identify presence of an authorized driver and/or owner of vehicle 1600. In at least one embodiment, an alwayson sensor processing engine may be used to unlock a vehicle when an owner approaches a driver door and turns on lights, and, in a security mode, to disable such vehicle when an owner leaves such vehicle. In this way, SoC(s) 1604 provide for security against theft and/or carjacking.

In at least one embodiment, a CNN for emergency vehicle detection and identification may use data from microphones 1696 to detect and identify emergency vehicle sirens. In at least one embodiment, SoC(s) 1604 use a CNN for classifying environmental and urban sounds, as well as classifying visual data. In at least one embodiment, a CNN running on a DLA is trained to identify a relative closing speed of an emergency vehicle (e.g., by using a Doppler effect). In at least one embodiment, a CNN may also be trained to identify emergency vehicles specific to a local area in which a vehicle is operating, as identified by GNSS sensor(s) 1658. In at least one embodiment, when operating in Europe, a CNN will seek to detect European sirens, and when in North America, a CNN will seek to identify only North American sirens. In at least one embodiment, once an emergency vehicle is detected, a control program may be used to execute an emergency vehicle safety routine, slowing a vehicle, pulling over to a side of a road, parking a vehicle, and/or idling a vehicle, with assistance of ultrasonic sensor(s) 1662, until emergency vehicles pass.

In at least one embodiment, vehicle 1600 may include CPU(s) 1618 (e.g., discrete CPU(s), or dCPU(s)), that may be coupled to SoC(s) 1604 via a high-speed interconnect (e.g., PCIe). In at least one embodiment, CPU(s) 1618 may include an X86 processor, for example. CPU(s) 1618 may be used to perform any of a variety of functions, including arbitrating potentially inconsistent results between ADAS sensors and SoC(s) 1604, and/or monitoring status and health of controller(s) 1636 and/or an infotainment system on a chip (“infotainment SoC”) 1630, for example. In at least one embodiment, SoC(s) 1604 includes one or more interconnects, and an interconnect can include a peripheral component interconnect express (PCIe).

In at least one embodiment, vehicle 1600 may include GPU(s) 1620 (e.g., discrete GPU(s), or dGPU(s)), that may be coupled to SoC(s) 1604 via a high-speed interconnect (e.g., NVIDIA's NVLINK channel). In at least one embodiment, GPU(s) 1620 may provide additional artificial intelligence functionality, such as by executing redundant and/or different neural networks, and may be used to train and/or update neural networks based at least in part on input (e.g., sensor data) from sensors of a vehicle 1600.

In at least one embodiment, vehicle 1600 may further include network interface 1624 which may include, without limitation, wireless antenna(s) 1626(e.g., one or more wireless antennas for different communication protocols, such as a cellular antenna, a Bluetooth antenna, etc.). In at least one embodiment, network interface 1624 may be used to enable wireless connectivity to Internet cloud services (e.g., with server(s) and/or other network devices), with other vehicles, and/or with computing devices (e.g., client devices of passengers). In at least one embodiment, to communicate with other vehicles, a direct link may be established between vehicle 160 and another vehicle and/or an indirect link may be established (e.g., across networks and over the Internet). In at least one embodiment, direct links may be provided using a vehicle-to-vehicle communication link. In at least one embodiment, a vehicle-to-vehicle communication link may provide vehicle 1600 information about vehicles in proximity to vehicle 1600 (e.g., vehicles in front of, on a side of, and/or behind vehicle 1600). In at least one embodiment, such aforementioned functionality may be part of a cooperative adaptive cruise control functionality of vehicle 1600.

In at least one embodiment, network interface 1624 may include an SoC that provides modulation and demodulation functionality and enables controller(s) 1636 to communicate over wireless networks. In at least one embodiment, network interface 1624 may include a radio frequency front-end for up-conversion from baseband to radio frequency, and down conversion from radio frequency to baseband. In at least one embodiment, frequency conversions may be performed in any technically feasible fashion. For example, frequency conversions could be performed through well-known processes, and/or using super-heterodyne processes. In at least one embodiment, radio frequency front end functionality may be provided by a separate chip. In at least one embodiment, network interfaces may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

In at least one embodiment, vehicle 1600 may further include data store(s) 1628 which may include, without limitation, off-chip (e.g., off SoC(s) 1604) storage. In at least one embodiment, data store(s) 1628 may include, without limitation, one or more storage elements including RAM, SRAM, dynamic random-access memory (“DRAM”), video random-access memory (“VRAM”), flash memory, hard disks, and/or other components and/or devices that may store at least one bit of data.

In at least one embodiment, vehicle 1600 may further include GNSS sensor(s) 1658 (e.g., GPS and/or assisted GPS sensors), to assist in mapping, perception, occupancy grid generation, and/or path planning functions. In at least one embodiment, any number of GNSS sensor(s) 1658 may be used, including, for example and without limitation, a GPS using a USB connector with an Ethernet-to-Serial (e.g., RS-232) bridge.

In at least one embodiment, vehicle 1600 may further include RADAR sensor(s) 1660. In at least one embodiment, RADAR sensor(s) 1660 may be used by vehicle 1600 for long-range vehicle detection, even in darkness and/or severe weather conditions. In at least one embodiment, RADAR functional safety levels may be ASIL B. In at least one embodiment, RADAR sensor(s) 1660 may use a CAN bus and/or bus 1602 (e.g., to transmit data generated by RADAR sensor(s) 1660) for control and to access object tracking data, with access to Ethernet channels to access raw data in some examples. In at least one embodiment, a wide variety of RADAR sensor types may be used. For example, and without limitation, RADAR sensor(s) 1660 may be suitable for front, rear, and side RADAR use. In at least one embodiment, one or more sensor of RADAR sensors(s) 1660 is a Pulse Doppler RADAR sensor.

In at least one embodiment, RADAR sensor(s) 1660 may include different configurations, such as long-range with narrow field of view, short-range with wide field of view, short-range side coverage, etc. In at least one embodiment, long-range RADAR may be used for adaptive cruise control functionality. In at least one embodiment, long-range RADAR systems may provide a broad field of view realized by two or more independent scans, such as within a 250 m (meter) range. In at least one embodiment, RADAR sensor(s) 1660 may help in distinguishing between static and moving objects, and may be used by ADAS system 1638 for emergency brake assist and forward collision warning. In at least one embodiment, sensors 1660(s) included in a long-range RADAR system may include, without limitation, monostatic multimodal RADAR with multiple (e.g., six or more) fixed RADAR antennae and a high-speed CAN and FlexRay interface. In at least one embodiment, with six antennae, a central four antennae may create a focused beam pattern, designed to record vehicle's 1600 surroundings at higher speeds with minimal interference from traffic in adjacent lanes. In at least one embodiment, another two antennae may expand field of view, making it possible to quickly detect vehicles entering or leaving a lane of vehicle 1600.

In at least one embodiment, mid-range RADAR systems may include, as an example, a range of up to 160 m (front) or 80 m (rear), and a field of view of up to 42 degrees (front) or 150 degrees (rear). In at least one embodiment, short-range RADAR systems may include, without limitation, any number of RADAR sensor(s) 1660 designed to be installed at both ends of a rear bumper. When installed at both ends of a rear bumper, in at least one embodiment, a RADAR sensor system may create two beams that constantly monitor blind spots in a rear direction and next to a vehicle. In at least one embodiment, short-range RADAR systems may be used in ADAS system 1638 for blind spot detection and/or lane change assist.

In at least one embodiment, vehicle 1600 may further include ultrasonic sensor(s) 1662. In at least one embodiment, ultrasonic sensor(s) 1662, which may be positioned at a front, a back, and/or side location of vehicle 1600, may be used for parking assist and/or to create and update an occupancy grid. In at least one embodiment, a wide variety of ultrasonic sensor(s) 1662 may be used, and different ultrasonic sensor(s) 1662 may be used for different ranges of detection (e.g., 2.5 m, 4 m). In at least one embodiment, ultrasonic sensor(s) 1662 may operate at functional safety levels of ASIL B.

In at least one embodiment, vehicle 1600 may include LIDAR sensor(s) 1664. In at least one embodiment, LIDAR sensor(s) 1664 may be used for object and pedestrian detection, emergency braking, collision avoidance, and/or other functions. In at least one embodiment, LIDAR sensor(s) 1664 may operate at functional safety level ASIL B. In at least one embodiment, vehicle 1600 may include multiple LIDAR sensors 1664 (e.g., two, four, six, etc.) that may use an Ethernet channel (e.g., to provide data to a Gigabit Ethernet switch).

In at least one embodiment, LIDAR sensor(s) 1664 may be capable of providing a list of objects and their distances for a 360-degree field of view. In at least one embodiment, commercially available LIDAR sensor(s) 1664 may have an advertised range of approximately 100 m, with an accuracy of 2 cm to 3 cm, and with support for a 100 Mbps Ethernet connection, for example. In at least one embodiment, one or more non-protruding LIDAR sensors may be used. In such an embodiment, LIDAR sensor(s) 1664 may include a small device that may be embedded into a front, a rear, a side, and/or a corner location of vehicle 1600. In at least one embodiment, LIDAR sensor(s) 1664, in such an embodiment, may provide up to a 120-degree horizontal and 35-degree vertical field-of-view, with a 200 m range even for low-reflectivity objects. In at least one embodiment, front-mounted LIDAR sensor(s) 1664 may be configured for a horizontal field of view between 45 degrees and 135 degrees.

In at least one embodiment, LIDAR technologies, such as 3D flash LIDAR, may also be used. In at least one embodiment, 3D flash LIDAR uses a flash of a laser as a transmission source, to illuminate surroundings of vehicle 1600 up to approximately 200 m. In at least one embodiment, a flash LIDAR unit includes, without limitation, a receptor, which records laser pulse transit time and reflected light on each pixel, which in turn corresponds to a range from vehicle 1600 to objects. In at least one embodiment, flash LIDAR may allow for highly accurate and distortion-free images of surroundings to be generated with every laser flash. In at least one embodiment, four flash LIDAR sensors may be deployed, one at each side of vehicle 1600. In at least one embodiment, 3D flash LIDAR systems include, without limitation, a solid-state 3D staring array LIDAR camera with no moving parts other than a fan (e.g., a non-scanning LIDAR device). In at least one embodiment, flash LIDAR device may use a 5 nanosecond class I (eye-safe) laser pulse per frame and may capture reflected laser light as a 3D range point cloud and co-registered intensity data.

In at least one embodiment, vehicle 1600 may further include IMU sensor(s) 1666. In at least one embodiment, IMU sensor(s) 1666 may be located at a center of a rear axle of vehicle 1600. In at least one embodiment, IMU sensor(s) 1666 may include, for example and without limitation, accelerometer(s), magnetometer(s), gyroscope(s), a magnetic compass, magnetic compasses, and/or other sensor types. In at least one embodiment, such as in six-axis applications, IMU sensor(s) 1666 may include, without limitation, accelerometers and gyroscopes. In at least one embodiment, such as in nine-axis applications, IMU sensor(s) 1666 may include, without limitation, accelerometers, gyroscopes, and magnetometers.

In at least one embodiment, IMU sensor(s) 1666 may be implemented as a miniature, high performance GPS-Aided Inertial Navigation System (“GPS/INS”) that combines micro-electro-mechanical systems (“MEMS”) inertial sensors, a high-sensitivity GPS receiver, and advanced Kalman filtering algorithms to provide estimates of position, velocity, and attitude. In at least one embodiment, IMU sensor(s) 1666 may enable vehicle 1600 to estimate its heading without requiring input from a magnetic sensor by directly observing and correlating changes in velocity from a GPS to IMU sensor(s) 1666. In at least one embodiment, IMU sensor(s) 1666 and GNSS sensor(s) 1658 may be combined in a single integrated unit.

In at least one embodiment, vehicle 1600 may include microphone(s) 1696 placed in and/or around vehicle 1600. In at least one embodiment, microphone(s) 1696 may be used for emergency vehicle detection and identification, among other things.

In at least one embodiment, vehicle 1600 may further include any number of camera types, including stereo camera(s) 1668, wide-view camera(s) 1670, infrared camera(s) 1672, surround camera(s) 1674, long-range camera(s) 1698, mid-range camera(s) 1676, and/or other camera types. In at least one embodiment, cameras may be used to capture image data around an entire periphery of vehicle 1600. In at least one embodiment, which types of cameras used depends on vehicle 1600. In at least one embodiment, any combination of camera types may be used to provide necessary coverage around vehicle 1600. In at least one embodiment, a number of cameras deployed may differ depending on embodiment. For example, in at least one embodiment, vehicle 1600 could include six cameras, seven cameras, ten cameras, twelve cameras, or another number of cameras. In at least one embodiment, cameras may support, as an example and without limitation, Gigabit Multimedia Serial Link (“GMSL”) and/or Gigabit Ethernet communications. In at least one embodiment, each camera might be as described with more detail previously herein with respect to FIG. 16A and FIG. 16B.

In at least one embodiment, vehicle 1600 may further include vibration sensor(s) 1642. In at least one embodiment, vibration sensor(s) 1642 may measure vibrations of components of vehicle 1600, such as axle(s). For example, in at least one embodiment, changes in vibrations may indicate a change in road surfaces. In at least one embodiment, when two or more vibration sensors 1642 are used, differences between vibrations may be used to determine friction or slippage of road surface (e.g., when a difference in vibration is between a power-driven axle and a freely rotating axle).

In at least one embodiment, vehicle 1600 may include ADAS system 1638. In at least one embodiment, ADAS system 1638 may include, without limitation, an SoC, in some examples. In at least one embodiment, ADAS system 1638 may include, without limitation, any number and combination of an autonomous/adaptive/automatic cruise control (“ACC”) system, a cooperative adaptive cruise control (“CACC”) system, a forward crash warning (“FCW”) system, an automatic emergency braking (“AEB”) system, a lane departure warning (“LDW)” system, a lane keep assist (“LKA”) system, a blind spot warning (“BSW”) system, a rear cross-traffic warning (“RCTW”) system, a collision warning (“CW”) system, a lane centering (“LC”) system, and/or other systems, features, and/or functionality.

In at least one embodiment, ACC system may use RADAR sensor(s) 1660, LIDAR sensor(s) 1664, and/or any number of camera(s). In at least one embodiment, ACC system may include a longitudinal ACC system and/or a lateral ACC system. In at least one embodiment, a longitudinal ACC system monitors and controls distance to another vehicle immediately ahead of vehicle 1600 and automatically adjusts speed of vehicle 1600 to maintain a safe distance from vehicles ahead. In at least one embodiment, a lateral ACC system performs distance keeping, and advises vehicle 1600 to change lanes when necessary. In at least one embodiment, a lateral ACC is related to other ADAS applications, such as LC and CW.

In at least one embodiment, a CACC system uses information from other vehicles that may be received via network interface 1624 and/or wireless antenna(s) 1626 from other vehicles via a wireless link, or indirectly, over a network connection (e.g., over the Internet). In at least one embodiment, direct links may be provided by a vehicle-to-vehicle (“V2V”) communication link, while indirect links may be provided by an infrastructure-to-vehicle (“I2V”) communication link. In general, V2V communication provides information about immediately preceding vehicles (e.g., vehicles immediately ahead of and in same lane as vehicle 1600), while I2V communication provides information about traffic further ahead. In at least one embodiment, a CACC system may include either or both I2V and V2V information sources. In at least one embodiment, given information of vehicles ahead of vehicle 1600, a CACC system may be more reliable and it has potential to improve traffic flow smoothness and reduce congestion on road.

In at least one embodiment, an FCW system is designed to alert a driver to a hazard, so that such driver may take corrective action. In at least one embodiment, an FCW system uses a front-facing camera and/or RADAR sensor(s) 1660, coupled to a dedicated processor, DSP, FPGA, and/or ASIC, that is electrically coupled to provide driver feedback, such as a display, speaker, and/or vibrating component. In at least one embodiment, an FCW system may provide a warning, such as in form of a sound, visual warning, vibration and/or a quick brake pulse.

In at least one embodiment, an AEB system detects an impending forward collision with another vehicle or other object, and may automatically apply brakes if a driver does not take corrective action within a specified time or distance parameter. In at least one embodiment, AEB system may use front-facing camera(s) and/or RADAR sensor(s) 1660, coupled to a dedicated processor, DSP, FPGA, and/or ASIC. In at least one embodiment, when an AEB system detects a hazard, it will typically first alert a driver to take corrective action to avoid collision and, if that driver does not take corrective action, that AEB system may automatically apply brakes in an effort to prevent, or at least mitigate, an impact of a predicted collision. In at least one embodiment, an AEB system may include techniques such as dynamic brake support and/or crash imminent braking.

In at least one embodiment, an LDW system provides visual, audible, and/or tactile warnings, such as steering wheel or seat vibrations, to alert driver when vehicle 1600 crosses lane markings. In at least one embodiment, an LDW system does not activate when a driver indicates an intentional lane departure, such as by activating a turn signal. In at least one embodiment, an LDW system may use front-side facing cameras, coupled to a dedicated processor, DSP, FPGA, and/or ASIC, that is electrically coupled to provide driver feedback, such as a display, speaker, and/or vibrating component. In at least one embodiment, an LKA system is a variation of an LDW system. In at least one embodiment, an LKA system provides steering input or braking to correct vehicle 1600 if vehicle 1600 starts to exit its lane.

In at least one embodiment, a BSW system detects and warns a driver of vehicles in an automobile's blind spot. In at least one embodiment, a BSW system may provide a visual, audible, and/or tactile alert to indicate that merging or changing lanes is unsafe. In at least one embodiment, a BSW system may provide an additional warning when a driver uses a turn signal. In at least one embodiment, a BSW system may use rear-side facing camera(s) and/or RADAR sensor(s) 1660, coupled to a dedicated processor, DSP, FPGA, and/or ASIC, that is electrically coupled to driver feedback, such as a display, speaker, and/or vibrating component.

In at least one embodiment, an RCTW system may provide visual, audible, and/or tactile notification when an object is detected outside a rear-camera range when vehicle 1600 is backing up. In at least one embodiment, an RCTW system includes an AEB system to ensure that vehicle brakes are applied to avoid a crash. In at least one embodiment, an RCTW system may use one or more rear-facing RADAR sensor(s) 1660, coupled to a dedicated processor, DSP, FPGA, and/or ASIC, that is electrically coupled to provide driver feedback, such as a display, speaker, and/or vibrating component.

In at least one embodiment, conventional ADAS systems may be prone to false positive results which may be annoying and distracting to a driver, but typically are not catastrophic, because conventional ADAS systems alert a driver and allow that driver to decide whether a safety condition truly exists and act accordingly. In at least one embodiment, vehicle 1600 itself decides, in case of conflicting results, whether to heed result from a primary computer or a secondary computer (e.g., a first controller or a second controller of controllers 1636). For example, in at least one embodiment, ADAS system 1638 may be a backup and/or secondary computer for providing perception information to a backup computer rationality module. In at least one embodiment, a backup computer rationality monitor may run redundant diverse software on hardware components to detect faults in perception and dynamic driving tasks. In at least one embodiment, outputs from ADAS system 1638 may be provided to a supervisory MCU. In at least one embodiment, if outputs from a primary computer and outputs from a secondary computer conflict, a supervisory MCU determines how to reconcile conflict to ensure safe operation.

In at least one embodiment, a primary computer may be configured to provide a supervisory MCU with a confidence score, indicating that primary computer's confidence in a chosen result. In at least one embodiment, if that confidence score exceeds a threshold, that supervisory MCU may follow that primary computer's direction, regardless of whether that secondary computer provides a conflicting or inconsistent result. In at least one embodiment, where a confidence score does not meet a threshold, and where primary and secondary computers indicate different results (e.g., a conflict), a supervisory MCU may arbitrate between computers to determine an appropriate outcome.

In at least one embodiment, a supervisory MCU may be configured to run a neural network(s) that is trained and configured to determine, based at least in part on outputs from a primary computer and outputs from a secondary computer, conditions under which that secondary computer provides false alarms. In at least one embodiment, neural network(s) in a supervisory MCU may learn when a secondary computer's output may be trusted, and when it cannot. For example, in at least one embodiment, when that secondary computer is a RADAR-based FCW system, a neural network(s) in that supervisory MCU may learn when an FCW system is identifying metallic objects that are not, in fact, hazards, such as a drainage grate or manhole cover that triggers an alarm. In at least one embodiment, when a secondary computer is a camera-based LDW system, a neural network in a supervisory MCU may learn to override LDW when bicyclists or pedestrians are present and a lane departure is, in fact, a safest maneuver. In at least one embodiment, a supervisory MCU may include at least one of a DLA or a GPU suitable for running neural network(s) with associated memory. In at least one embodiment, a supervisory MCU may comprise and/or be included as a component of SoC(s) 1604.

In at least one embodiment, ADAS system 1638 may include a secondary computer that performs ADAS functionality using traditional rules of computer vision. In at least one embodiment, that secondary computer may use classic computer vision rules (if-then), and presence of a neural network(s) in a supervisory MCU may improve reliability, safety and performance. For example, in at least one embodiment, diverse implementation and intentional non-identity makes an overall system more fault-tolerant, especially to faults caused by software (or software-hardware interface) functionality. For example, in at least one embodiment, if there is a software bug or error in software running on a primary computer, and non-identical software code running on a secondary computer provides a consistent overall result, then a supervisory MCU may have greater confidence that an overall result is correct, and a bug in software or hardware on that primary computer is not causing a material error.

In at least one embodiment, an output of ADAS system 1638 may be fed into a primary computer's perception block and/or a primary computer's dynamic driving task block. For example, in at least one embodiment, if ADAS system 1638 indicates a forward crash warning due to an object immediately ahead, a perception block may use this information when identifying objects. In at least one embodiment, a secondary computer may have its own neural network that is trained and thus reduces a risk of false positives, as described herein.

In at least one embodiment, vehicle 1600 may further include infotainment SoC 1630 (e.g., an in-vehicle infotainment system (IVI)). Although illustrated and described as an SoC, infotainment system SoC 1630, in at least one embodiment, may not be an SoC, and may include, without limitation, two or more discrete components. In at least one embodiment, infotainment SoC 1630 may include, without limitation, a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, WiFi, etc.), and/or information services (e.g., navigation systems, rear-parking assistance, a radio data system, vehicle related information such as fuel level, total distance covered, brake fuel level, oil level, door open/close, air filter information, etc.) to vehicle 1600. For example, infotainment SoC 1630 could include radios, disk players, navigation systems, video players, USB and Bluetooth connectivity, carputers, in-car entertainment, WiFi, steering wheel audio controls, hands free voice control, a heads-up display (“HUD”), HMI display 1634, a telematics device, a control panel (e.g., for controlling and/or interacting with various components, features, and/or systems), and/or other components. In at least one embodiment, infotainment SoC 1630 may further be used to provide information (e.g., visual and/or audible) to user(s) of vehicle 1600, such as information from ADAS system 1638, autonomous driving information such as planned vehicle maneuvers, trajectories, surrounding environment information (e.g., intersection information, vehicle information, road information, etc.), and/or other information.

In at least one embodiment, infotainment SoC 1630 may include any amount and type of GPU functionality. In at least one embodiment, infotainment SoC 1630 may communicate over bus 1602 with other devices, systems, and/or components of vehicle 1600. In at least one embodiment, infotainment SoC 1630 may be coupled to a supervisory MCU such that a GPU of an infotainment system may perform some self-driving functions in event that primary controller(s) 1636(e.g., primary and/or backup computers of vehicle 1600) fail. In at least one embodiment, infotainment SoC 1630 may put vehicle 1600 into a chauffeur to safe stop mode, as described herein.

In at least one embodiment, vehicle 1600 may further include instrument cluster 1632 (e.g., a digital dash, an electronic instrument cluster, a digital instrument panel, etc.). In at least one embodiment, instrument cluster 1632 may include, without limitation, a controller and/or supercomputer (e.g., a discrete controller or supercomputer). In at least one embodiment, instrument cluster 1632 may include, without limitation, any number and combination of a set of instrumentation such as a speedometer, fuel level, oil pressure, tachometer, odometer, turn indicators, gearshift position indicator, seat belt warning light(s), parking-brake warning light(s), engine-malfunction light(s), supplemental restraint system (e.g., airbag) information, lighting controls, safety system controls, navigation information, etc. In some examples, information may be displayed and/or shared among infotainment SoC 1630 and instrument cluster 1632. In at least one embodiment, instrument cluster 1632 may be included as part of infotainment SoC 1630, or vice versa.

Inference and/or training logic 715 are used to perform inferencing and/or training operations associated with one or more embodiments. Details regarding inference and/or training logic 715 are provided herein in conjunction with FIGS. 7A and/or 7B. In at least one embodiment, inference and/or training logic 715 may be used in system FIG. 16C for inferencing or predicting operations based, at least in part, on weight parameters calculated using neural network training operations, neural network functions and/or architectures, or neural network use cases described herein.

Such components can be used to perform localization and/or route planning based in part upon one or more tokenized representations of at least a portion of an environment.

FIG. 16D is a diagram of a system for communication between cloud-based server(s) and autonomous vehicle 1600 of FIG. 16A, according to at least one embodiment. In at least one embodiment, system may include, without limitation, server(s) 1678, network(s) 1690, and any number and type of vehicles, including vehicle 1600. In at least one embodiment, server(s) 1678 may include, without limitation, a plurality of GPUs 1684 (A)-1684 (H) (collectively referred to herein as GPUs 1684), PCIe switches 1682 (A)-1682 (D) (collectively referred to herein as PCIe switches 1682), and/or CPUs 1680 (A)-1680 (B) (collectively referred to herein as CPUs 1680). In at least one embodiment, GPUs 1684, CPUs 1680, and PCIe switches 1682 may be interconnected with high-speed interconnects such as, for example and without limitation, NVLink interfaces 1688 developed by NVIDIA and/or PCIe connections 1686. In at least one embodiment, GPUs 1684 are connected via an NVLink and/or NVSwitch SoC and GPUs 1684 and PCIe switches 1682 are connected via PCIe interconnects. Although eight GPUs 1684, two CPUs 1680, and four PCIe switches 1682 are illustrated, this is not intended to be limiting. In at least one embodiment, each of server(s) 1678 may include, without limitation, any number of GPUs 1684, CPUs 1680, and/or PCIe switches 1682, in any combination. For example, in at least one embodiment, server(s) 1678 could each include eight, sixteen, thirty-two, and/or more GPUs 1684.

In at least one embodiment, server(s) 1678 may receive, over network(s) 1690 and from vehicles, image data representative of images showing unexpected or changed road conditions, such as recently commenced road-work. In at least one embodiment, server(s) 1678 may transmit, over network(s) 1690 and to vehicles, neural networks 1692, updated or otherwise, and/or map information 1694, including, without limitation, information regarding traffic and road conditions. In at least one embodiment, updates to map information 1694 may include, without limitation, updates for HD map 1622, such as information regarding construction sites, potholes, detours, flooding, and/or other obstructions. In at least one embodiment, neural networks 1692, and/or map information 1694 may have resulted from new training and/or experiences represented in data received from any number of vehicles in an environment, and/or based at least in part on training performed at a data center (e.g., using server(s) 1678 and/or other servers).

In at least one embodiment, server(s) 1678 may be used to train machine learning models (e.g., neural networks) based at least in part on training data. In at least one embodiment, training data may be generated by vehicles, and/or may be generated in a simulation (e.g., using a game engine). In at least one embodiment, any amount of training data is tagged (e.g., where associated neural network benefits from supervised learning) and/or undergoes other pre-processing. In at least one embodiment, any amount of training data is not tagged and/or pre-processed (e.g., where associated neural network does not require supervised learning). In at least one embodiment, once machine learning models are trained, machine learning models may be used by vehicles (e.g., transmitted to vehicles over network(s) 1690), and/or machine learning models may be used by server(s) 1678 to remotely monitor vehicles.

In at least one embodiment, server(s) 1678 may receive data from vehicles and apply data to up-to-date real-time neural networks for real-time intelligent inferencing. In at least one embodiment, server(s) 1678 may include deep-learning supercomputers and/or dedicated AI computers powered by GPU(s) 1684, such as a DGX and DGX Station machines developed by NVIDIA. However, in at least one embodiment, server(s) 1678 may include deep learning infrastructure that uses CPU-powered data centers.

In at least one embodiment, deep-learning infrastructure of server(s) 1678 may be capable of fast, real-time inferencing, and may use that capability to evaluate and verify health of processors, software, and/or associated hardware in vehicle 1600. For example, in at least one embodiment, deep-learning infrastructure may receive periodic updates from vehicle 1600, such as a sequence of images and/or objects that vehicle 1600 has located in that sequence of images (e.g., via computer vision and/or other machine learning object classification techniques). In at least one embodiment, deep-learning infrastructure may run its own neural network to identify objects and compare them with objects identified by vehicle 1600 and, if results do not match and deep-learning infrastructure concludes that AI in vehicle 1600 is malfunctioning, then server(s) 1678 may transmit a signal to vehicle 1600 instructing a fail-safe computer of vehicle 1600 to assume control, notify passengers, and complete a safe parking maneuver.

In at least one embodiment, server(s) 1678 may include GPU(s) 1684 and one or more programmable inference accelerators (e.g., NVIDIA's TensorRT 3 devices). In at least one embodiment, a combination of GPU-powered servers and inference acceleration may make real-time responsiveness possible. In at least one embodiment, such as where performance is less critical, servers powered by CPUs, FPGAs, and other processors may be used for inferencing.

Various embodiments can be described by the following clauses:
1. A method, comprising:
generating, based at least on a language model processing data associated with a set of observations corresponding to at least a portion of an environment, a feature vector corresponding to a tokenized description of at least the portion of the environment;
performing, using the feature vector, a similarity search of a set of one or more previously-determined feature vectors to determine one or more similar feature vectors;
updating the tokenized description of at least the portion of the environment based in part upon one or more additional observations obtained for at least the portion of the environment until a single similar feature vector is identified though the similarity search; and
identifying a geographic location, associated with the single similar feature vector, as a current location in the environment.
2. The method of clause 1, wherein the one or more previously-determined feature vectors correspond to a set of points in a latent space, and wherein the one or more similar feature vectors are determined for the feature vector based at least on a proximity in the latent space.
3. The method of clause 1, further comprising:
capturing sensor data, at an initial location of a vehicle in the environment, to be used to generate at least a subset of observations; and
capturing additional sensor data over one or more subsequent positions of the vehicle to generate the additional observations.
4. The method of clause 1, further comprising:
providing the geographic location, the tokenized description, and a road-level route plan as input to a second language model; and
receiving, as output of the second language model, a tokenized representation of routing data, including a further level of detail, to be used to follow the road-level route plan.
5. The method of clause 4, further comprising:
causing the second language model to identify a sequence of goals corresponding to the road-level route plan;
determining a set of path options for satisfying the sequence of goals; and
selecting, from the set of path options, an optimal path option to use to generate the tokenized representation of the routing data.
6. The method of clause 4, further comprising:
providing the tokenized representation of the routing data as input to a control system for operating an object according to the routing data in the tokenized representation.
7. The method of clause 1, wherein the tokenized description includes a tokenized sequence representative of at least the portion of the environment, in which tokens are associated with objects or features, and wherein the feature vector is generated based in part on the tokenized sequence.
8. The method of clause 1, wherein the tokenized description is written in a road topology language (RTL) or other domain specific language (DSL).
9. The method of clause 1, wherein the tokenized description is determined based on at least one of semantic, topological, geometric, kinematic, or relational information of features identified from the set of observations.
10. A processor, comprising:
one or more circuits to:
   generate, based at least on a language model processing data associated with a set of observations corresponding to a current location, a tokenized description of one or more features corresponding to the current location;
   perform, using the tokenized description, a similarity search of a set of one or more previously-determined tokenized descriptions to determine one or more similar tokenized descriptions;
   update the tokenized description of the one or more features, corresponding to the current environment, based in part upon one or more additional observations obtained for the current location until a similar previously-determined tokenized description is identified though the similarity search; and
   identify a geographic location, associated with the similar previously-determined tokenized description, as the current location.
11. The processor of clause 10, wherein the one or more circuits are further to:
capture sensor data, at an initial location of a vehicle, to be used to generate at least a subset of the set of observations; and
capture additional sensor data over one or more subsequent positions of the vehicle to generate the additional observations.
12. The processor of clause 10, wherein the one or more circuits are further to:
provide the geographic location, the tokenized description, and a road-level route plan as input to a second language model; and
receive, as output of the second language model, a tokenized representation of routing data to be used to follow the road-level route plan.
13. The processor of clause 12, wherein the one or more circuits are further to:
cause the second language model to identify a sequence of goals corresponding to the road-level route plan;
determine a set of path options for satisfying the sequence of goals; and
select, from the set of path options, an optimal path option to use to generate the tokenized representation of the routing data.
14. The processor of clause 12, wherein the one or more circuits are further to:
provide the tokenized representation of the routing data as input to a control system for operating an object according to the routing data in the tokenized representation.
15. The processor of clause 14, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.
16. A system comprising:
one or more processors to determine a location of a vehicle based in part on a tokenized description of a set of observations obtained for the location, the tokenized description to be used in a similarity search of a set of previously-generated tokenized descriptions to identify a geographic location associated with a most similar result of the similarity search.
17. The system of clause 16, wherein the one or more processors are further to:
use additional observations obtained for the location to narrow down a set of similarity search results and identify the most similar result.
18. The system of clause 16, wherein the one or more processors are further to:
provide the geographic location, the tokenized description, and an initial route plan as input to a language model; and
receive, as output of the language model, a tokenized representation of routing data to be used to follow the initial route plan.
19. The system of clause 18, wherein the one or more processors are further to:
cause the language model to identify a sequence of goals corresponding to the initial route plan;
determine a set of path options for satisfying the sequence of goals; and
select, from the set of path options, an optimal path option to use to generate the tokenized representation of the routing data.
20. The system of clause 16, wherein the simulation system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably as far as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although the discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method, comprising:
generating, based at least on a language model processing data associated with a set of observations corresponding to at least a portion of an environment, a feature vector corresponding to a tokenized description of at least the portion of the environment;
performing, using the feature vector, a similarity search of a set of one or more previously-determined feature vectors to determine one or more similar feature vectors;
updating the tokenized description of at least the portion of the environment based in part upon one or more additional observations obtained for at least the portion of the environment until a single similar feature vector is identified though the similarity search; and
identifying a geographic location, associated with the single similar feature vector, as a current location in the environment.

2. The method of claim 1, wherein the one or more previously-determined feature vectors correspond to a set of points in a latent space, and wherein the one or more similar feature vectors are determined for the feature vector based at least on a proximity in the latent space.

3. The method of claim 1, further comprising:
capturing sensor data, at an initial location of a vehicle in the environment, to be used to generate at least a subset of observations; and
capturing additional sensor data over one or more subsequent positions of the vehicle to generate the additional observations.

4. The method of claim 1, further comprising:
providing the geographic location, the tokenized description, and a road-level route plan as input to a second language model; and
receiving, as output of the second language model, a tokenized representation of routing data, including a further level of detail, to be used to follow the road-level route plan.

5. The method of claim 4, further comprising:
causing the second language model to identify a sequence of goals corresponding to the road-level route plan;
determining a set of path options for satisfying the sequence of goals; and
selecting, from the set of path options, an optimal path option to use to generate the tokenized representation of the routing data.

6. The method of claim 4, further comprising:
providing the tokenized representation of the routing data as input to a control system for operating an object according to the routing data in the tokenized representation.

7. The method of claim 1, wherein the tokenized description includes a tokenized sequence representative of at least the portion of the environment, in which tokens are associated with objects or features, and wherein the feature vector is generated based in part on the tokenized sequence.

8. The method of claim 1, wherein the tokenized description is written in a road topology language (RTL) or other domain specific language (DSL).

9. The method of claim 1, wherein the tokenized description is determined based on at least one of semantic, topological, geometric, kinematic, or relational information of features identified from the set of observations.

10. A processor, comprising:
one or more circuits to:
generate, based at least on a language model processing data associated with a set of observations corresponding to a current location, a tokenized description of one or more features corresponding to the current location;
perform, using the tokenized description, a similarity search of a set of one or more previously-determined tokenized descriptions to determine one or more similar tokenized descriptions;
update the tokenized description of the one or more features, corresponding to the current environment, based in part upon one or more additional observations obtained for the current location until a similar previously-determined tokenized description is identified though the similarity search; and
identify a geographic location, associated with the similar previously-determined tokenized description, as the current location.

11. The processor of claim 10, wherein the one or more circuits are further to:
capture sensor data, at an initial location of a vehicle, to be used to generate at least a subset of the set of observations; and
capture additional sensor data over one or more subsequent positions of the vehicle to generate the additional observations.

12. The processor of claim 10, wherein the one or more circuits are further to:
provide the geographic location, the tokenized description, and a road-level route plan as input to a second language model; and
receive, as output of the second language model, a tokenized representation of routing data to be used to follow the road-level route plan.

13. The processor of claim 12, wherein the one or more circuits are further to:
cause the second language model to identify a sequence of goals corresponding to the 2 road-level route plan;
determine a set of path options for satisfying the sequence of goals; and
select, from the set of path options, an optimal path option to use to generate the tokenized representation of the routing data.

14. The processor of claim 12, wherein the one or more circuits are further to:
provide the tokenized representation of the routing data as input to a control system for operating an object according to the routing data in the tokenized representation.

15. The processor of claim 14, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.

16. A system comprising:
one or more processors to determine a location of a vehicle based in part on a tokenized description of a set of observations obtained for the location, the tokenized description to be used in a similarity search of a set of previously-generated tokenized descriptions to identify a geographic location associated with a most similar result of the similarity search.

17. The system of claim 16, wherein the one or more processors are further to:
use additional observations obtained for the location to narrow down a set of similarity search results and identify the most similar result.

18. The system of claim 16, wherein the one or more processors are further to:
provide the geographic location, the tokenized description, and an initial route plan as input to a language model; and
receive, as output of the language model, a tokenized representation of routing data to be used to follow the initial route plan.

19. The system of claim 18, wherein the one or more processors are further to:
cause the language model to identify a sequence of goals corresponding to the initial route plan;
determine a set of path options for satisfying the sequence of goals; and
select, from the set of path options, an optimal path option to use to generate the tokenized representation of the routing data.

20. The system of claim 16, wherein the simulation system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.
